(19) United States
(12) Patent Application Publication
(10) Pub. No.: US 2014/0289759 A1
(43) Pub. Date: Sep. 25, 2014

(54) CONTENT PROVIDING SYSTEM AND CONTROL METHOD THEREFOR

(71) Applicant: Panasonic Corporation, Osaka (JP)

(72) Inventors: Toshihisa Nakano, Osaka (JP); Masayuki Kozuka, Osaka (JP); Masataka Minami, Hyogo (JP); Makoto Morise, Osaka (JP); Takahiro Yamaguchi, Osaka (JP); Motoji Ohmori, Osaka (JP); Takeshi Matsuo, Nara (JP)

(21) Appl. No.: 14/350,974

(22) PCT Filed: Jul. 2, 2013
(86) PCT No.: PCT/JP2013/004105

§ 371 Date: Apr. 10, 2014

Related U.S. Application Data
(60) Provisional application No. 61/668,223, filed on Jul. 5, 2012.

(51) Int. Cl. H04N 21/2347; H04N 21/254

(52) U.S. Cl. CPC H04N 21/2347; H04N 21/2541
USPC 725/31

(57) ABSTRACT

A sales device 100a includes: a first acquisition unit 108a acquiring a request for purchasing content from a user; a second acquisition unit 109a acquiring first identification information for a service, from a medium carrying the first identification information; a judgment unit 112a judging whether or not the request is received before a period during which the content is purchasable in a form of a packaged medium, and judging, by using the first identification information, whether or not the user is entitled to the service; an encryption unit 105a, when the request is received before the period and the user is entitled to the service, encrypting the content to generate encrypted content usable only on a terminal device that the user has; and a transmission unit 103a transmitting the encrypted content to the terminal device before the period.

### TECHNICAL FIELD

The present invention relates to a technology for providing content to users.

### BACKGROUND ART

Film production companies typically make movie content that they produce publically available according to a business model commonly referred to as a “release window” business model. Specifically, movie content is first released by being shown in the form of a movie in theaters, movie theaters, etc. Subsequently, the movie is shown in airplanes, hotels, etc., before the content is made available for purchase in the form of a packaged medium, such as a DVD or a Blu-ray disc, having data of the content recorded thereon and/or by being distributed via a network. Note that a period during which movie content is purchasable in the form of a packaged medium and/or by being distributed via a network is referred to in the present disclosure as a “purchasable period” or a “purchasable window.” Further, movie content made available in the form of a package medium is referred to in the present disclosure as “packaged content”.

### Citation List

### Patent Literature

[Patent Literature 1]
Japanese Patent Publication No. 4670461

### SUMMARY OF INVENTION

### Technical Problem

Suppose a case where a user is impressed by a movie that he/she first sees in a movie theater or in an airplane. If the user can purchase content corresponding to the movie immediately after first seeing the movie, the user would be able to take the content that he/she has purchased home and re-experience, at home, the excitement that he/she felt when first seeing the movie. Further, suppose a case where a passenger is watching a movie on an airplane but the showing of the movie on the airplane is stopped in the middle due to the airplane arriving at the airport. In such a case, the passenger may want to continue watching the movie up to the end, even if he/she has to purchase movie content.

As illustrated by such examples, there are cases where a user would like to purchase content before the purchasable period of the movie begins. On the other hand, those who sell content consider that a good opportunity to sell content corresponding to a movie is when a user watches and is impressed by the movie.

However, if content corresponding to a movie were to be sold before a purchasable period of the content begins to users having watched the movie in a movie theater, certain problems would arise. In specific, there is a risk of a user selling content that he/she has purchased to other users before the purchasable period begins, which would lead to the content circulating in the market and being available for many others to watch. This would result in a decrease in the number of people visiting movie theaters, theaters, etc., to watch the movie and the consequent decrease in the box-office revenue of the movie in movie theaters, theaters, etc.

The present invention aims to provide a sales device, a content-providing system, and a method of controlling such a content-providing system that realize selling of content before the purchasable period of the content begins and thus satisfy the above-described desire of users, while providing a resolution to the above-described problems.

### Solution to the Problems

In view of the above, one aspect of the present invention is a method of controlling a content-providing system that includes: a first acquisition unit; a second acquisition unit; a judgment unit; an encryption unit; and a transmission unit, and that provides, to users who receive a service, content corresponding to a movie shown at a site where the service is provided when the users make a payment for the content, the method including: a first acquisition step of the first acquisition unit acquiring a request for purchasing the content from a user; a second acquisition step of the second acquisition unit acquiring first identification information for the service, from a medium carrying the first identification information; a judgment step of the judgment unit (i) judging whether or not the request is received before a period during which the content is purchasable in a form of a packaged medium, and (ii) judging, by using the first identification information, whether or not the user is entitled to the service; an encryption step of the encryption unit, when the request is received before the period and the user is entitled to the service, encrypting the content to generate encrypted content usable only on a terminal device that the user has; and a transmission step of the transmission unit transmitting the encrypted content to the terminal device before the period.

### Advantageous Effects of the Invention

According to the method pertaining to one aspect of the present invention, encrypted content, which is encrypted so as to be usable only on a terminal device that a user has, is transmitted to the terminal device that the user has when judged that the purchasable period of the content has not yet begun and the user is entitled to the service. Accordingly, the content is made usable only on the terminal device that the user has. This has the effect of preventing the content from circulating in the market. As such, it can be expected that the present invention prevents the decrease in the number of people visiting theatrical venues to watch movies.

### BRIEF DESCRIPTION OF THE DRAWINGS

FIG. 1 is a system configuration diagram illustrating a configuration of a content-providing system 10a.

FIG. 2 is a flowchart illustrating a method of controlling the content-providing system 10a.

FIG. 3 is a system configuration diagram illustrating a configuration of a content distribution system 10b.

FIG. 4 is a block diagram illustrating a configuration of a sales device 100b.

FIG. 5 illustrates a data structure of a usage rule table 120.

FIG. 6 illustrates a data structure of a movie content information table 130.

FIG. 7 illustrates a data structure of a usage rule 140.

FIG. 8 is a block diagram illustrating a configuration of an on-board playback device 400b.

FIG. 9 is a block diagram illustrating a configuration of a portable terminal device 200b.

FIG. 10 is a block diagram illustrating a configuration of a billing server device 500b.

FIG. 11 is a block diagram illustrating a configuration of a management device 300b.

FIG. 12 illustrates a data structure of a user information table 320.

FIG. 13 illustrates a data structure of a packaged content information table 330.

FIG. 14 illustrates a data structure of a sales information table 340.

FIG. 15 is a block diagram illustrating a configuration of a playback device 600b.

FIG. 16 illustrates the first part of a sequence diagram illustrating operations of the sales device 100b, the billing server device 500b, the portable terminal device 200b, and the management device 300b, when selling content in a movie theater. Continues to the second part, which is illustrated in FIG. 17.

FIG. 17 illustrates the second part of the sequence diagram illustrating operations of the sales device 100b, the billing server device 500b, the portable terminal device 200b, and the management device 300b, when selling content in a movie theater. Continues to the third part, which is illustrated in FIG. 18.

FIG. 18 illustrates the third part of the sequence diagram illustrating operations of the sales device 100b, the billing server device 500b, the portable terminal device 200b, and the management device 300b, when selling content in a movie theater. Continues to the fourth part, which is illustrated in FIG. 19.

FIG. 19 illustrates the fourth part of the sequence diagram illustrating operations of the sales device 100b, the billing server device 500b, the portable terminal device 200b, and the management device 300b, when selling content in a movie theater.

FIG. 20 is a sequence diagram illustrating operations of the on-board playback device 400b, the billing server device 500b, the portable terminal device 200b, and the management device 300b, when selling content on-board an airplane.

FIG. 21 is a flowchart illustrating operations of the portable terminal device 200b when playing back content.

FIG. 22 illustrates the first part of a flowchart illustrating operations of the management device 300b when providing notification of a purchasable period start date. Continues to the second part, which is illustrated in FIG. 23.

FIG. 23 illustrates the second part of the flowchart illustrating operations of the management device 300b when providing notification of the purchasable period start date.

FIG. 24 illustrates the first part of a sequence diagram illustrating operations of the playback device 600b when acquiring content. Continues to the second part, which is illustrated in FIG. 25.

FIG. 25 illustrates the second part of the sequence diagram illustrating operations of the playback device 600b when acquiring content.

FIG. 26 is a flowchart illustrating operations of the portable terminal device 600b when playing back content.

FIG. 27 illustrates the first part of a sequence diagram illustrating operations when the sales device 100b and the portable terminal device 200b perform mutual authentication and key-sharing. Continues to the second part, which is illustrated in FIG. 28.

FIG. 28 illustrates the second part of the sequence diagram illustrating operations when the sales device 100b and the portable terminal device 200b perform mutual authentication and key-sharing.

FIG. 29 is a system configuration diagram illustrating a configuration of a content distribution system 10c.

FIG. 30 is a block diagram illustrating a configuration of a sales device 100c.

FIG. 31 is a block diagram illustrating a configuration of an on-board playback device 400c.

FIG. 32 is a sequence diagram illustrating operations of the sales device 100c, when selling content in a movie theater.

FIG. 33 illustrates the first part of a sequence diagram illustrating operations of a portable terminal device 200c when acquiring content. Continues to the second part, which is illustrated in FIG. 34.

FIG. 34 illustrates the second part of the sequence diagram illustrating operations of the portable terminal device 200c when acquiring content. Continues to the third part, which is illustrated in FIG. 35.

FIG. 35 illustrates the third part of the sequence diagram illustrating operations of the portable terminal device 200c when acquiring content.

FIG. 36 is a system configuration diagram illustrating a configuration of a content distribution system 10d.

FIG. 37 is a block diagram illustrating a configuration of a medium manufacturing device 700d.

FIG. 38 illustrates a data structure of a shipment information table 740.

FIG. 39 illustrates data recorded on a recording medium 800.

FIG. 40 illustrates the first part of a sequence diagram illustrating operations of the medium manufacturing device 700d when manufacturing a packaged medium. Continues to the second part, which is illustrated in FIG. 41.

FIG. 41 illustrates the second part of the sequence diagram illustrating operations of the medium manufacturing device 700d when manufacturing a packaged medium. Continues to the third part, which is illustrated in FIG. 42.

FIG. 42 illustrates the third part of the sequence diagram illustrating operations of the medium manufacturing device 700d when manufacturing a packaged medium.

FIG. 43 is a system configuration diagram illustrating a configuration of a content distribution system 10e.

FIG. 44 is a block diagram illustrating a configuration of a sales device 100e.

FIG. 45 illustrates a data structure of a purchase certificate 170.

FIG. 46 is a block diagram illustrating a configuration of an on-board playback device 400e.

FIG. 47 is a block diagram illustrating a configuration of a portable terminal device 200e.

FIG. 48 is a block diagram illustrating a configuration of a management device 300e.

FIG. 49 is the first part of a sequence diagram illustrating operations of the sales device 100e, when selling content in a movie theater. Continues to the second part, which is illustrated in FIG. 50.

FIG. 50 is the second part of the sequence diagram illustrating operations of the sales device 100e, when selling content in a movie theater.

FIG. 51 illustrates the first part of a sequence diagram illustrating operations of the portable terminal device 200e when acquiring content. Continues to the second part, which is illustrated in FIG. 52.

FIG. 52 illustrates the second part of the sequence diagram illustrating operations of the portable terminal device 200e when acquiring content.

FIG. 53 is a system configuration diagram illustrating a configuration of a content distribution system 10f pertaining to a modification.

### DESCRIPTION OF EMBODIMENTS

One aspect of the present invention is a method of controlling a content-providing system that includes: a first acquisition unit; a second acquisition unit; a judgment unit; an encryption unit; and a transmission unit, and that provides, to users who receive a service, content corresponding to a movie shown at a site where the service is provided when the users make a payment for the content, the method including: a first acquisition step of the first acquisition unit acquiring a request for purchasing the content from a user; a second acquisition step of the second acquisition unit acquiring first identification information for the service, from a medium carrying the first identification information; a judgment step of the judgment unit (i) judging whether or not the request is received before a period during which the content is purchasable in a form of a packaged medium, and (ii) judging, by using the first identification information, whether or not the user is entitled to the service; an encryption step of the encryption unit, when the request is received before the period and the user is entitled to the service, encrypting the content to generate encrypted content usable only on a terminal device that the user has; and a transmission step of the transmission unit transmitting the encrypted content to the terminal device before the period.

According to the method pertaining to one aspect of the present invention, encrypted content that is encrypted so as to be usable only on the terminal device that the user has is transmitted to the terminal device when judged that the purchasable period of the content has not yet begun and the user is entitled to the service. Accordingly, the content is made usable only on the terminal device that the user has. This has the effect of preventing the content from circulating in the market before the purchasable period begins. Consequently, it can be expected that the present invention prevents the decrease in the number of people visiting theatrical venues to watch movies.

In the method pertaining to one aspect of the present invention, in the service, the movie may be shown to an audience in a theatrical venue, in the judgment step, the judgment unit may judge that the user is entitled to the service when the first identification information matches second identification information that is internally stored in advance, the medium may be a movie ticket and the first identification information may identify content corresponding to a movie, and the second identification information may identify the content corresponding to the movie, which is shown at the theatrical venue.

According to this, when the user is entitled to watch the movie, the content corresponding to the movie is transmitted to the terminal device that the user has.

In the method pertaining to one aspect of the present invention, in the service, a passenger may be transported between airports on an airplane, the movie shown on the airplane, in the judgment step, the judgment unit may judge that the user is entitled to the service when the first identification information matches second identification information that is internally stored in advance, the medium may be a boarding ticket and the first identification information may identify an airplane flight, and the second identification information may identify the airplane flight during which the movie is shown.

According to this, when the user is entitled to board the airplane flight during which the movie is shown, the content corresponding to the movie is transmitted to the terminal device that the user has.

In the method pertaining to one aspect of the present invention, in the service, a hotel guest may be allowed to occupy a room in a hotel in which the movie is shown, in the judgment step, the judgment unit may judge that the user is entitled to the service when the first identification information matches second identification information that is internally stored in advance, the first identification information may identify a hotel room and the medium may be a cardkey for locking and unlocking the hotel room identified by the first identification information, and the second identification information may identify the room in the hotel.

According to this, when the user is entitled to occupy the room of the hotel in which the movie is shown, the content corresponding to the movie is transmitted to the terminal device that the user has.

In the method pertaining to one aspect of the present invention, the content-providing system may include a sales device which sells and provides the content to users and in which the first acquisition unit, the second acquisition unit, the judgment unit, the encryption unit, and the transmission unit are included, in the first acquisition step, the first acquisition unit, which is included in the sales device, may acquire the request for purchasing the content from the user, in the second acquisition step, the second acquisition unit, which is included in the sales device, may acquire the first identification information, in the judgment step, the judgment unit, which is included in the sales device, may judge whether or not the request is received before the period and whether or not the user is entitled to the service, in the encryption step, the encryption unit, which is included in the sales device, may encrypt the content to generate the encrypted content, and in the transmission step, the transmission unit, which is included in the sales device, may transmit the encrypted content to the terminal device.

According to this, the sales device transmits the content to the terminal device that the user has.

In the method pertaining to one aspect of the present invention, the content-providing system may include: a sales device which sells the content and in which the first acquisition unit, the second acquisition unit, and the judgment unit are included; and a management device which provides the content to users and in which the encryption unit and the transmission unit are included, in the first acquisition step, the first acquisition unit, which is included in the sales device, may acquire the request for purchasing the content from the user, in the second acquisition step, the second acquisition unit, which is included in the sales device, may acquire the first identification information, in the judgment step, the judgment unit, which is included in the sales device, may judge whether or not the request is received before the period and whether or not the user is entitled to the service, in the encryption step, the encryption unit, which is included in the management device, may encrypt the content to generate the encrypted content, and in the transmission step, the transmission unit, which is included in the management device, may transmit the encrypted content to the terminal device.

According to this, the sales device judges whether or not the content is to be sold, and the management device transmits the content to the terminal device that the user has.

The method pertaining to one aspect of the present invention may further include: a purchase certificate generation step of a generation unit of the sales device, when the request is received before the period and the user is entitled to the service, generating a purchase certificate that certifies that the user has purchased the content and has the right to use the content, and in the method pertaining to one aspect of the present invention, in the transmission step, the purchase certificate may be transmitted to the terminal device. Further, the method pertaining to one aspect of the present invention may further include: a terminal device reception step of a reception unit of the terminal device receiving the purchase certificate and storing the purchase certificate in the terminal device; and a terminal device transmission step of a transmission unit of the terminal device transmitting the purchase certificate stored in the terminal device to the management device, and in the method pertaining to one aspect of the present invention, in the encryption step, judgment may be performed of whether or not the purchase certificate is valid, and the content may be encrypted to generate the encrypted content when the purchase certificate is valid, regarding that the request is received before the period and the user is entitled to the service.

According to this, the terminal device that the user has is able to acquire the content in exchange for the purchase certificate.

The method pertaining to one aspect of the present invention may further include: a terminal reception step of a reception unit of the terminal device receiving the encrypted content; a decrypting step of a decryption unit of the terminal device decrypting the encrypted content to generate decrypted content, and a playback step of a playback unit of the terminal device playing back the decrypted content.

According to this, the terminal device that the user has is capable of playing back the content.

In the method pertaining to one aspect of the present invention, in the transmission step, a usage rule may be transmitted to the terminal device, the usage rule indicating limited conditions under which the content is available for use, and in the terminal reception step, the usage rule may be received. Further, the method pertaining to one aspect of the present invention may further include: a terminal checking step of a checking unit of the terminal device checking the usage rule received in the terminal reception step, and in the method pertaining to one aspect of the present invention, in the playback step, the decrypted content may be played back according to results of the check in the terminal checking step.

According to this, the terminal device that the user has is capable of playing back the content in accordance with the usage rule.

In the method pertaining to one aspect of the present invention, the content-providing system may include: a sales device which sells and provides the content to users and in which the first acquisition unit, the second acquisition unit, the judgment unit, the encryption unit and the transmission unit are included; a management device that manages the content after being provided to users; and a playback device that the user has. Further, the method pertaining to one aspect of the present invention may further include: a first reception step of a first reception unit of the management device receiving, from the sales device, sales information indicating that the content has been sold to the user, and storing the sales information in the management device; a second reception step of a second reception unit of the management device receiving a transmission request from the playback device, the transmission request being a request for transmission of the content; a management device judgment step of a judgment unit of the management device judging whether or not the transmission request is received before the period, and judging, by using the sales information stored in the management device, whether or not the user, who uses the playback device, is entitled to use the content, which pertains to the transmission request; a management device encryption step of an encryption unit of the management device, when the transmission request is received during the period and the user is entitled to use the content, encrypting the content in accordance with a recording medium that is mounted to the playback device to generate encrypted content; and a management device transmission step of a transmission unit of the management device transmitting the encrypted content to the playback device during the period.

According to this, the playback device that the user has is capable of acquiring the content.

The method pertaining to one aspect of the present invention may further include: a playback device reception step of a reception unit of the playback device receiving the encrypted content and writing the encrypted content to the recording medium; a decryption step of a decryption unit of the playback device decrypting the encrypted content to generate decrypted content; and a playback step of a playback unit of the playback device playing back the decrypted content.

According to this, the playback device that the user has is capable of playing back the content.

In the method pertaining to one aspect of the present invention, in the management device transmission step, a usage rule may be transmitted to the playback device, the usage rule indicating moderated conditions under which the content is available for use, and in the playback device reception step, the usage rule may be received. Further, the method pertaining to one aspect of the present invention may further include: a playback device checking step of a checking unit of the playback device checking the usage rule received in the playback device reception step, and in the method pertaining to one aspect of the present invention, in the playback step, the decrypted content may be played back according to results of the check in the playback device checking step.

According to this, the playback device that the user has is capable of playing back the content in accordance with the usage rule.

In the method pertaining to one aspect of the present invention, the content-providing system may include: a sales device which sells and provides the content to users and in which the first acquisition unit, the second acquisition unit, the judgment unit, the encryption unit, and the transmission unit are included; a management device that manages the content after being provided to users; a medium manufacturing device that writes the content to a recording medium; and a playback device that the user has. Further, the method pertaining to one aspect of the present invention may further include: a first reception step of a first reception unit of the management device receiving, from the sales device, sales information indicating that the content has been sold to the user, and storing the sales information in the management device; a second reception step of a second reception unit of the management device receiving a transmission request from the playback device, the transmission request being a request for transmission of the content; a management device judgment step of a judgment unit of the management device judging whether or not the transmission request is received before the period, and judging, by using the sales information stored in the management device, whether or not the user, who uses the playback device, is entitled to use the content, which pertains to the transmission request; a medium manufacturing device encryption step of an encryption unit of the medium manufacturing device, when the transmission request is received during the period and the user is entitled to use the content, encrypting the content in accordance with the recording medium to generate encrypted content; a medium manufacturing step of a manufacturing unit of the medium manufacturing device writing the encrypted content to the recording medium; a decryption step of a decryption unit of the playback device decrypting the encrypted content, which is recorded on the recording medium, to generate decrypted content; and a playback step of a playback unit of the playback device playing back the decrypted content.

According to this, the playback device that the user has is capable of playing back the content recorded on the recording medium.

In the method pertaining to one aspect of the present invention, in the medium manufacturing step, a usage rule may be recorded on the recording medium, the usage rule indicating moderated conditions under which the content is available for use. Further, the method pertaining to one aspect of the present invention may further include: a playback device checking step of a checking unit of the playback device checking the usage rule recorded on the recording medium, and in the method pertaining to one aspect of the present invention, in the playback step, the decrypted content may be played back according to results of the check in the playback device checking step.

According to this, the playback device that the user has is capable of playing back the content recorded on the recording medium according to the moderated conditions indicated by the usage rule.

Another aspect of the present invention is a sales device that provides, to users who receive a service, content corresponding to a movie shown at a site where the service is provided when the users make a payment for the content, the sales device including: a first acquisition unit acquiring a request for purchasing the content from a user; a second acquisition unit acquiring first identification information for the service, from a medium carrying the first identification information; a judgment unit (i) judging whether or not the request is received before a period during which the content is purchasable in a form of a packaged medium, and (ii) judging, by using the first identification information, whether or not the user is entitled to the service; an encryption unit, when the request is received before the period and the user is entitled to the service, encrypting the content to generate encrypted content usable only on a terminal device that the user has; and a transmission unit transmitting the encrypted content to the terminal device before the period.

According to the sales device pertaining to one aspect of the present invention, encrypted content that is encrypted so as to be usable only on the terminal device possessed by the user is transmitted to the terminal device when judged that the purchasable period of the content has not yet begun and the user is entitled to the service. Accordingly, the content is made usable only on the terminal device that the user has. This has the effect of preventing the content from circulating in the market before the purchasable period begins. Consequently, it can be expected that the present invention prevents the decrease in the number of people visiting theatrical venues to watch movies.

Another aspect of the present invention is a computer-readable recording medium having recorded thereon a program for controlling a sales device that provides, to users who receive a service, content corresponding to a movie shown at a site where the service is provided when the users make a payment for the content, the program causing the sales device, which is a computer, to execute: a first acquisition step of a first acquisition unit of the sales device acquiring a request for purchasing the content from a user; a second acquisition step of a second acquisition unit of the sales device acquiring first identification information for the service, from a medium carrying the first identification information; a judgment step of a judgment unit of the sales device (i) judging whether or not the request is received before a period during which the content is purchasable in a form of a packaged medium, and (ii) judging, by using the first identification information, whether or not the user is entitled to the service; an encryption step of an encryption unit of the sales device, when the request is received before the period and the user is entitled to the service, encrypting the content to generate encrypted content usable only on a terminal device that the user has; and a transmission step of a transmission unit of the sales device transmitting the encrypted content to the terminal device before the period.

According to the computer-readable recording medium pertaining to one aspect of the present invention, encrypted content that is encrypted so as to be usable only on the terminal device that the user has is transmitted to the terminal device when judged that the purchasable period of the content has not yet begun and the user is entitled to the service. Accordingly, the content is made usable only on the terminal device that the user has. This has the effect of preventing the content from circulating in the market before the purchasable period begins. Consequently, it can be expected that the present invention prevents the decrease in the number of people visiting theatrical venues to watch movies.

Another aspect of the present invention is an integrated circuit constituting a sales device that provides, to users who receive a service, content corresponding to a movie shown at a site where the service is provided when the users make a payment for the content, the integrated circuit including: a first acquisition unit acquiring a request for purchasing the content from a user; a second acquisition unit acquiring first identification information for the service, from a medium carrying the first identification information; a judgment unit (i) judging whether or not the request is received before a period during which the content is purchasable in a form of a packaged medium, and (ii) judging, by using the first identification information, whether or not the user is entitled to the service; an encryption unit, when the request is received before the period and the user is entitled to the service, encrypting the content to generate encrypted content usable only on a terminal device that the user has; and a transmission unit transmitting the encrypted content to the terminal device before the period.

According to the integrated circuit pertaining to one aspect of the present invention, encrypted content that is encrypted so as to be usable only on the terminal device that the user has is transmitted to the terminal device when judged that the purchasable period of the content has not yet begun and the user is entitled to the service. Accordingly, the content is made usable only on the terminal device that the user has. This has the effect of preventing the content from circulating in the market before the purchasable period begins. Consequently, it can be expected that the present invention prevents the decrease in the number of people visiting theatrical venues to watch movies.

Another aspect of the present invention is a content-providing system that provides, to users who receive a service, content corresponding to a movie shown at a site where the service is provided when the users make a payment for the content, the content-providing system including: a sales device selling the content; and a management device providing the content to users. In the content-providing system pertaining to another aspect of the present invention, the sales device includes: a first acquisition unit acquiring a request for purchasing the content from a user; a second acquisition unit acquiring first identification information for the service, from a medium carrying the first identification information; and a judgment unit (i) judging whether or not the request is received before a period during which the content is purchasable in a form of a packaged medium, and (ii) judging, by using the first identification information, whether or not the user is entitled to the service; and the management device includes: an encryption unit, when the request is received before the period and the user is entitled to the service, encrypting the content to generate encrypted content usable only on a terminal device that the user has; and a transmission unit transmitting the encrypted content to the terminal device before the period.

According to the content-providing system pertaining to one aspect of the present invention, encrypted content that is encrypted so as to be usable only on the terminal device that the user has is transmitted to the terminal device when judged that the purchasable period of the content has not yet begun and the user is entitled to the service. Accordingly, the content is made usable only on the terminal device that the user has. This has the effect of preventing the content from circulating in the market before the purchasable period begins. Consequently, it can be expected that the present invention prevents the decrease in the number of people visiting theatrical venues to watch movies.

Another aspect of the present invention is a content-providing system that provides, to users who receive a service, content corresponding to a movie shown at a site where the service is provided when the users make a payment for the content, the content-providing system including: a sales device selling the content; a management device providing the content to users; and a playback device that a user has. In the content-providing system pertaining to another aspect of the present invention, the sales device includes: a first acquisition unit acquiring a request for purchasing the content from the user; a second acquisition unit acquiring first identification information for the service, from a medium carrying the first identification information; and a judgment unit (i) judging whether or not the request is received before a period during which the content is purchasable in a form of a packaged medium, and (ii) judging, by using the first identification information, whether or not the user is entitled to the service; an encryption unit, when the request is received before the period and the user is entitled to the service, encrypting the content to generate encrypted content usable only on a terminal device that the user has; and a transmission unit transmitting the encrypted content to the terminal device before the period, and the management device includes: a first reception unit receiving, from the sales device, sales information indicating that the content has been sold to the user, and storing the sales information in the management device; a second reception unit receiving a transmission request from the playback device, the transmission request being a request for transmission of the content; a management device judgment unit judging whether or not the transmission request is received before the period, and judging, by using the sales information stored in the management device, whether or not the user, who uses the playback device, is entitled to use the content, which pertains to the transmission request; a management device encryption unit, when the transmission request is received during the period and the user is entitled to use the content, encrypting the content in accordance with a recording medium that is mounted to the playback device to generate encrypted content; and a management device transmission unit transmitting the encrypted content to the playback device during the period.

According to the content-providing system pertaining to one aspect of the present invention, encrypted content that is encrypted so as to be usable only on the terminal device that the user has is transmitted to the terminal device when judged that the purchasable period of the content has not yet begun and the user is entitled to the service. Accordingly, the content is made usable only on the terminal device that the user has. This has the effect of preventing the content from circulating in the market before the purchasable period begins. Consequently, it can be expected that the present invention prevents the decrease in the number of people visiting theatrical venues to watch movies. In addition, the content is made transmissible to the playback device that the user has during the purchasable period.

Another aspect of the present invention is a content-providing system that provides, to users who receive a service, content corresponding to a movie shown at a site where the service is provided when the users make a payment for the content, the content-providing system including: a sales device selling the content; a management device providing the content to users; a medium manufacturing device writing the content to a recording medium; and a playback device that a user has. In the content-providing system pertaining to another aspect of the present invention, the sales device includes: a first acquisition unit acquiring a request for purchasing the content from the user; a second acquisition unit acquiring first identification information for the service, from a medium carrying the first identification information; and a judgment unit (i) judging whether or not the request is received before a period during which the content is purchasable in a form of a packaged medium, and (ii) judging, by using the first identification information, whether or not the user is entitled to the service; an encryption unit, when the request is received before the period and the user is entitled to the service, encrypting the content to generate encrypted content usable only on a terminal device that the user has; and a transmission unit transmitting the encrypted content to the terminal device before the period, the management device includes: a first reception unit receiving, from the sales device, sales information indicating that the content has been sold to the user, and storing the sales information in the management device; a management device judgment unit judging whether or not a present point in time is before the period, and judging, by using the sales information stored in the management device, whether or not the user is entitled to use the content, the medium manufacturing device includes: a medium manufacturing device encryption unit, when the present point in time is during the period and the user is entitled to use the content, encrypting the content in accordance with the recording medium to generate encrypted content; and a medium manufacturing unit writing the encrypted content to the recording medium; and the playback device includes: a decryption unit decrypting the encrypted content, which is recorded on the recording medium, to generate decrypted content; and a playback unit playing back the decrypted content.

According to the content-providing system pertaining to one aspect of the present invention, encrypted content that is encrypted so as to be usable only on the terminal device that the user has is transmitted to the terminal device when judged that the purchasable period of the content has not yet begun and the user is entitled to the service. Accordingly, the content is made usable only on the terminal device that the user has. This has the effect of preventing the content from circulating in the market before the purchasable period begins. Consequently, it can be expected that the present invention prevents the decrease in the number of people visiting theatrical venues to watch movies. In addition, the playback device that the user has is capable of playing back the content from the recording medium having the content recorded thereon during the purchasable period.

### 1. Embodiment 1

Embodiment 1 provides description on a content-providing system 10a, as one example of implementation of the present invention.

(1) The content-providing system 10a provides, to users who receive a service, content corresponding to a movie shown at a site where the service is provided when the users made a payment for the content.

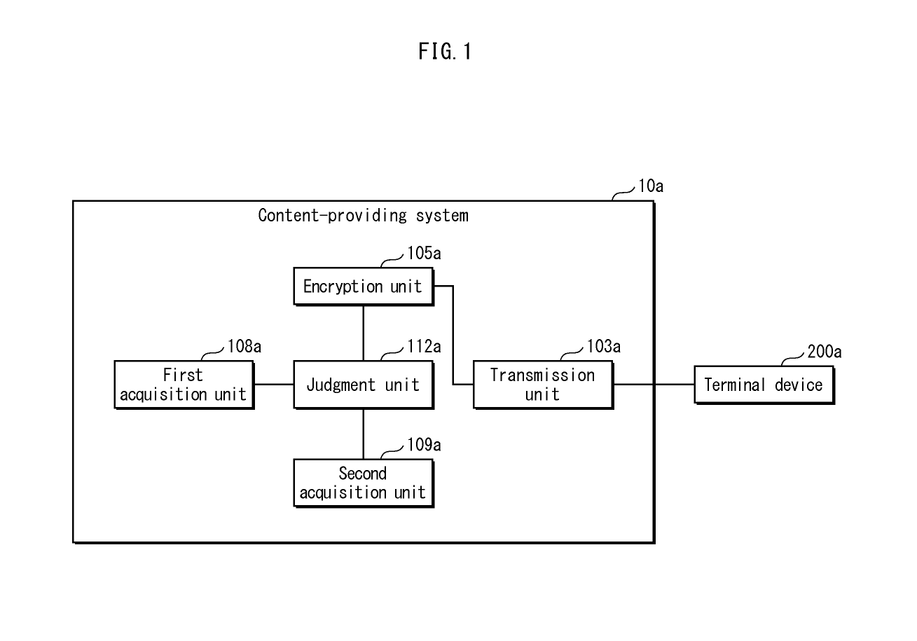

As illustrated in FIG. 1, the content-providing system 10a includes: a first acquisition unit 108a; a second acquisition unit 109a; a judgment unit 112a; an encryption unit 105a; and a transmission unit 103a.

The first acquisition unit 108a acquires a request for purchasing the content from a user.

The second acquisition unit 109a acquires first identification information for the service, from a medium carrying the first identification information.

The judgment unit 112a (i) judges whether or not the request is received before a period during which the content is purchasable in a form of a packaged medium, and (ii) judges, by using the first identification information, whether or not the user is entitled to the service.

The encryption unit 105a, when the request is received before the period and the user is entitled to the service, encrypts the content to generate encrypted content usable only on a terminal device 200a that the user has.

The transmission unit 103a transmits the encrypted content to the terminal device 200a before the period.

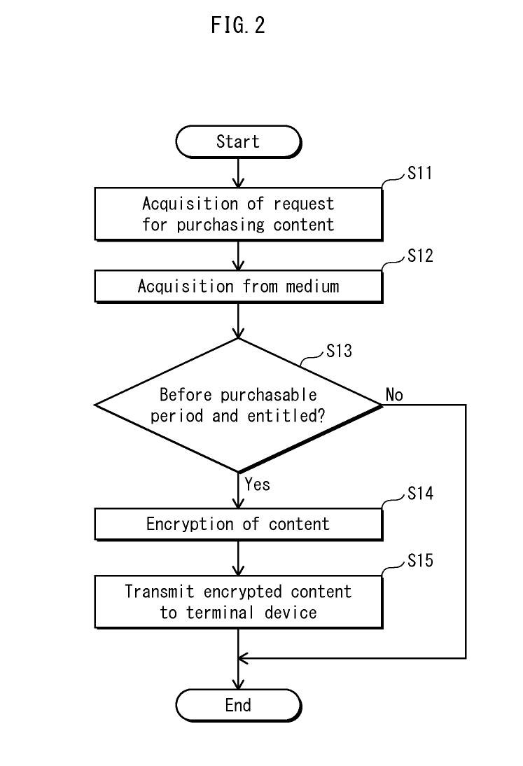

(2) In the following, description is provided on a method of controlling the content-providing system 10a, while referring to the flowchart illustrated in FIG. 2.

The method of controlling the content-providing system 10a includes: a first acquisition step (Step S11) of the first acquisition unit 108a acquiring a request for purchasing the content from a user; a second acquisition step (Step S12) of the second acquisition unit 109a acquiring first identification information for the service, from a medium carrying the first identification information; a judgment step (Step S13) of the judgment unit 112a (i) judging whether or not the request is received before a period during which the content is purchasable in a form of a packaged medium, and (ii) judging, by using the first identification information, whether or not the user is entitled to the service; an encryption step (Step S14) of the encryption unit 105a, when the request is received before the period and the user is entitled to the service (“YES” in Step S13), encrypting the content to generate encrypted content usable only on the terminal device 200a that the user has; and a transmission step (Step S15) of the transmission unit 103a transmitting the encrypted content to the terminal device 200a before the period.

(3) In the service, the movie may be shown to an audience in a theatrical venue, the medium may be a movie ticket and the first identification information may identify content corresponding to a movie, and second identification information the content corresponding to the movie, which is shown at the theatrical venue. In the judgment step, the judgment unit may judge that the user is entitled to the service when the first identification information matches the second identification information that is internally stored in advance.

(4) In the service, a passenger may be transported between airports on an airplane, the movie shown on the airplane, the medium may be a boarding ticket and the first identification information may identify an airplane flight, and second identification information may identify the airplane flight during which the movie is shown. In the judgment step, the judgment unit may judge that the user is entitled to the service when the first identification information matches the second identification information that is internally stored in advance.

(5) In the service, a hotel guest may be allowed to occupy a room in a hotel in which the movie is shown, the first identification information may identify a hotel room and the medium may be a cardkey for locking and unlocking the hotel room identified by the first identification information, and second identification information may identify the room in the hotel. In the judgment step, the judgment unit may judge that the user is entitled to the service when the first identification information matches the second identification information that is internally stored in advance,

(6) The content-providing system 10a may include a sales device 100a which sells and provides the content to users and in which the first acquisition unit 108a, the second acquisition unit 109a, the judgment unit 112a, the encryption unit 105a, and the transmission unit 103a are included.

In the first acquisition step, the first acquisition unit 108a, which is included in the sales device 100a, acquires the request for purchasing the content from the user. In the second acquisition step, the second acquisition unit 109a, which is included in the sales device 100a, acquires the first identification information.

In the judgment step, the judgment unit 112a, which is included in the sales device 100a, judges whether or not the request is received before the period and whether or not the user is entitled to the service, in the encryption step, the encryption unit 105a, which is included in the sales device 100a, encrypts the content to generate the encrypted content, and in the transmission step, the transmission unit 103a, which is included in the sales device 100a, transmits the encrypted content to the terminal device 200a.

(7) The content-providing system 10a may include: the sales device 100a, which sells the content and in which the first acquisition unit 108a, the second acquisition unit 109a, and the judgment unit 112a are included; and a management device 300a which provides the content to users and in which the encryption unit 105a and the transmission unit 103a are included.

In the first acquisition step, the first acquisition unit 108a, which is included in the sales device 100a, acquires the request for purchasing the content from the user. In the second acquisition step, the second acquisition unit 109a, which is included in the sales device 100a, acquires the first identification information.

In the judgment step, the judgment unit 112a, which is included in the sales device 100a, judges whether or not the request is received before the period and whether or not the user is entitled to the service.

In the encryption step, the encryption unit 105a, which is included in the management device 300a, encrypts the content to generate the encrypted content. In the transmission step, the transmission unit 103a, which is included in the management device 300a, transmits the encrypted content to the terminal device 200a.

(8) The method may further include: a purchase certificate generation step of a generation unit of the sales device 100a, when the request is received before the period and the user is entitled to the service, generating a purchase certificate that certifies that the user has purchased the content and has the right to use the content.

In the transmission step, the purchase certificate is transmitted to the terminal device 200a.

The method may further include: a terminal device reception step of a reception unit of the terminal device 200a receiving the purchase certificate and storing the purchase certificate in the terminal device 200a; and a terminal device transmission step of the transmission unit 103a of the terminal device 200a transmitting the purchase certificate stored in the terminal device 200a to the management device 300a.

In the encryption step, judgment is performed of whether or not the purchase certificate is valid, and the content is encrypted to generate the encrypted content when the purchase certificate is valid, regarding that the request is received before the period and the user is entitled to the service.

(9) The method may further include: a terminal reception step of a reception unit of the terminal device 200a receiving the encrypted content; a decrypting step of a decryption unit of the terminal device 200a decrypting the encrypted content to generate decrypted content, and a playback step of a playback unit of the terminal device 200a playing back the decrypted content.

(10) In the transmission step, a usage rule may be transmitted to the terminal device 200a, the usage rule indicating limited conditions under which the content is available for use.

In the terminal reception step, the usage rule is received.

The method may further include: a terminal checking step of a checking unit of the terminal device 200a checking the usage rule received in the terminal reception step.

In the playback step, the decrypted content is played back according to results of the check in the terminal checking step.

(11) The content-providing system 10a may include: the sales device 100a, which sells and provides the content to users; the management device 300a, which manages the content after being provided to users; and a playback device 600a that the user has.

The sales device 100a includes the first acquisition unit 108a, the second acquisition unit 109a, the judgment unit 112a, the encryption unit 105a, and the transmission unit 103a.

The method further includes: a first reception step of a first reception unit of the management device 300a receiving, from the sales device 100a, sales information indicating that the content has been sold to the user, and storing the sales information in the management device 300a; a second reception step of a second reception unit of the management device 300a receiving a transmission request from the playback device 600a, the transmission request being a request for transmission of the content; a management device judgment step of a judgment unit of the management device 300a judging whether or not the transmission request is received before the period, and judging, by using the sales information stored in the management device 300a, whether or not the user, who uses the playback device 600a, is entitled to use the content, which pertains to the transmission request; a management device encryption step of the encryption unit 105a of the management device 300a, when the transmission request is received during the period and the user is entitled to use the content, encrypting the content in accordance with a recording medium that is mounted to the playback device to generate encrypted content; and a management device transmission step of the transmission unit 103a of the management device 300a transmitting the encrypted content to the playback device 600a during the period.

(12) The method may further include: a playback device reception step of a reception unit of the playback device 600a receiving the encrypted content and writing the encrypted content to the recording medium; a decryption step of a decryption unit of the playback device 600a decrypting the encrypted content to generate decrypted content; and a playback step of a playback unit of the playback device 600a playing back the decrypted content.

(13) In the management device transmission step, a usage rule may be transmitted to the playback device 600a, the usage rule indicating moderated conditions under which the content is available for use. In the playback device reception step, the usage rule is received.

The method may further include: a playback device checking step of a checking unit of the playback device 600a checking the usage rule received in the playback device reception step.

In the playback step, the decrypted content is played back according to results of the check in the playback device checking step.

(14) The content-providing system 10a may include: the sales device 100a, which sells and provides the content to users; the management device 300a, which manages the content after being provided to users; a medium manufacturing device 700a that writes the content to a recording medium; and the playback device 600a that the user has

The sales device 100a includes the first acquisition unit 108a, the second acquisition unit 109a, the judgment unit 112a, the encryption unit 105a, and the transmission unit 103a.

The method further includes: a first reception step of a first reception unit of the management device 300a receiving, from the sales device 100a, sales information indicating that the content has been sold to the user, and storing the sales information in the management device 300a; a second reception step of a second reception unit of the management device 300a receiving a transmission request from the playback device 600a, the transmission request being a request for transmission of the content; a management device judgment step of the judgment unit 112a of the management device 300a judging whether or not the transmission request is received before the period, and judging, by using the sales information stored in the management device 300a, whether or not the user, who uses the playback device 600a, is entitled to use the content, which pertains to the transmission request; a medium manufacturing device encryption step of the encryption unit 105a of the medium manufacturing device 700a, when the transmission request is received during the period and the user is entitled to use the content, encrypting the content in accordance with the recording medium to generate encrypted content; a medium manufacturing step of a manufacturing unit of the medium manufacturing device 700a writing the encrypted content to the recording medium; a decryption step of a decryption unit of the playback device 600a decrypting the encrypted content, which is recorded on the recording medium, to generate decrypted content; and a playback step of a playback unit of the playback device 600a playing back the decrypted content.

(15) In the medium manufacturing step, a usage rule may be recorded on the recording medium, the usage rule indicating moderated conditions under which the content is available for use.

The method may further include: a playback device checking step of a checking unit of the playback device 600a checking the usage rule recorded on the recording medium.

In the playback step, the decrypted content is played back according to results of the check in the playback device checking step.

(16) The sales device 100a, which provides, to users who receive a service, content corresponding to a movie shown at a site where the service is provided when the users make a payment for the content, may include: the first acquisition unit 108a; the second acquisition unit 109a; the judgment unit 112a; the encryption unit 105a; and the transmission unit 103a.

The first acquisition unit 108a acquires a request for purchasing the content from a user.

The second acquisition unit 109a acquires first identification information for the service, from a medium carrying the first identification information.

The judgment unit 112a judges whether or not the request is received before a period during which the content is purchasable in a form of a packaged medium, and judges, by using the first identification information, whether or not the user is entitled to the service.

The encryption unit 105a, when the request is received before the period and the user is entitled to the service, encrypts the content to generate encrypted content usable only on the terminal device 200a that the user has.

The transmission unit 103a transmits the encrypted content to the terminal device 200a before the period.

(19) The content-providing system 10a, which provides, to users who receive a service, content corresponding to a movie shown at a site where the service is provided when the users make a payment for the content, may include: the sales device 100a, which sells the content; and the management device 300a, which provides the content to users.

The sales device 100a includes: the first acquisition unit 108a acquiring a request for purchasing the content from a user; the second acquisition unit 109a acquiring first identification information for the service, from a medium carrying the first identification information; and the judgment unit 112a (i) judging whether or not the request is received before a period during which the content is purchasable in a form of a packaged medium, and (ii) judging, by using the first identification information, whether or not the user is entitled to the service.

The management device 300a includes: the encryption unit 105a, when the request is received before the period and the user is entitled to the service, encrypting the content to generate encrypted content usable only on the terminal device 200a that the user has; and the transmission unit 103a transmitting the encrypted content to the terminal device 200a before the period.

(20) The content-providing system 10a, which provides, to users who receive a service, content corresponding to a movie shown at a site where the service is provided when the users make a payment for the content, may include: the sales device 100a, which sells the content; the management device 300a, which provides the content to users; and the playback device 600a that the user has.

The sales device 100a includes: the first acquisition unit 108a acquiring a request for purchasing the content from a user; the second acquisition unit 109a acquiring first identification information for the service, from a medium carrying the first identification information; the judgment unit 112a (i) judging whether or not the request is received before a period during which the content is purchasable in a form of a packaged medium, and (ii) judging, by using the first identification information, whether or not the user is entitled to the service; the encryption unit 105a, when the request is received before the period and the user is entitled to the service, encrypting the content to generate encrypted content usable only on the terminal device 200a that the user has; and the transmission unit 103a transmitting the encrypted content to the terminal device 200a before the period.

The management device 300a includes: a first reception unit receiving, from the sales device 100a, sales information indicating that the content has been sold to the user, and storing the sales information in the management device 300a; a second reception unit receiving a transmission request from the playback device 600a, the transmission request being a request for transmission of the content; a management device judgment unit judging whether or not the transmission request is received before the period, and judging, by using the sales information stored in the management device 300a, whether or not the user, who uses the playback device 600a, is entitled to use the content, which pertains to the transmission request; a management device encryption unit, when the transmission request is received during the period and the user is entitled to use the content, encrypting the content in accordance with a recording medium that is mounted to the playback device 600a to generate encrypted content; and a management device transmission unit transmitting the encrypted content to the playback device 600a during the period.

(21) The content-providing system 10a, which provides, to users who receive a service, content corresponding to a movie shown at a site where the service is provided when the users make a payment for the content, may include: the sales device 100a, which sells the content; the management device 300a, which provides the content to users; and the medium manufacturing device 700a, which writes the content to a recording medium; and the playback device 600a that the user has.

The sales device 100a includes: the first acquisition unit 108a acquiring a request for purchasing the content from a user; the second acquisition unit 109a acquiring first identification information for the service, from a medium carrying the first identification information; the judgment unit 112a (i) judging whether or not the request is received before a period during which the content is purchasable in a form of a packaged medium, and (ii) judging, by using the first identification information, whether or not the user is entitled to the service; the encryption unit 105a, when the request is received before the period and the user is entitled to the service, encrypting the content to generate encrypted content usable only on the terminal device 200a that the user has; and the transmission unit 103a transmitting the encrypted content to the terminal device 200a before the period.

The management device 300a includes: a first reception unit receiving, from the sales device 100a, sales information indicating that the content has been sold to the user, and storing the sales information in the management device 300a; and a management device judgment unit judging whether or not a present point in time is before the period, and judging, by using the sales information stored in the management device 300a, whether or not the user is entitled to use the content.

The medium manufacturing device 700a includes: a medium manufacturing device encryption unit, when the present point in time is during the period and the user is entitled to use the content, encrypting the content in accordance with the recording medium to generate encrypted content; and a medium manufacturing unit writing the encrypted content to the recording medium.

The playback device 600a includes: a decryption unit decrypting the encrypted content, which is recorded on the recording medium, to generate decrypted content; and a playback unit playing back the decrypted content.

### 2. Embodiment 2

Embodiment 2 provides description on a content distribution system 10b, as another example of implementation of the present invention.

2.1 Content Distribution System 10b

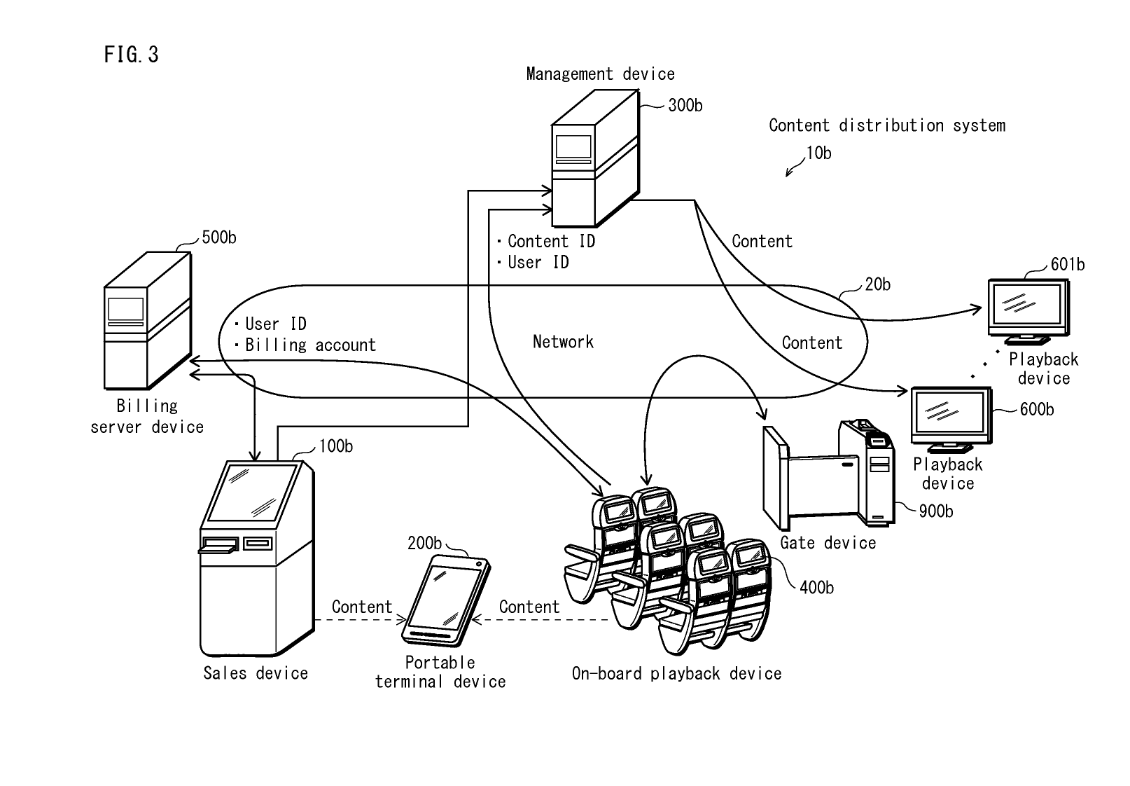

As illustrated in FIG. 3, the content distribution system 10b includes: a sales device 100b; an on-board playback device 400b; a portable terminal device 200b; a management device 300b; a billing server device 500b; playback devices 600b, . . . , 601b; and a gate device 900b. The sales device 100b, the on-board playback device 400b, the portable terminal device 200b, the management device 300b, the billing server device 500b, and the playback devices 600b, . . . , 601b are all connected to a network 20b. The gate device 900b and the on-board playback device 400b are connected to one another via the network 20b.

During an initial release period of a movie, the content distribution system 10b permits selling of content corresponding to the movie only to a user whose terminal device is a portable terminal device and who is entitled to a service. On the other hand, during the initial release period, the content distribution system 10b prohibits selling of the content to users whose terminal device is not a portable terminal device and users who are not entitled to the service.

Specifically, during the initial release period, the content distribution system 10b permits selling of the content to a user who has purchased a movie ticket for a movie shown in a theater or a movie theater. Also, during the initial release period, the content distribution system 10b permits selling of the content to a user who has purchased a boarding pass for boarding an airplane flight. In addition, during the initial release period, the content distribution system 10b permits selling of the content to a user who stays at a hotel.

For example, in the service, a movie may be shown to an audience in a theatrical venue. For example, in the service, a passenger may be transported between airports on an airplane, and a movie may be shown on the airplane for the passenger to watch. For example, in the service, a hotel guest may be allowed to occupy a room in a hotel, and a movie may be shown in the hotel for the hotel guest to watch.

Note that in the present disclosure, an initial release period of movie content refers to a period immediately following the initial release of the movie content in the form of a movie, and is an initial part of the period during which the movie content is made publically available. The initial release period includes: a theatrical release period, an in-flight release period, and an in-hotel release period. The theatrical release period refers to a period during which movie content is shown in the form of a movie in movie theaters and theaters. The in-flight release period refers to a period during which movie content is shown on-board airplanes. The in-hotel release period refers to a period during which movie content is shown in hotels.

The sales device 100b is either located in or near a movie theater. The sales device 100b may be located on-board an airplane or in an airport. The sales device 100b may be located in a hotel. The on-board playback device 400b is installed to a rear side of an airplane passenger seat.

In the content distribution system 10b, a user watches a movie in a movie theater, on-board an airplane, or in a hotel. When wishing to purchase content corresponding to the movie, the user selects the content according to what is displayed on a screen of the sales device 100b or the on-board playback device 400b). Subsequently, the user inputs user information identifying himself/herself, such as a user ID. Subsequently, the user inputs billing information such as a credit card number. The sales device 100b (on-board playback device 400b) performs billing processing with the billing server device 500b.

When the billing processing is completed, the sales device 100b (on-board playback device 400b) transmits the content to the portable terminal device 200b. The portable terminal device 200b receives the content and stores the content therein. This allows the user to watch the content on the portable terminal device 200b.

Note that in the above, a configuration may be made such that a plurality of portable terminal devices are able to play back the content, and further, such that only a limited number of portable terminal devices are able to play back the content. Further, a configuration may be made such that the output of the content from the portable terminal device 200b to a large-sized display device via an HDMI™ cable is prohibited. Further, a configuration may be made such that watermark screening needs to be performed when playing back the content. Further, a configuration may be made such that each time the content is played back or once for every predetermined time period elapsing, a permission of playback needs to be granted from the management device 300b by connecting to the management device 300b via a network.

By setting such restrictions, the security of the content can be strengthened. This reduces the risk of the content being spread in an unauthorized manner. As such, it can be ensured that the release of the content is carried out in accordance with the release window business model.

Note that the above-described obligations are set in a usage rule for the content. A usage rule of content is distributed along with the content. Upon playback, the portable terminal device 200b checks the usage rule and plays back the content in accordance with the usage rule.

Subsequently, the sales device 100b (on-board playback device 400b) transmits, to the management device 300b, a content ID uniquely identifying the content purchased by the user, and user information pertaining to the user. Here, the user information includes, for example, a user ID, a password, an e-mail address, a telephone number, an address, and a credit card number.

The management device 300b manages the content ID and the user information so received, together with the usage rule of the content.

The user is able to use the content on the playback devices 600b, . . . , 601b when the purchasable period of the content is reached (i.e., on and after a purchasable period start date of the content). Here, the purchasable period start date is the date from which the purchasable period of the content starts. For example, a purchasable period start date is a date on which selling of content in the form of a packaged medium is begun, and a date on which distribution of content via a network is begun. To ensure that the release window business model is maintained, the date from which the purchasable period starts is set as the purchasable period start date.

The management device 300b, when receiving a request for the content from any of the playback devices 600b, . . . , 601b, checks the usage rule of the content. When confirmed that the content is available for use, the management device 300b transmits the content to the playback device having transmitted the request. Note that since the purchasable period start date of the content is included in the usage rule, the content is available for use on the playback devices 600b, . . . , 601b on and after the purchasable period start date. In other words, before the purchasable period start date, the use of the content on the playback devices 600b, . . . , 601b is prohibited.

As such, the content, which was available for watching only on one portable terminal device during the initial release period, becomes usable on a plurality of playback devices once the purchasable period begins. In addition, the usage rule of the content, the use of which is limited to only on a single portable terminal device storing the content during the initial release period, is updated once the purchasable period begins. Specifically, various obligations set in the original usage rule (e.g., the necessity of performing watermark screening and network connection) are moderated in the updated usage rule. In other words, once the purchasable period begins, it is no longer required to perform watermark screening, network connection, etc., when using the content.

Above, description is provided that the user inputs the user information, the billing information, etc. Alternatively, the user information, the billing information, etc., may be registered to the portable terminal device 200b in advance, and may be transmitted from the portable terminal device 200b to the sales device 100b or the on-board playback device 400b. Alternatively, information stored on a credit card may be read as the billing information.

2.2 Sales Device 100b

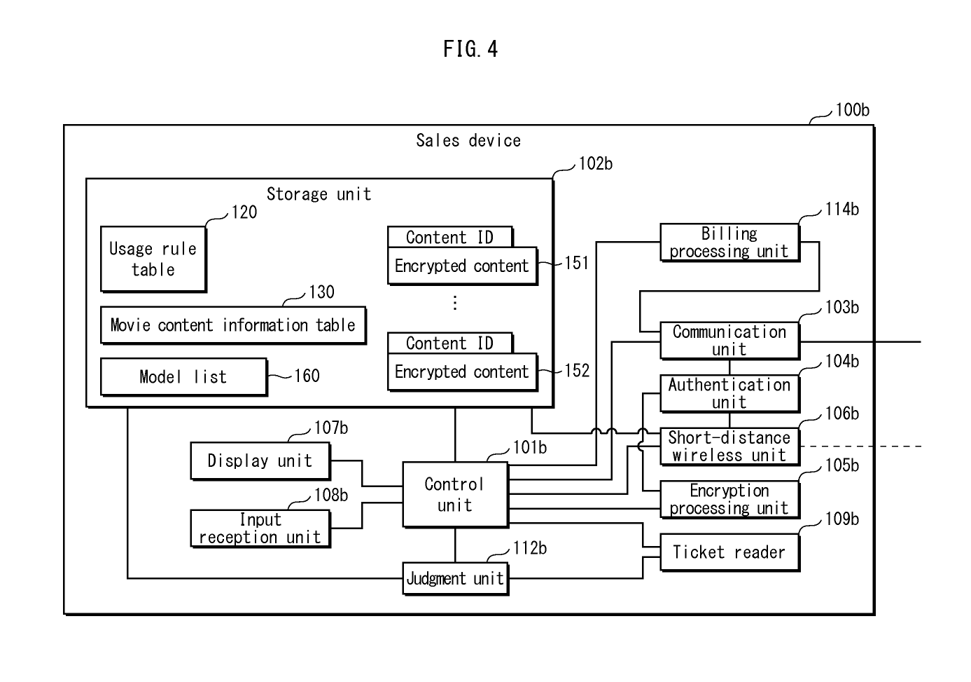

As illustrated in FIG. 4, the sales device 100b includes: a control unit 101b; a storage unit 102b; a communication unit 103b; an authentication unit 104b; an encryption processing unit 105b; a short-distance wireless unit 106b; a display unit 107b; an input reception unit 108b; a ticket reader 109b; a judgment unit 112b; and a billing processing unit 114b.

In specific, the sales device 100b includes a microprocessor, a RAM, a ROM, a hard disk device, etc., which are not illustrated in FIG. 4. The microprocessor operates in accordance with computer programs stored in the RAM, the ROM, and the hard disk device, whereby the sales device 100b achieves the functions thereof.

Note that functional blocks of the sales device 100b, such as the control unit 101b, the communication unit 103b, the authentication unit 104b, the encryption processing unit 105b, the short-distance wireless unit 106b, the ticket reader 109b, the judgment unit 112b, and the billing processing unit 114b, are typically implemented by using LSIs, which is one type of an integrated circuit. The implementation of the above-described functional blocks by using LSIs may be performed such that a single LSI chip is used for each individual functional block.

Alternatively, the above-described functional blocks may be implemented by using LSIs each including one or more of such functional blocks, or by using LSIs each including a part of each of the functional blocks.

(1) Display Unit 107b, Input Reception Unit 108b, Ticket Reader 109b

The display unit 107b displays a screen for having a user purchase content. The display unit 107b displays a screen for receiving input from a user. A user, according to what is displayed on-screen by the display unit 107b, goes through procedures such as: selecting content; inputting user information; inputting billing information; and receiving content.

The input reception unit 108b receives an operation for purchasing content from a user. In addition, the input reception unit 108b receives from a user input of user information, billing information, etc., and outputs the user information, the billing information, etc., to the control unit 101b.

Above, description is provided that a user manually inputs user information. However, user information may be set to the portable terminal device 200b in advance. In such a case, the sales device 100b acquires user information from the portable terminal device 200b via the short-distance wireless unit 106b.

Above, description is provided that a user inputs billing information, such as a credit card number. However, the sales device 100b may acquire billing information by scanning and thus reading information stored on a credit card. Further, when credit card information and user information are managed in an associated state, the sales device 100b may regard that input of user information is completed when credit card information is read.

The ticket reader 109b reads a bar code or a QR Code (trademark) printed on a movie ticket. Here, description is provided assuming that the sales device 100b is located in a movie theater or a theater. By reading a bar code or a QR Code on a movie ticket, the ticket reader 109b acquires ticket information from the bar code or the QR code, and outputs the acquired ticket information to the judgment unit 112b. When ticket information is acquired from a movie ticket, the ticket information includes: (i) identification information indicating a movie ticket; (ii) a movie theater ID identifying a movie theater; (iii) a content ID identifying content corresponding to a movie shown in the movie theater; and (iv) date/time information indicating the date/time that the movie is shown. In addition to the above, ticket information acquired from a movie ticket may also include a seat ID identifying a seat in the movie theater.

Note that when the sales device 100b is located in an airplane or an airport, the ticket reader 109b reads a bar code or a QR Code printed on a boarding pass for an airplane flight. By reading a bar code or a QR Code on a boarding pass, the ticket reader 109b acquires ticket information from the bar code or the QR Code, and outputs the acquired ticket information to the judgment unit 112b. When ticket information is acquired from a boarding pass, the ticket information includes: (i) identification information indicating a boarding pass; (ii) a flight ID identifying a flight; (iii) the name, the age, and the sex of a passenger of the flight; (iv) date/time information indicating the date/time that the flight departs; and (v) a seat ID identifying a seat in an airplane. In this case, a storage unit 102b, description on which is provided later in the present disclosure, stores a flight ID and a content ID in an associated state. This enables a content ID to be extracted from a flight ID printed on a boarding pass.

Note that, when the sales device 100b is located in a hotel, the ticket reader 109b reads key information from a cardkey. A cardkey is used for locking and unlocking a hotel room that a hotel guest occupies. The ticket reader 109b outputs the key information so read to the judgment unit 112b. Here, the key information includes: (i) identification information indicating a cardkey; (ii) a hotel ID identifying a hotel; (iii) a room ID identifying a room of the hotel; (iv) the name, the age, and the sex of a guest at the hotel; (v) and date/time information indicating the date/time during which the guest stays at the hotel. In this case, the storage unit 102b stores a room ID and a content ID in an associated state. This enables a content ID to be extracted from a room ID stored in a cardkey.

Above, description is provided that specification of content is made by a user selecting content via the input reception unit 108b. Alternatively, a content ID of content may be automatically specified through the above-described procedures. In specific, content to be purchased may be specified according to a content ID included in ticket information acquired by the ticket reader 109b.

(2) Storage Unit 102b

Specifically, the storage unit 102b is composed of a hard disk drive.

The storage unit 102b stores therein: a usage rule table 120; a movie content information table 130; encrypted content 151, . . . , 152; and a model list 160.

Usage Rule Table 120

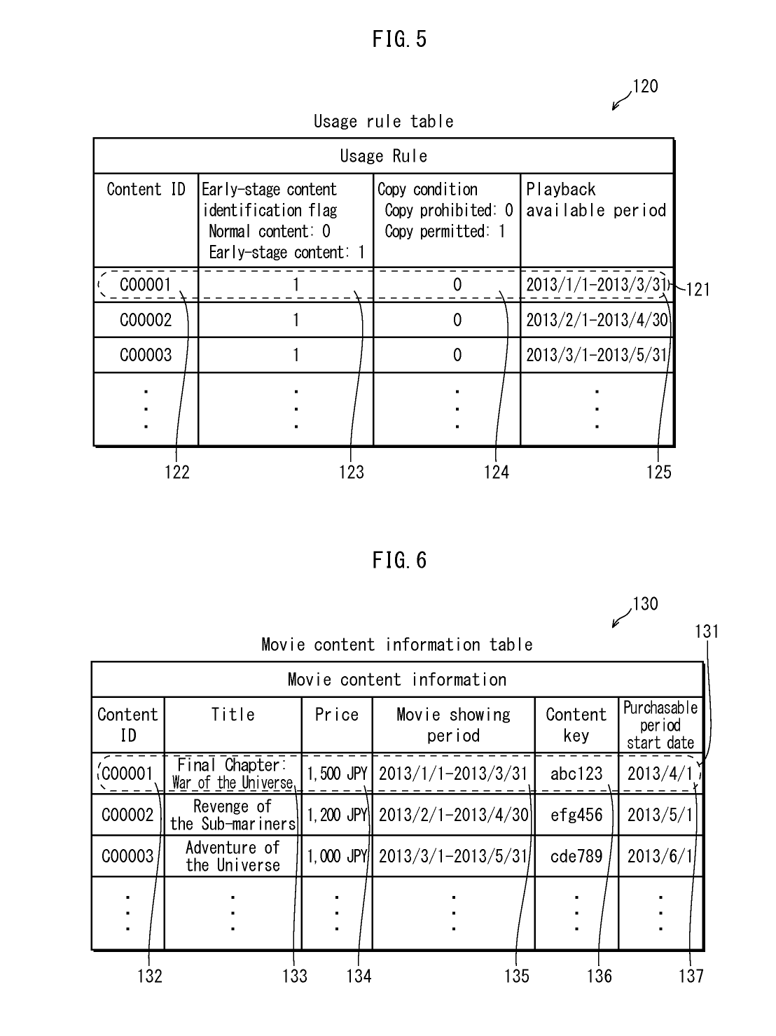

FIG. 5 illustrates one example of the usage rule table 120. The usage rule table 120 illustrated in FIG. 5 has areas for storing a plurality of usage rules. Each usage rule corresponds to corresponding content. Each usage rule includes: a content ID; an early-stage content identification flag; a copy condition; and a playback-available period.

In each usage rule, a content ID uniquely identifies corresponding content.

In each usage rule, an early-stage content identification flag indicates whether the corresponding content is content sold during the initial release period or content sold during the purchasable period. Specifically, “1” set to the early-stage content identification flag indicates that the corresponding content is content sold during the initial release period. On the other hand, “0” set to the early-stage content identification flag indicates that the corresponding content is content sold during the purchasable period.

In each usage rule, a copy condition indicates whether or not duplication of the corresponding content is permitted. “1” set to the copy condition indicates that duplication of the corresponding content is permitted. On the other hand, “0” set to the copy condition indicates that duplication of the corresponding content is prohibited.

In each usage rule, a playback-available period indicates a period during which playback of the corresponding content is permitted. The playback-available period includes a playback start date and a playback end date. The playback start date indicates the day, the month, and the year of the date starting from which playback of the corresponding content is permitted. The playback end date indicates the day, the month, and the year of the date until which playback of the corresponding content is permitted.

As illustrated in FIG. 5, the usage rule table 120 includes a usage rule 121. The usage rule 121 includes: a content ID 122 indicating “C00001”; an early-stage content identification flag 123 indicating “1”; a copy condition 124 indicating “0”; and a playback-available period 125 indicating “2013/1/1-2013/3/31”. The usage rule 121 indicates that the corresponding content, which is indicated by a content ID “C00001”, is content sold during the initial release period and that duplication of the corresponding content is not permitted. The usage rule 121 also indicates that the playback-available period of the corresponding content starts on Jan. 1, 2013 and ends on Mar. 31, 2013.

Note that a usage rule may additionally include a purchasable period start date of corresponding content. In such a case, the portable terminal device 200b or the playback devices 600b, . . . , 601b, on or after the purchasable period start date of the corresponding content, may update the early-stage content identification flag included in the usage rule so as to indicate “0” even when the early-stage content identification flag originally indicates “1”.

### (Movie Content Information Table 130)

FIG. 6 illustrates one example of the movie content information table 130. The movie content information table 130 illustrated in FIG. 6 has areas for storing a plurality of pieces of movie content information. Each piece of movie content information corresponds to corresponding content. Each piece of movie content information includes: a content ID; a title; a price; a movie showing period; a content key; and a purchasable period start date.

In each piece of movie content information, a content ID uniquely identifies corresponding content.

In each piece of movie content information, a title is a title indicating the corresponding content.

In each piece of movie content information, a price indicates a price of the corresponding content when sold.

In each piece of movie content information, a movie showing period indicates a period during which the corresponding content is shown in theaters and movie theaters. The movie showing period includes a showing start date and a showing end date. The showing start date indicates, the day, the month, and the year of the date starting from which the showing of the corresponding content in the form of a movie in theaters and movie theaters is performed. The showing end date indicates, the day, the month, and the year of the date until which the showing of the corresponding content in the form of a movie in theaters and movie theaters is performed.

In each piece of movie content information, a content key is a key that is used when the corresponding content is to be encrypted and when encrypted content corresponding to the content is to be decrypted. A secret key cryptosystem is used as an encryption algorithm when encrypting/decrypting content. One example of the encryption algorithm is the Advanced Encryption Standard (AES).

In each piece of movie content information, a purchasable period start date is the purchasable period start date of the corresponding content.

As illustrated in FIG. 6, the movie content information table 130 includes movie content information 131. The movie content information 131 includes: a content ID 132 indicating “C00001”; a title 133 indicating “Final Chapter: War of the Universe”, a price 134 indicating “1,500 JPY”, a movie showing period 135 indicating “2013/1/1-2013/3/31”, a content key 136 indicating “abc123”, and a purchasable period start date 137 indicating “2013/4/1”.

(Encrypted Content 151, . . . , 152)

Each encrypted content 151, . . . , 152 is generated by encrypting corresponding content by using a content key.

encrypted content=E(content key, content)

In the above, E(A, B) represents encrypted text generated by encrypting plaintext B by applying encryption algorithm E and by using a key A. Here, the encryption algorithm E is an encryption algorithm that uses a secret key cryptosystem. An example of the encryption algorithm E is AES.

Encrypted content 151, . . . , 152 can each be identified by a corresponding content ID.

(Model List 160)

The model list 160 includes a plurality of model IDs. Each model ID identifies a corresponding model of portable terminal devices. In the present disclosure, a portable terminal device is defined as a terminal device having a display screen of a predetermined size or smaller. For instance, the predetermined size is 300 dots in the vertical direction and 240 dots in the lateral direction.

(Other Information)

When the sales device 100b is located in an airplane or an airport, the storage unit 102b stores a flight ID and a content ID in an associated state. The flight IDs each identify a corresponding airplane flight. This enables a content ID to be extracted from a flight ID printed on a boarding pass.

When the sales device 100b is located in a hotel, the storage unit 102b stores a room ID and a content ID in an associated state. This enables a content ID to be extracted from a room ID stored in a cardkey.

(3) Short-distance Wireless Unit 106b

The short-distance wireless unit 106b receives a content ID from the control unit 101b. Further, the short-distance wireless unit 106b reads out encrypted content stored in the storage unit 102b according to the received content ID. Further, the short-distance wireless unit 106b transmits the encrypted content so read out to the portable terminal device 200b via WiGig, for example. WiGig is a specification for wireless communication in the 60 GHz band.

In addition, the short-distance wireless unit 106b receives a usage rule from the control unit 101b. Further, the short-distance wireless unit 106b transmits the received usage rule to the portable terminal device 200b via WiGig, for example.

In addition, the short-distance wireless unit 106b receives an encrypted content key from the control unit 101b. Further, the short-distance wireless unit 106b transmits the received encrypted content key to the portable terminal device 200b via WiGig, for example.

(4) Communication Unit 103b, Authentication Unit 104b, Encryption Processing Unit 105b

The communication unit 103b performs transmission and reception of information with the management device 300b and the billing server 500b, via the network 20b. The information that the communication unit 103b exchanges with the management device 300b and the billing server 500b includes user information, billing information, a content ID, and content. The communication unit 103b may perform either wired communication or wireless communication.

The authentication unit 104b performs mutual authentication and key sharing with the portable terminal device 200b, the management device 300b, and the billing server device 500b. Conventional technology such as Elliptic Curve Digital Signature Standard (ECDSA), Elliptic Curve Diffie-Hellman (ECDH), and AES are applicable in mutual authentication and key sharing. Note that detailed explanation concerning mutual authentication and key sharing is not provided here in the present disclosure. Further, the procedures through which mutual authentication and key sharing are performed are described in detail later in the present disclosure.

The encryption processing unit 105b performs encryption processing, utilizing encryption technology, for confirming a communication opponent, and encryption processing for ensuring confidentiality of data. Conventional technology such as ECDSA, ECDH, and AES are applicable in encryption processing. Note that detailed explanation concerning encryption processing is not provided here in the present disclosure.

(5) Judgment Unit 112b

The judgment unit 112b judges whether or not a user is certified (or is entitled to) purchase content. Here, the content is a content corresponding to a movie currently being shown at theaters, and the content is exclusively sold, during the initial release period of the content, to users who have watched the movie.

In specific, the judgment unit 112b receives ticket information from the ticket reader 109b. As already described above, when ticket information is acquired from a movie ticket, the ticket information includes: (i) identification information indicating a movie ticket; (ii) a movie theater ID identifying a movie theater; (iii) a content ID identifying content corresponding to a movie shown in the movie theater; (iv) date/time information indicating the date/time that the movie is shown; and (v) a seat ID identifying a seat in the movie theater.

The judgment unit 112b judges whether or not the received ticket information has been acquired from a movie ticket by using the identification information indicating a movie ticket. Further, the judgment unit 112b judges whether or not the content ID included in the ticket information is included in the movie content information table 130.

The judgment unit 112b, when judging that the ticket information has been acquired from a movie ticket and that the content ID included in the ticket information is included in the movie content information table 130, judges that a user is certified (or is entitled) to purchase content.

Note that the portable terminal device 200b may be provided with a function, such as a GPS function, for acquiring location information. In such a case, the sales device 100b acquires, from the portable terminal device 200b, location information indicating a location of the portable terminal device 200b. Further, the judgment unit 112b judges whether or not the location of the portable terminal device 200b indicated by the location information indicates that the portable terminal device 200b is inside a theater. In other words, the judgment unit 112b judges whether or not the portable terminal device 200b is being operated inside a theater or a movie theater. As such, the judgment unit 112b judges that a user that has the portable terminal device 200a is inside a theater or a movie theater. In other words, the judgment unit 112b judges that the user has seen movie content or is in a state of being able to see the movie content, and thus, is certified (or is entitled) to purchase the content.

In addition, the judgment unit 112b may compare a showing date/time of content corresponding to a movie and the date/time indicated by date/time information included in ticket information, and judge that a user is certified to purchase the content when the showing date/time and the date/time acquired from a movie ticket match.

When the sales device 100b is located in an airplane or an airport, the judgment unit 112b receives ticket information from the ticket reader 109b. When ticket information is acquired from a boarding pass, the ticket information includes: (i) identification information indicating a boarding pass; (ii) a flight ID identifying a flight; (iii) the name, the age, and the sex of a passenger of the flight; (iv) date/time information indicating the date/time that the flight departs; and (v) a seat ID identifying a seat in an airplane. In this case, the storage unit 102b stores a flight ID and a content ID in an associated state. The judgment unit 112b judges whether or not a flight ID that is the same as the flight ID included in the ticket information is stored in the storage unit 102b in association with a content ID. When judging that the same flight ID as that included in the ticket information is stored in the storage unit 102b in association with a content ID, the judgment unit 112b further judges whether or not the associated content ID is included in the movie content information table 130. The judgment unit 112b, when the content ID is included in the movie content information table 130, judges that the user has seen movie content or is in a state of being able to see the movie content, and thus that the user is certified (or is entitled) to purchase the content.

When the sales device 100b is located in a hotel, the judgment unit 112b receives key information from the ticket reader 109b. Here, the key information includes: (i) identification information indicating a cardkey; (ii) a hotel ID identifying a hotel; (iii) a room ID identifying a room of the hotel; (iv) the name, the age, and the sex of a guest at the hotel; (v) and date/time information indicating the date/time during which the guest stays at the hotel. In this case, the storage unit 102b stores a room ID and a content ID in an associated state. The judgment unit 112b judges whether or not a room ID that is the same as the room ID included in the key information is stored in the storage unit 102b in association with a content ID. When judging that the same room ID as that included in the key information is stored in the storage unit 102b in association with a content ID, the judgment unit 112b further judges whether or not the associated content ID is included in the movie content information table 130. The judgment unit 112b, when the content ID is included in the movie content information table 130, judges that a user has seen movie content or is in a state of being able to see the movie content, and thus, that the user is certified (or is entitled) to purchase the content.

In addition, the judgment unit 112b receives a model ID 261 from a portable terminal device 200b via a secure communication path. Further, the judgment unit 112b judges whether or not the received model ID 261 exists in the model list 160. When the received model ID 261 does not exist in the model list 160, the judgment unit 112b judges that the portable terminal device 200b is a model that is not a portable terminal device as defined in the present disclosure. In this case, the display unit 107b displays a message to that effect.

When the model ID 261 exists in the model list 160, the judgment unit 112b judges that the portable terminal device 200b is a portable terminal device as defined in the present disclosure.

(6) Control Unit 101b

The control unit 101b selects one content from among the encrypted content 151, . . . , 152 stored in the storage unit 102b in accordance with a selection of content made by a user and received by the input reception unit 108b. Further, the control unit 101b acquires a content ID identifying the selected content. Further, the control unit 101b outputs the acquired content ID to the short-distance wireless unit 106b.

In addition, the control unit 101b acquires a content ID identifying selected content, in accordance with a selection of content made by a user. Further, the control unit 101b reads out, from the movie content information table 130, movie content information including the acquired content ID. Further, the control unit 101b extracts a content key from the movie content information so read out. Further, the control unit 101b outputs the extracted content key and a device key received from the portable terminal device 200b to the encryption processing unit 105b, and causes the encryption processing unit 105b to encrypt the content key by using the device key. As such, an encrypted content key is generated.

encrypted content key=E(device key, content key)

Further, the control unit 101b outputs the encrypted content key to the short-distance wireless unit 106b.

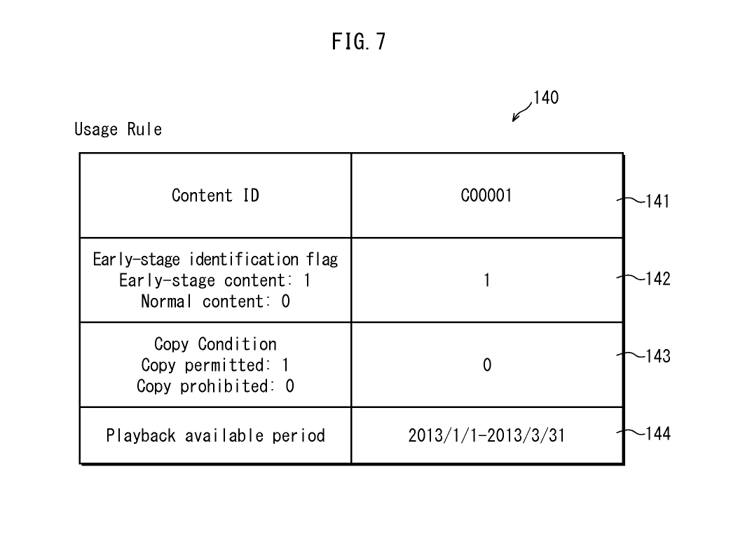

In addition, the control unit 101b acquires a content ID identifying selected content, in accordance with a selection of content made by a user. Further, the control unit 101b extracts, from the usage rule table 120, a usage rule including the acquired content ID. FIG. 7 illustrates one example of a usage rule extracted by the control unit 110b. FIG. 7 illustrates a usage rule 140 including: a content ID 141 indicating “C00001”; an early-stage content identification flag 142 indicating “1”; a copy condition 143 indicating “0”; and a playback-available period 144 indicating “2013/1/1-2013/3/31”. Details of the information included in a usage rule are already described above. Further, the extracted usage rule is output to the short-distance wireless unit 106b.

In addition, the control unit 101b realizes the functions of the sales device 100b by controlling the storage unit 102b, the communication unit 103b, the authentication unit 104b, the encryption processing unit 105b, the short-distance wireless unit 106b, the display unit 107b, the input reception unit 108b, the ticket reader 109b, the judgment unit 112b, and the billing processing unit 114b.

2.3 On-board Playback Device 400b

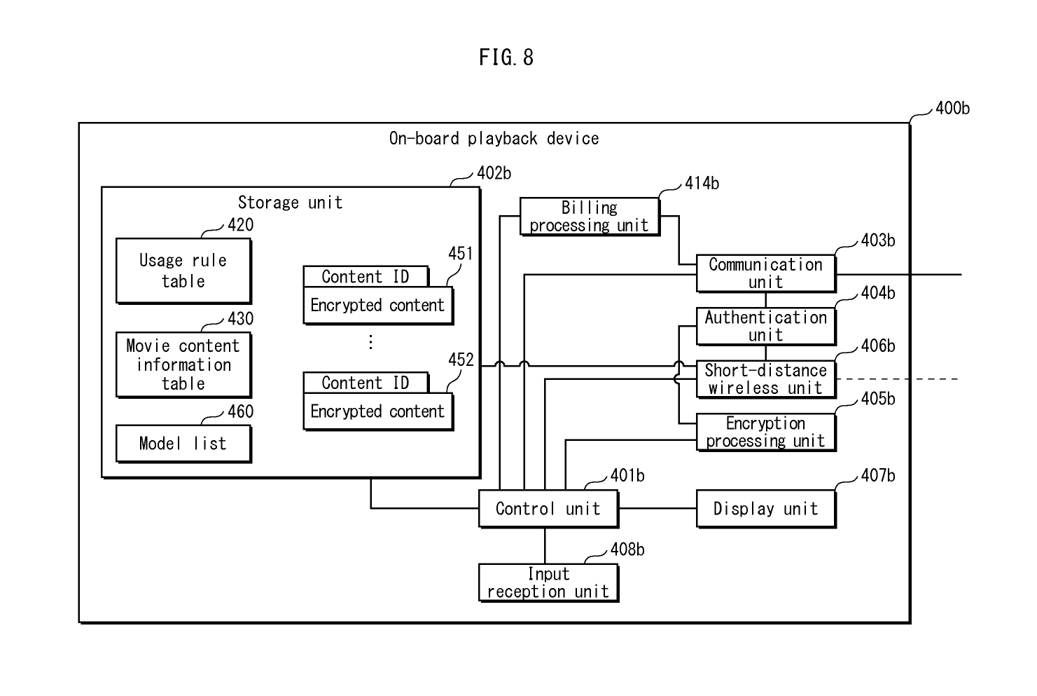

As illustrated in FIG. 8, the on-board playback device 400b includes: a control unit 401b; a storage unit 402b; a communication unit 403b; an authentication unit 404b; an encryption processing unit 405b; a short-distance wireless unit 406b; a display unit 407b; an input reception unit 408b; and a billing processing unit 414b.

In specific, the on-board playback device 400b includes a microprocessor, a RAM, a ROM, a hard disk, etc., which are not illustrated in FIG. 8. The microprocessor operates in accordance with computer programs stored in the RAM, the ROM, and the hard disk device, whereby the on-board playback device 400b achieves the functions thereof.

Note that functional blocks of the on-board playback device 400b, such as the control unit 401b, the communication unit 403b, the authentication unit 404b, the encryption processing unit 405b, the short-distance wireless unit 406b, and the billing processing unit 414b, are typically implemented by using LSIs, which is one type of an integrated circuit. The implementation of the above-described functional blocks by using LSIs may be performed such that a single LSI chip is used for each individual functional block. Alternatively, the above-described functional blocks may be implemented by using LSIs each including one or more of such functional blocks, or by using LSIs each including a part of each of the functional blocks.

The functional blocks may be implemented by using software, or a combination of software and LSIs. In such a case, the software may be tamper resistant.

(1) Display Unit 407b, Input Reception Unit 408b

The display unit 407b plays back and displays content when a user performs operations.

The display unit 407b displays a screen for having a user purchase content. The display unit 407b displays a screen for receiving input from a user. A user, according to what is displayed on-screen by the display unit 407b, goes through procedures such as: selecting content; inputting user information; inputting billing information; and receiving content. The display unit 407b plays back and displays content stored in the storage unit 402b. When playing back and displaying content, the display unit 407b may display a screen enabling a user to select the content, in order to allow the user to purchase the content when the user has finished watching the content or when the user has watched the content up to a certain point.

The input reception unit 408b receives user operations for playing back content. In addition, the input reception unit 408b receives user operations for purchasing content. Further, the input reception unit 408b receives from a user input of user information, billing information, etc., and outputs the user information, the billing information, etc., to the control unit 401b.

Above, description is provided that a user inputs billing information, such as a credit card number. However, the input reception unit 408b may acquire billing information by scanning and thus reading information stored on a credit card. Further, when credit card information and user information are managed in an associated state, the input reception unit 408b may regard that input of user information is completed when credit card information is read.

(2) Storage Unit 402b

Specifically, the storage unit 402b is composed of a hard disk drive.

The storage unit 402b has storage areas for storing: a usage rule table 420; a movie content information table 430; encrypted content 451, . . . , 452; and a model list 460.

Here, the usage rule table 420, the movie content information table 430, the encrypted content 451, . . . , 452, and the model list 460 have the same data structures as the usage rule table 120, the movie content information table 130, the encrypted content 151, . . . , 152, and the model list 160 stored in the storage unit 102b, respectively. As such, further description thereon is not provided.

(4) Short-distance Wireless Unit 406b, Communication Unit 403b, Authentication Unit 404b, Encryption Processing Unit 405b

The short-distance wireless unit 406b, the communication unit 403b, the authentication unit 404b, and the encryption processing unit 405b have configurations similar to those of the short-distance wireless unit 106b, the communication unit 103b, the authentication unit 104b, and the encryption processing unit 105b of the sales device 100b, respectively. As such, further description thereon is not provided.

(4) Control Unit 401b

The control unit 401b selects one content from among the encrypted content 451, . . . , 452 stored in the storage unit 402b in accordance with a selection of content made by a user and received by the input reception unit 408b. Further, the control unit 401b acquires a content ID identifying the selected content. Further, the control unit 401b outputs the acquired content ID to the short-distance wireless unit 406b.

In addition, the control unit 401b acquires a content ID identifying selected content, in accordance with a selection of content made by a user. Further, the control unit 401b reads out, from the movie content information table 430, movie content information including the acquired content ID. Further, the control unit 401b extracts a content key from the movie content information so read out. Further, the control unit 401b outputs the extracted content key and a device key received from the portable terminal device 200b to the encryption processing unit 405b, and causes the encryption processing unit 405b to encrypt the content key by using the device key. As such, an encrypted content key is generated.

encrypted content key=E(device key, content key)

Further, the control unit 401b outputs the encrypted content key to the short-distance wireless unit 406b.

In addition, similar to the control unit 101b, the control unit 401b acquires a content ID identifying selected content, and extracts, from the usage rule table 420, a usage rule including the acquired content ID. Further, the extracted usage rule is output to the short-distance wireless unit 406b.

In addition, the control unit 401b realizes the functions of the on-board playback device 400b by controlling the storage unit 402b, the communication unit 403b, the authentication unit 404b, the encryption processing unit 405b, the short-distance wireless unit 406b, the display unit 407b, the input reception unit 408b, and the billing processing unit 414b.

2.4 Portable Terminal Device 200b

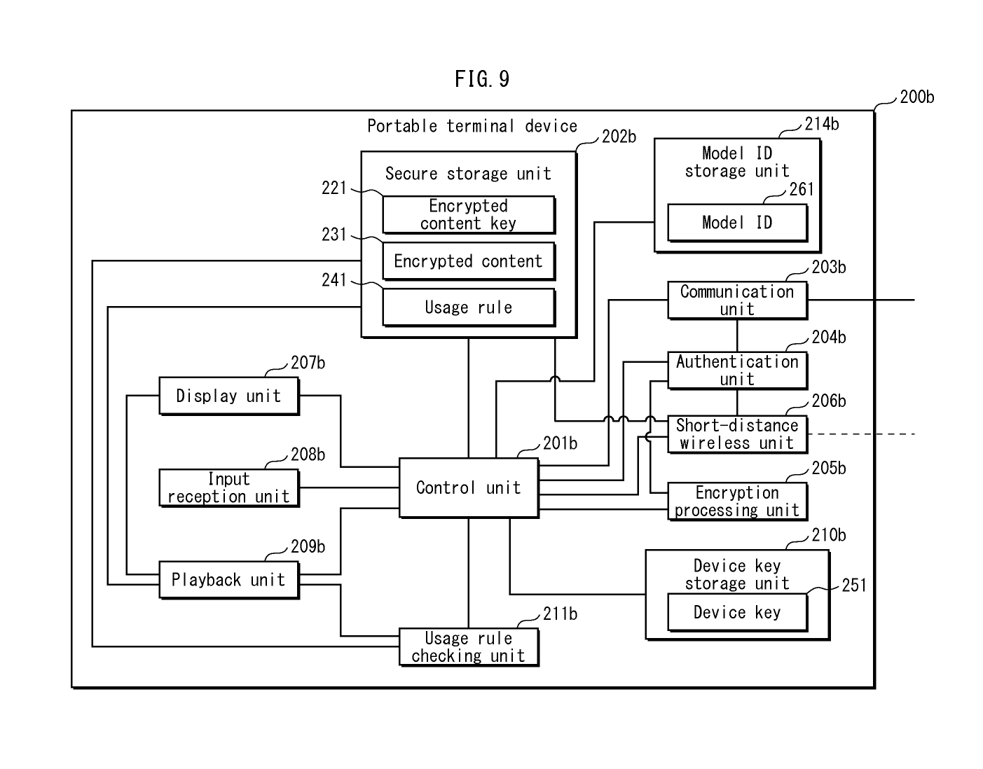

As illustrated in FIG. 9, the portable terminal device 200b includes: a control unit 201b; a secure storage unit 202b; a communication unit 203b; an authentication unit 204b; an encryption processing unit 205b; a short-distance wireless unit 206b; a display unit 207b; an input reception unit 208b; a playback unit 209b; a device key storage unit 210b; a usage rule checking unit 211b; and a model ID storage unit 214b.

In specific, the portable terminal device 200b includes a microprocessor, a RAM, a ROM, a hard disk, etc. The microprocessor operates in accordance with computer programs stored in the RAM, the ROM, and the hard disk device, whereby the portable terminal device 200b achieves the functions thereof.

Note that functional blocks of the portable terminal device 200b, such as the control unit 201b, the secure storage unit 202b, the communication unit 203b, the authentication unit 204b, the encryption processing unit 205b, the short-distance wireless unit 206b, the playback unit 209b, the device key storage unit 210b, and the usage rule checking unit 211b, are typically implemented by using LSIs, which is one type of an integrated circuit. The implementation of the above-described functional blocks by using LSIs may be performed such that a single LSI chip is used for each individual functional block. Alternatively, the above-described functional blocks may be implemented by using LSIs each including one or more of such functional blocks, or by using LSIs each including a part of each of the functional blocks.

(1) Display Unit 207b, Input Reception Unit 208b

The display unit 207b includes a display screen having the predetermined size or a smaller size. For instance, the size of the display screen is 300 dots or smaller in the vertical direction and 240 dots or smaller in the lateral direction. Thus, the display screen of the display unit 207b has a smaller size than display screens that the playback devices 600b, . . . , 601b have. The playback devices 600b, . . . , 601b are described in detail later in the present disclosure. In addition, the display unit 207b includes a speaker.

The display unit 207b displays a screen for having user watch content. The display unit 407b displays a screen for receiving input from a user. A user, according to what is displayed on-screen by the display unit 207b, makes a selection of content, inputs user information, etc. The display unit 207b receives video data and audio data from the playback unit 209b, and outputs the received video data as video and the received audio data as audio.

The input reception unit 208b receives from a user input of user information, billing information, etc., and outputs the user information, the billing information, etc., so received to the control unit 201b.

(2) Secure Storage Unit 202b, Device Key Storage Unit 210b, Model ID Storage Unit 214b

For example, the secure storage unit 202b is composed of a non-volatile semiconductor memory. FIG. 9 illustrates one example of the secure storage unit 202b. The secure storage unit 202b illustrated in FIG. 9 has storage areas for storing: an encrypted content key 221; encrypted content 231; and a usage rule 241.

The encrypted content key 221 is generated by encrypting a content key by using a device key in the manner described above. In this case, the device key used for generating the encrypted content key 221 is a device key 251 of the portable terminal device 200b.

The encrypted content 231 is generated by encrypting content by using the content key.

The usage rule 241 includes the above-described information included in a usage rule. That is, the usage rule 241 includes: a content ID; an early-stage content identification flag; a copy condition; and a playback-available period.

For example, the device key storage unit 210b is composed of a non-volatile semiconductor memory. The device key storage unit 210b stores, for example, the device key 251. The device key 251 is a key that is uniquely assigned to the portable terminal device 200b. The device key 251 is written to the device key storage unit 210b when the portable terminal device 200b is manufactured.

For example, the model ID storage unit 214b is composed of a non-volatile semiconductor memory. The model ID storage unit 214b stores the model ID 261. The model ID 261 is identification information identifying the model (a type) of the portable terminal device 200b.

(3) Short-distance Wireless Unit 206b

The short-distance wireless unit 206b receives encrypted content, an encrypted content key, and a usage rule from the sales device 100b via WiGig, for example. Further, the short-distance wireless unit 206b writes the encrypted content, the encrypted content key, and the usage rule so received to the secure storage unit 202b.

(4) Communication Unit 203b, Authentication Unit 204b, Encryption Processing Unit 205b

The communication unit 203b performs transmission and reception of information with the management device 300b. The information that the communication unit 203b exchanges with the management device 300b includes a content ID, user information, content, etc. The communication unit 203b may perform either wired communication or wireless communication.

The authentication unit 204b performs mutual authentication and key sharing with the management device 300b. The authentication unit 204b performs mutual authentication and key sharing as already described above.

The encryption processing unit 205b performs encryption processing, utilizing encryption technology, for confirming a communication opponent, and encryption processing for ensuring confidentiality of data.

(5) Usage Condition Checking Unit 211b

The usage rule checking unit 211b receives a content ID from the control unit 201b, and reads out a usage rule including the received content ID from the secure storage unit 202b. Further, the usage rule checking unit 211b checks the conditions described in the usage rule so read out.

Specifically, the usage rule checking unit 211b extracts an early-stage content identification flag from the usage rule so read out. Further, the usage rule checking unit 211b judges whether or not the extracted early-stage content identification flag indicates “1”. When the early-stage content identification flag indicates “1”, the usage rule checking unit 211b instructs the playback unit 209b to perform a predetermined operation. Here, the predetermined operation refers, for instance, to an operation such as detecting a watermark embedded into content and accessing the management device 300b each time content is played back or once for every predetermined time period elapsing.

The usage rule checking unit 211b extracts a copy condition from the usage rule so read out. Further, the usage rule checking unit 211b checks whether or not the extracted copy condition indicates “0”. When the copy condition indicates “0”, the usage rule checking unit 211b instructs the control unit 201b not to permit duplication of content.

In addition, the usage rule checking unit 211b acquires the present date, and extracts a playback-available period from the usage rule so read out. Further, the usage rule checking unit 211b judges whether or not the present date so acquired is included in the playback-available period. When the present date is included in the playback-available period, the usage rule checking unit 211b permits the playback unit 209b to play back content. When the present date is not included in the playback-available period, the usage rule checking unit 211b prohibits the playback unit 209b from playing back content.

(6) Playback Unit 209b

The playback unit 209b receives an instruction to play back content and a content ID from the control unit 201b. In addition, the playback unit 209b receives, from the usage rule checking unit 211b, an instruction indicating whether playback of content is permitted or prohibited, and an instruction indicating whether or not to perform the predetermined operation.

When receiving, from the usage rule checking unit 211b, an instruction indicating prohibition of playback of content, the playback unit 209b does not perform playback of content.

When receiving, from the usage rule checking unit 211b, an instruction indicating whether or not to perform the predetermined operation, the playback unit 209b either performs or does not perform the predetermined operation, according to the instruction. Specifically, when the instruction indicates accessing the management device 300b, the playback unit 209b accesses the management device 300b via the communication unit 203b. In such a case, when unable to connect to the management device 300b, playback of content is prohibited. On the other hand, when able to connect to the management device 300b in such a case, the playback unit 209b receives, from the management device 300b, an instruction indicating permission of playback of content or an instruction indicating prohibition of playback of content. When receiving the instruction indicating prohibition of playback of content, the playback unit 209b does not playback content. Meanwhile, when the instruction received from the usage rule checking unit 211b indicates detecting a watermark, the playback unit 209b performs the detection of a watermark as described later in the present disclosure.

When receiving, from the usage rule checking unit 211b, the instruction indicating permission to play back content, the playback unit 209b commences playback of encrypted content indicated by the received content ID.

In specific, the playback unit 209b instructs and controls the encryption processing unit 205b to decrypt an encrypted content key stored in the secure storage unit 202b by using a device key stored in the device key storage unit 210b. As such, a content key is generated.

content key=D(device key, encrypted content key)

In the above, D(A, B) represents decrypted text generated by decrypting encrypted text B by applying decryption algorithm A corresponding to the encryption algorithm E and by using the key A. Here, the decryption algorithm D is a decryption algorithm that uses a secret key cryptosystem. An example of the decryption algorithm D is AES.

Further, the playback unit 209b instructs and controls the encryption processing unit 205b to decrypt encrypted content stored in the secure storage unit 202b by using the generated content key. As such, content is generated.

content=D(content key, encrypted content)

Meanwhile, when having received from the usage rule checking unit 211b an instruction indicating detecting a watermark, the playback unit 209b judges whether or not a predetermined watermark is embedded at a predetermined portion of the generated content. When judging that the predetermined watermark is embedded in the content, the playback unit 209b continues the playback of content as described in the following. On the other hand, when judging that the predetermined watermark is not embedded in the content, the playback unit 209b suspends playback of the content at the point when the judgment is made.

Further, the playback unit 209b decompresses the generated content to generate video data and audio data, and outputs the video data and the audio data so generated to the display unit 207b.

(7) Control Unit 201b

The control unit 201b receives, from the usage rule checking unit 211b, an instruction indicating whether or not duplication of content is permitted. Further, the control unit 201b controls the duplication of content according to the instruction.

The control unit 201b instructs the playback unit 209b to play back content in accordance with a selection made by a user. In addition, the control unit 201b outputs, to the playback unit 209b, a content ID identifying content to be played back.

In addition, the control unit 201b realizes the functions of the portable terminal device 200b by controlling the secure storage unit 202b, the communication unit 203b, the authentication unit 204b, the encryption processing unit 205b, the short-distance wireless unit 206b, the display unit 207b, the input reception unit 208b, the playback unit 209b, the device key storage unit 210b, and the usage rule checking unit 211b.

2.5 Configuration of Billing Server Device 500b

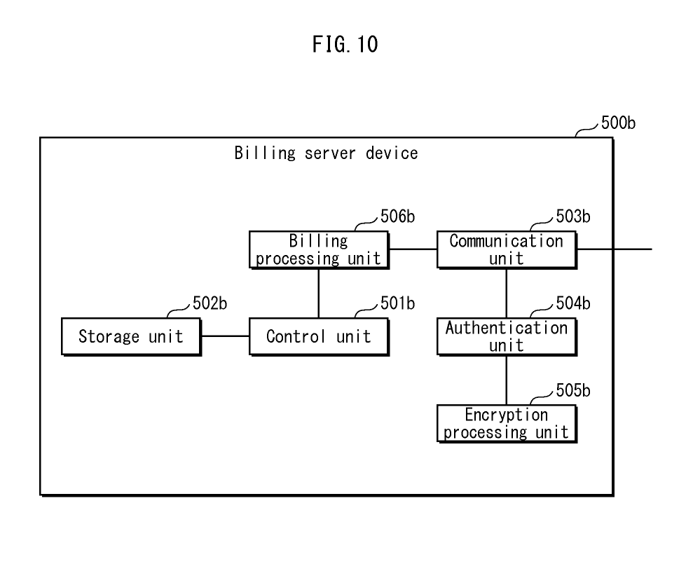

As illustrated in FIG. 10, the billing server device 500b includes: a control unit 501b; a storage unit 502b; a communication unit 503b; an authentication unit 504b; an encryption processing unit 505b; and a billing processing unit 506b.

In specific, the billing server device 500b includes a microprocessor, a RAM, a ROM, a hard disk, etc., which are not illustrated in FIG. 10. The microprocessor operates in accordance with computer programs stored in the RAM, the ROM, and the hard disk device, whereby the billing server device 500b achieves the functions thereof.

Note that functional blocks of the billing server device 500b, such as the control unit 501b, the communication unit 503b, the authentication unit 504b, the encryption processing unit 505b, and the billing processing unit 506b, are typically implemented by using LSIs, which is one type of an integrated circuit. The implementation of the above-described functional blocks by using LSIs may be performed such that a single LSI chip is used for each individual functional block. Alternatively, the above-described functional blocks may be implemented by using LSIs each including one or more of such functional blocks, or by using LSIs each including a part of each of the functional blocks.

The communication unit 503b connects with the sales device 100b and the on-board playback device 400b via the network 20b. Thus, the communication unit 503b realizes transmission and reception of information between the billing server device 500b and the sales device 100b, and between the billing server device 500b and the on-board playback device 400b.

The authentication unit 504b performs mutual authentication and key sharing with the sales device 100b. In addition, the authentication unit 504b performs mutual authentication and key sharing with the on-board playback device 400b.

The encryption processing unit 505b performs encryption processing, utilizing encryption technology, for confirming a communication opponent, and encryption processing for ensuring confidentiality of data.

The billing processing unit 506b receives, from the sales device 100b or the on-board playback device 400b, a user ID and a billing account. Further, the billing processing unit 506b performs processing for billing a user by using the user ID and the billing account so received.

The control unit 501b realizes the functions of the billing server device 500b by controlling the storage unit 502b, the communication unit 503b, the authentication unit 504b, the encryption processing unit 505b, and the billing processing unit 506b.

2.6 Management Device 300b

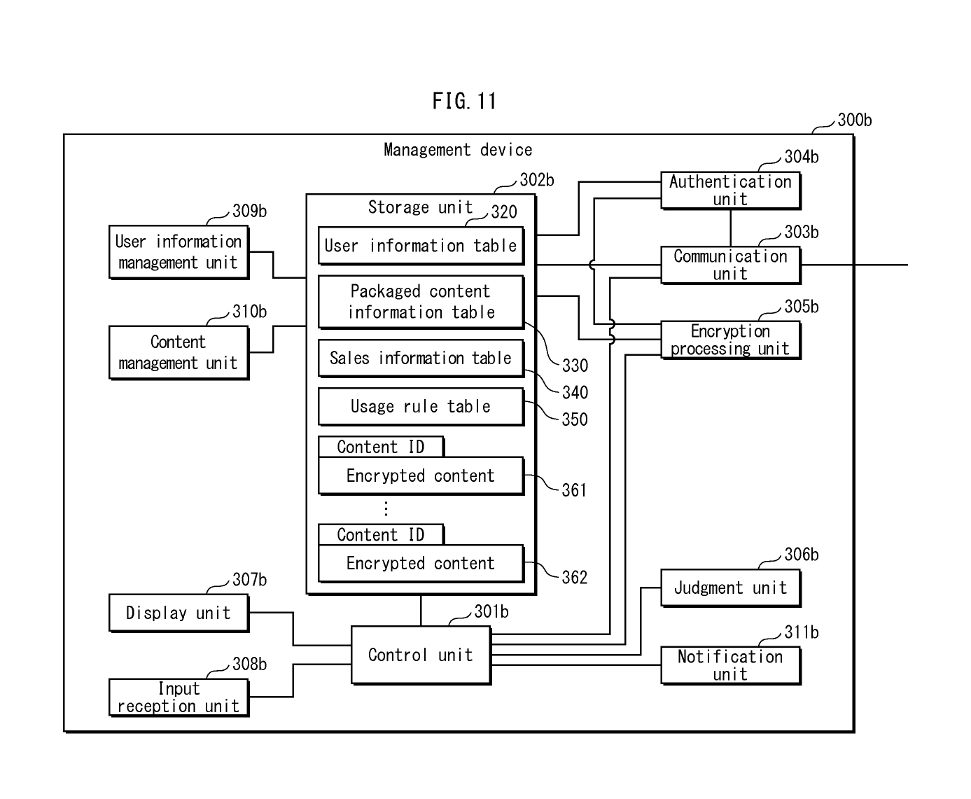

As illustrated in FIG. 11, the management device 300b includes: a control unit 301b; a storage unit 302b; a communication unit 303b; an authentication unit 304b; an encryption processing unit 305b; a judgment unit 306b; a display unit 307b; an input reception unit 308b; a user information management unit 309b; a content management unit 310b; and a notification unit 311b.

In specific, the management device 300b includes a microprocessor, a RAM, a ROM, a hard disk, etc. The microprocessor operates in accordance with computer programs stored in the RAM, the ROM, and the hard disk device, whereby the management device 300b achieves the functions thereof.

Note that functional blocks of the management device 300b, such as the control unit 301b, the communication unit 303b, the authentication unit 304b, the encryption processing unit 305b, and the judgment unit 306b, the user information management unit 309b, and the content management unit 310b, are typically implemented by using LSIs, which is one type of an integrated circuit. The implementation of the above-described functional blocks by using LSIs may be performed such that a single LSI chip is used for each individual functional block. Alternatively, the above-described functional blocks may be implemented by using LSIs each including one or more of such functional blocks, or by using LSIs each including a part of each of the functional blocks.

(1) Storage Unit 302b

For example, the storage unit 302b is composed of a hard disk device.

The storage unit 302b stores therein: a user information table 320; a packaged content information table 330; a sales information table 340; a usage rule table 350; and encrypted content 361, . . . , 362.

(User Information Table 320)

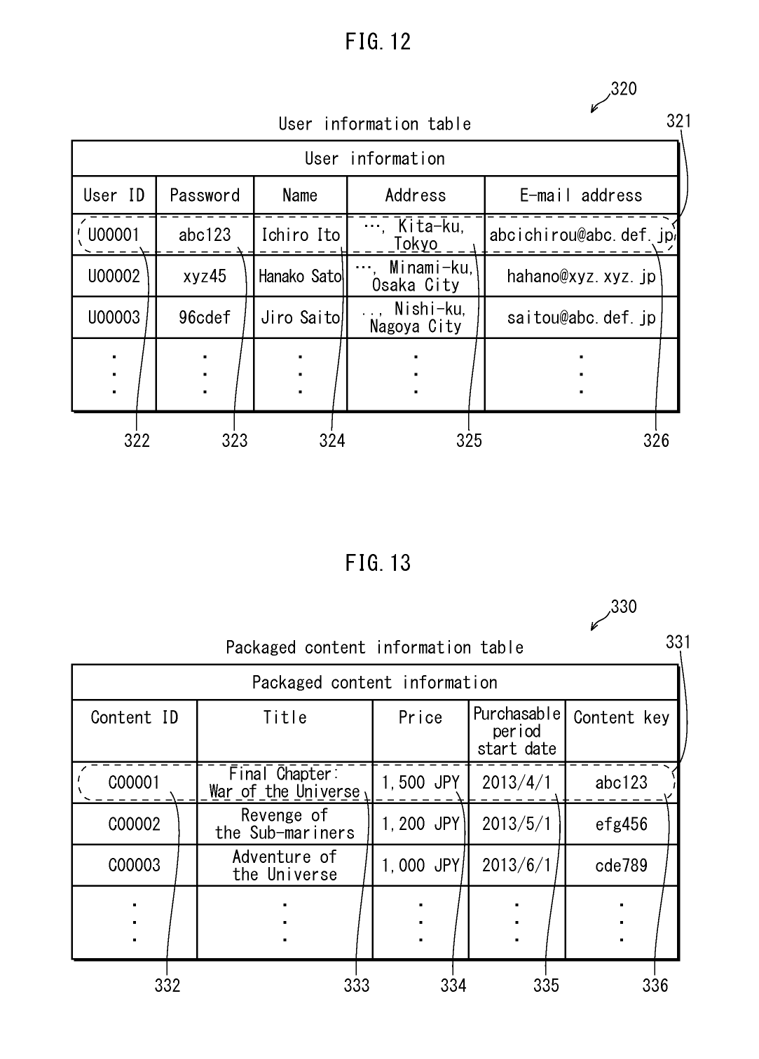

FIG. 12 illustrates one example of the user information table 320. The user information table 320 illustrated in FIG. 12 has areas for storing a plurality of pieces of user information. Each piece of user information corresponds to a corresponding user. Each piece of user information includes: a user ID; a password; a name; an address; and an E-mail address of the corresponding user. In each piece of user information, a user ID identifies the corresponding user. In each piece of user information, a name indicates the name of the corresponding user. In each piece of user information, an address indicates a residential location of the corresponding user. In each piece of user information, an E-mail address is an E-mail address allocated to the corresponding user.

For example, the user information table 320 includes user information 321. The user information 321 includes: a user ID 321 indicating “U00001”; a password 323 indicating “abc123”; a name 324 indicating “Ichiro Ito”; an address 325 indicating “ . . . , Kita-Ku, Tokyo”; and an E-mail address 326 indicating “abcichirou@abc.def.jp”.

(Packaged Content Information Table 330)

FIG. 13 illustrates one example of the packaged content information table 330. The packaged content information table 330 illustrated in FIG. 13 has areas for storing a plurality of pieces of packaged content information. Each piece of packaged content information corresponds to corresponding packaged content (i.e., content available in the form of being recorded on a packaged medium). Each piece of packaged content information includes: a content ID; a title; a price; a purchasable period start date; and a content key.

In each piece of packaged content information, a content ID identifies the corresponding content. In each piece of packaged content information, a title indicates the title of the corresponding content. In each piece of packaged content information, a price indicates the price at which the corresponding packaged content is sold. In each piece of packaged content information, a purchasable period start date indicates the purchasable period start date of the corresponding content, and indicates the date on which the selling of the packaged content is started. In other words, the purchasable period start date is the date on which distribution of the corresponding content to the playback devices 600b, . . . , 601b becomes possible. In each piece of packaged content information, a content key is a key that is used when the corresponding content is encrypted.

As illustrated in FIG. 13, the packaged content information table 330 includes packaged content information 331. The packaged content information 331 includes: a content ID 332 indicating “C00001”; a title 333 indicating “Final Chapter: War of the Universe”; a price 334 indicating “1,500 JPY”; a purchasable period start date 335 indicating “2013/4/1”; and a content key 336 indicating “abc123”.

(Sales Information Table 340)

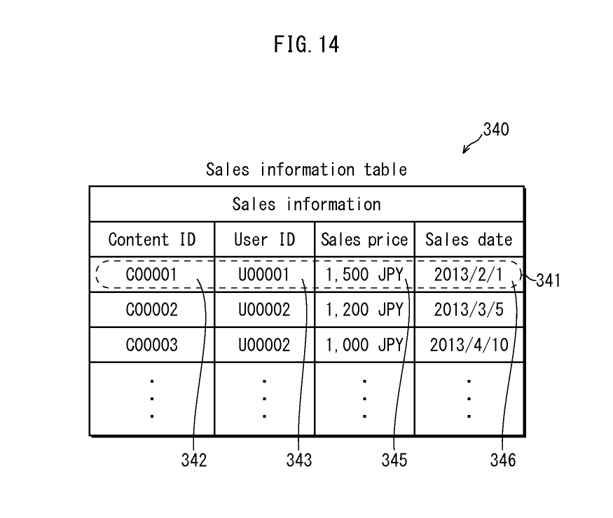

FIG. 14 illustrates one example of the sales information table 340. The sales information table 340 illustrated in FIG. 14 has areas for storing a plurality of pieces of sales information. Each piece of sales information corresponds to corresponding content that has been sold to a user. Each piece of sales information includes: a content ID; a user ID; a sales price; and a sales date.

In each piece of sales information, a content ID identifies the corresponding content that has been sold. In each piece of sales information, a user ID identifies a user having purchased the corresponding content. In each piece of sales information, a sales price indicates the price at which the corresponding content has been sold. In each piece of sales information, a sales date indicates the day, the month, and the year of the date on which the corresponding content has been sold.

As illustrated in FIG. 14, the sales information table 340 includes sales information 341. The sales information 341 includes: a content ID 342 indicating “C00001”; a user ID 343 indicating “U00001”; a sales price 345 indicating “1,500 JPY”; and a sales date 346 indicating “2013/2/1”.

(Usage Rule Table 350)

The usage rule table 350 has the same data structure as the usage rule table 120 illustrated in FIG. 5. Each usage rule included in the usage rule table 350 corresponds to corresponding encrypted content stored in the storage unit 302b.

(Encrypted Content 361, . . . , 362)

As already described above, each encrypted content 361, . . . , 362 is generated by encrypting content by using a content key.

(2) User Information Management Unit 309b

The user information management unit 309b manages the user information table 320 illustrated in FIG. 12 as a database. The user information management unit 309b receives user information from the sales device 100b or the on-board playback device 400b, via the communication unit 303b. Further, the user information management unit 309b updates the user information table 320 by using the received user information.

In addition, the user information management unit 309b manages the sales information table 340 illustrated in FIG. 14 as a database. The user information management unit 309b receives sales information from the sales device 100b or the on-board playback device 400b, via the communication unit 303b. Further, the user information management unit 309b updates the sales information table 340 by using the received sales information.

(3) Content Management Unit 310b

The content management unit 310b manages the packaged content information table 330 illustrated in FIG. 13 as a database. Each time new content is added, the content management unit 310b updates the packaged content information table 330 by using packaged content information indicating the new content. In addition, each time a purchasable period start date of content is set, the content management unit 310b updates the purchasable period start date associated with the corresponding content in the packaged content information table 330. Note that a purchasable period start date for content may be set in advance.

The content management unit 310b manages the usage rule table 350 as a database. Each time new content is added, the content management unit 310b updates the usage rule table 350 by using a usage rule corresponding to the new content.

In addition, each time new content is added, the content management unit 310b stores new encrypted content to the storage unit 302b.

(4) Notification Unit 311b

The notification unit 311b notifies a user of a purchasable period start date of content based on the databases managed by the user information management unit 309b and the content management unit 310b. For example, the notification unit 311b may notify a user of a purchasable period start date of content when the purchasable period start date of the content is set. In addition, the notification unit 311b may notify the user of the purchasable period start date of the content once again one week before the purchasable period start date of the content.

(5) Judgment Unit 306b

The judgment unit 306b judges whether or not content is distributable when a request for the content is made from the playback devices 600b, . . . , 601b. The judgment unit 306b performs the judgment based on the databases managed by the user information management unit 309b and the content management unit 310b.

The judgment unit 306b performs the judgment of whether or not content is distributable as described in the following.

(a) The judgment unit 306b judges whether or not a content ID, a user ID, and a password received from a playback device are stored in the sales information table 340. When the content ID, the user ID, and the password are not stored in the sales information table 340, the judgment unit 306b rejects the request for distribution of content.

(b) When the content ID, the user ID, and the password are stored in the sales information table 340, the judgment unit 306b compares the present date and a purchasable period start date stored in the packaged content information table 330. When the present date is before the purchasable period start date, the judgment unit 306b rejects the request for distribution of content. When the present date is on or after the purchasable period start date, the judgment unit 306b permits distribution of the requested content.

When the judgment unit 306b judges that the requested content is distributable, the content is distributed to the playback device having transmitted the request, via the communication unit 303b.

(6) Communication Unit 303b, Authentication Unit 304b, Encryption Processing Unit 305b

The communication unit 303b performs transmission and reception of information with the sales device 100b, the on-board playback device 400b, and the playback devices 600b, . . . , 601b, via the network 20b. The communication unit 303b may perform either wired communication or wireless communication.

The authentication unit 304b performs mutual authentication and key sharing with the sales device 100b, the on-board playback device 400b, and the playback devices 600b, . . . , 601b.

The encryption processing unit 305b performs encryption processing, utilizing encryption technology, for ensuring the confidentiality of data, etc.

(7) Control Unit 301b

The control unit 301b realizes the functions of the management device 300b by controlling the storage unit 302b, the communication unit 303b, the authentication unit 304b, the encryption processing unit 305b, the judgment unit 306b, the display unit 307b, the input reception unit 308b, the user information management unit 309b, the content management unit 310b, and the notification unit 311b.

2.7 Playback Devices 600b, . . . , 601b

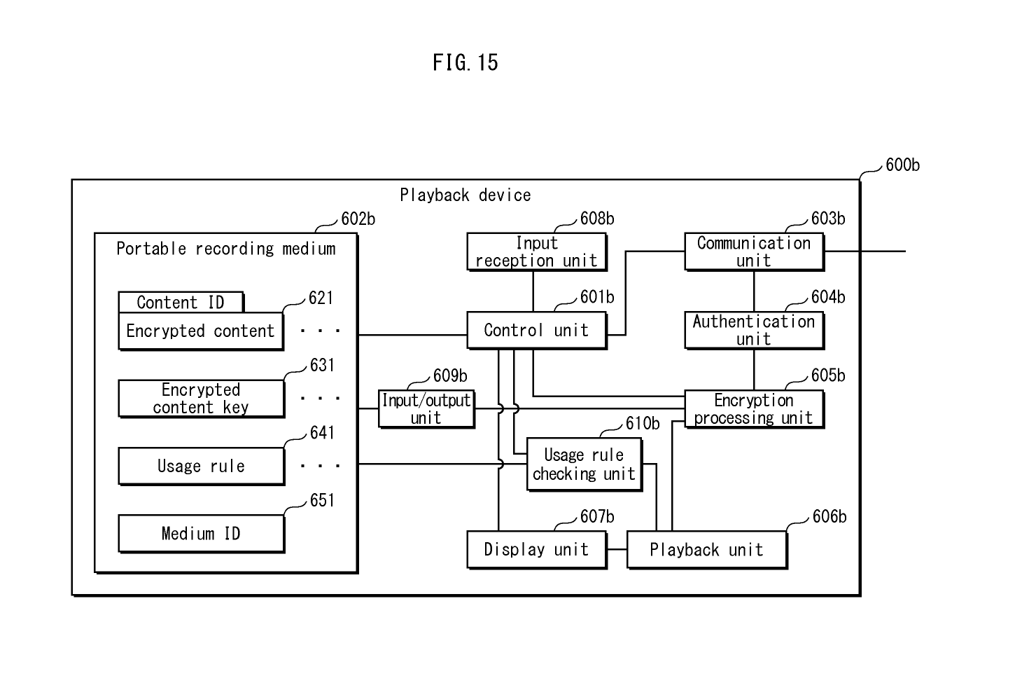

As illustrated in FIG. 15, the playback device 600b includes: a control unit 601b; a communication unit 603b; an authentication unit 604b; an encryption processing unit 605b; a playback unit 606b; a display unit 607b; an input reception unit 608b; an input/output unit 609b; and a usage rule checking unit 610b. Further, a portable recording medium 602b is attached to the playback device 600b.

In specific, the playback device 600b includes a microprocessor, a RAM, a ROM, a hard disk, etc. The microprocessor operates in accordance with computer programs stored in the RAM, the ROM, and the hard disk device, whereby the playback device 600b achieves the functions thereof.

Note that functional blocks of the playback device 600b, such as the control unit 601b, the communication unit 603b, the authentication unit 604b, the encryption processing unit 605b, the playback unit 606b, and the usage rule checking unit 610b, are typically implemented by using LSIs, which is one type of an integrated circuit. The implementation of the above-described functional blocks by using LSIs may be performed such that a single LSI chip is used for each individual functional block. Alternatively, the above-described functional blocks may be implemented by using LSIs each including one or more of such functional blocks, or by using LSIs each including a part of each of the functional blocks.

(1) Display Unit 607b, Input Reception Unit 608b

The display unit 607b includes a display screen having the predetermined size or a larger size. For instance, the size of the display screen is 1280 dots or larger in the vertical direction and 720 dots or larger in the lateral direction.

The display unit 607b displays a screen for having a user watch content. The display unit 607b displays a screen for receiving input from a user. A user, according to what is displayed on-screen by the display unit 607b, makes a selection of content, inputs user information, etc. The display unit 607b receives video data and audio data from the playback unit 606b, and outputs the received video data as video and the received audio data as audio.

The input reception unit 608b receives from a user input of user information, billing information, etc., and outputs the user information, the billing information, etc., so received to the control unit 601b.

(2) Portable Recording Medium 602b

For example, the portable recording medium 602b may be a recording medium such as a DVD.

FIG. 15 illustrates one example of the portable recording medium 602b. The portable recording medium 602b illustrated in FIG. 15 has storage areas for storing: an encrypted content key 631; encrypted content 621; and a usage rule 641. In addition, the portable recording medium 602b stores therein a medium ID 651 that is unique thereto.

The encrypted content key 631 is generated by encrypting a content key by using a medium key. The medium key is generated based on the medium ID and through the execution of predetermined procedures. For example, a hash value that is generated by performing a hash calculation (SHA-1, for example) on the medium ID may be used as the medium key.

As such, a medium key is generated based on the medium ID that is unique to the recording medium and through the execution of predetermined procedures. Due to this, as long as the same recording medium is used, the same medium key is generated regardless of the different devices that may be used for generating the medium key.

The encrypted content 621 is generated by encrypting content by using a content key.

The usage rule 641 includes the above-described information included in a usage rule. That is, the usage rule 641 includes: a content ID; an early-stage content identification flag; a copy condition; and a playback-available period.

(3) Communication Unit 603b, Authentication Unit 604b, Encryption Processing Unit 605b

The communication unit 603b performs transmission and reception of data with the management device 300b. The communication unit 603b may perform either wired communication or wireless communication.

The authentication unit 604b performs mutual authentication and key sharing with the management device 300b. The authentication unit 604b performs mutual authentication and key sharing as already described above.

The encryption processing unit 605b performs encryption processing, utilizing encryption technology, for confirming a communication opponent, and encryption processing for ensuring confidentiality of data.

(5) Usage Rule Checking Unit 610b

The usage rule checking unit 610b receives a content ID from the control unit 601b, and reads out a usage rule including the received content ID from the portable recording medium 602b. Further, the usage rule checking unit 610b checks the conditions described in the usage rule so read out.

The usage rule checking unit 610b extracts an early-stage content identification flag from the usage rule so read out. Further, the usage rule checking unit 610b judges whether or not the extracted early-stage content identification flag indicates “1”. When the early-stage content identification flag indicates “1”, the usage rule checking unit 610b instructs the playback unit 606b to perform a predetermined operation. Here, note that the early-stage content identification flag never indicates “1”.

The usage rule checking unit 610b extracts a copy condition from the usage rule so read out. Further, the usage rule checking unit 610b checks whether or not the copy condition so read out indicates “0”. When the copy condition indicates “0”, the usage rule checking unit 610b instructs the control unit 601b not to permit the duplication of the content.

In addition, the usage rule checking unit 610b acquires the present date, and extracts a playback-available period from the usage rule so read out. Further, the usage rule checking unit 610b judges whether or not the present date so acquired is included in the playback-available period. When the present date is included in the playback-available period, the usage rule checking unit 610b permits the playback unit 606b to play back content. When the present date is not included in the playback-available period, the usage rule checking unit 610b prohibits the playback unit 606b from playing back the content.

(6) Playback Unit 606b

The playback unit 606b receives an instruction to play back content and a content ID from the control unit 601b. In addition, the playback unit 606b receives, from the usage rule checking unit 610b, an instruction indicating whether playback of content is permitted or prohibited, and an instruction indicating whether or not to perform the predetermined operation.

When receiving, from the usage rule checking unit 610b, an instruction indicating prohibition of playback of content, the playback unit 606b does not perform playback of content.

Here, note that the playback device 606b never receives an instruction indicating whether or not to perform the predetermined operation.

When receiving, from the usage rule checking unit 610b, an instruction indicating permission to play back content, the playback unit 606b commences playback of encrypted content indicated by the received content ID.

In specific, the playback unit 606b instructs the encryption processing unit 605b to generate a medium key by using the medium ID 651 stored in the portable recording medium 602b and through the execution of the predetermined procedures described above. For example, a hash value that is generated by performing a hash calculation (SHA-1, for example) on the medium ID is used as the medium key. Further, the playback unit 606b instructs and controls the encryption processing unit 605b to decrypt an encrypted content key stored in the portable recording medium 602b by using the generated medium key. As such, a content key is generated.

content key=D(medium key, encrypted content key)

Further, the playback unit 606b instructs and controls the encryption processing unit 605b to decrypt encrypted content stored in the portable recording medium 602b by using the generated content key. As such, content is generated.

content=D(content key, encrypted content)

Further, the playback unit 606b decompresses the generated content to generate video data and audio data, and outputs the video data and the audio data so generated to the display unit 607b.

(7) Control Unit 601b

The control unit 601b receives, from the usage rule checking unit 610b, an instruction indicating whether or not duplication of content is permitted. Further, the control unit 601b controls the duplication of content according to the instruction.

The control unit 601b instructs the playback unit 606b to play back content in accordance with a selection made by a user. In addition, the control unit 601b outputs, to the playback unit 606b, a content ID identifying content to be played back.

Further, the control unit 601b realizes the functions of the playback device 600b by controlling the communication unit 603b, the authentication unit 604b, the encryption processing unit 605b, the playback unit 606b, the display unit 607b, the input reception unit 608b, the input/output unit 609b, and the usage rule checking unit 610b.

Note that the other playback devices also have the same structure as the playback device 600b.

2.8 Gate Device 900b

The gate device 900b is located at a boarding gate in an airport.

The gate device 900b reads ticket information from a boarding pass. As already described above, when ticket information is acquired from a boarding pass, the ticket information includes: (i) identification information indicating a boarding pass; (ii) a flight ID identifying a flight; (iii) the name, the age, and the sex of a passenger of the flight; (iv) date/time information indicating the date/time that the flight departs; and (v) a seat ID identifying a seat in an airplane. The gate device 900b judges whether or not the ticket information so read is correct. For example, the judgment of whether or not ticket information is correct is performed according to whether or not identification information included in the ticket information indicates acquisition from a boarding pass.

When judging that ticket information is not correct, the gate device 900b generates a message indicating that the boarding pass is not correct and displays the generated message. In such a case, the gate device 900b opens up the gate doors thereof, whereby a passenger is blocked from passing the gate device 900b.

When judging that ticket information is correct, the gate device 900b generates a message indicating that the boarding pass is correct and stores the generated message. In such a case, the gate device 900b retracts the gate doors thereof, whereby a passenger is allowed to pass the gate device 900b.

When the gate device 900b judges that ticket information is correct, a passenger making a request to purchase content whose purchasable period has not yet arrived is entitled to purchase the content on-board an airplane.

2.9 Operations in Content Distribution System 10b

In the following, description is provided on operations in the content distribution system 10b.

(1) Operations when Selling Content in Movie Theater

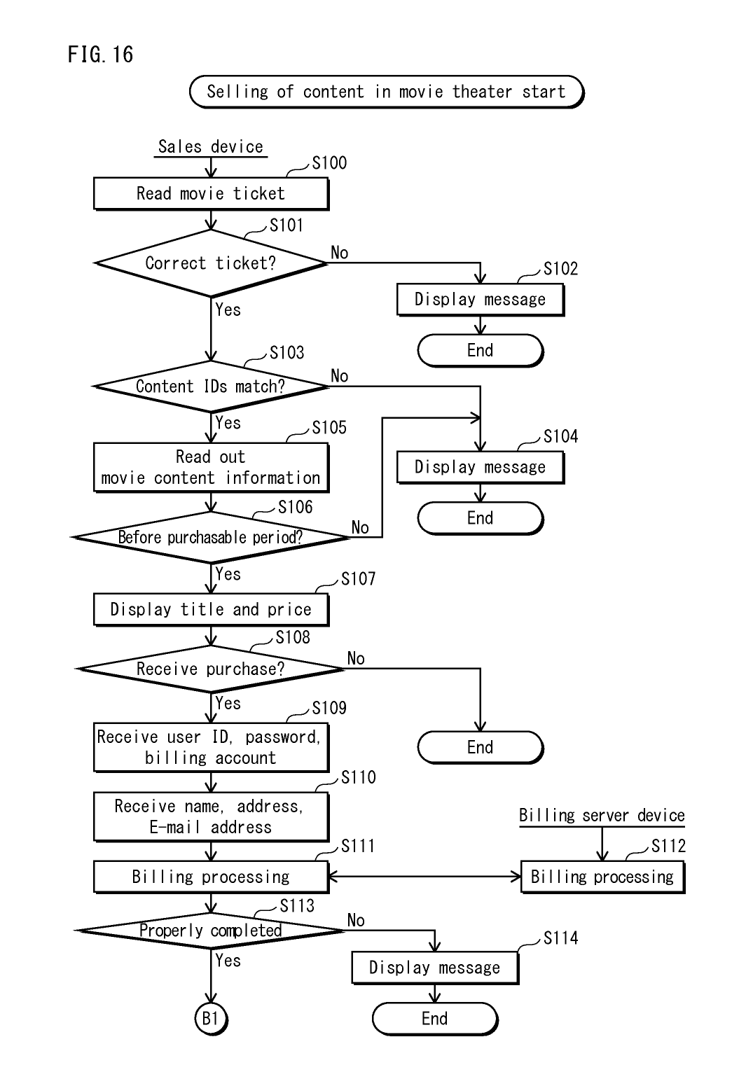

In the following, description is provided on operations, when content is sold in a movie theater, of the sales device 100b, the billing server device 500b, the portable terminal device 200b, and the management device 300b, by referring to the sequence diagram in FIGS. 16 through 19.

The ticket reader 109b reads a movie ticket (Step S100).

Further, the judgment unit 112b judges whether or not the ticket so read is correct (Step S101). When judged that the ticket is not correct (“NO” in Step S101), the control unit 101b generates a message indicating that the ticket is not correct, and the display unit 107b displays the generated message (Step S102). This ends the operation of the sales device 100b.

When judged that the ticket is correct (“YES” in Step S101), the judgment unit 112b judges whether or not (i) a content ID of a movie that is shown and (ii) a content ID recorded on the ticket match (Step S103).

Note that when the sales device 100b is located in an airplane or in an airport, the ticket is a boarding pass for an airplane flight. In such a case, the judgment unit 112b judges whether or not (i) a flight ID recorded on the boarding pass and (ii) a flight ID of a flight that a passenger is intending to board match.

Further, when the sales device 100b is located in a hotel, the ticket is a cardkey for a hotel room. In such a case, the judgment unit 112b judges whether or not (i) a room ID recorded on the cardkey and (ii) a room ID of a hotel room that a guest is intending to occupy match.

When judged that (i) the content ID of the movie that is shown and (ii) the content ID recorded on the ticket do not match (“NO” in Step S103), the control unit 101b generates a message indicating that the content IDs do not match, and the display unit 107b displays the generated message (Step S104). This ends the operation of the sales device 100b.

When judged that (i) the content ID of the movie that is shown and (ii) the content ID recorded on the ticket match (“YES” in Step S103), the control unit 101b reads out movie content information corresponding to the content ID of the movie from the movie content information table 130 (Step S105). Subsequently, the control unit 101b extracts a purchasable period start date from the movie content information so read out, and judges whether or not the present date is before the purchasable period start date (Step S106). When judged that the present date is not before the purchasable period start date (“NO” in Step S106), a message indicating that the present date is not before the purchasable period start date is generated, and the generated message is displayed (Step S104). This ends the operation of the sales device 100b.

When judged that the present date is before the purchasable period start date (“NO” in Step S106), the control unit 101b extracts a title and a price from the movie content information so read out. Subsequently, the display unit 107b displays the title and the price (Step S107).

In Step S108, when the input reception unit 108b receives non-purchase of content from a user (“NO” in Step S108), the operation of the sales device 100b ends.

When the input reception unit 108b receives purchase of content from a user (“YES” in Step S108), the input reception unit 108b goes on to receive, from the user, a user ID, a password, and a billing account of the user (Step S109). Subsequently, the input reception unit 108b receives, from the user, a name, an address, and an E-mail address of the user (Step S110).

Subsequently, the control unit 101b performs billing processing with the billing server device 500b via the communication unit 103b (Steps S111 and S112).

When billing processing is not properly completed (“NO” in Step S113), the control unit 101b generates a message indicating that billing processing is not properly completed, and the display unit 107b displays the generated message (Step S114). This ends the operation of the sales device 100b.

When billing processing is properly completed (“YES” in Step S113), the authentication unit 104b and the authentication unit 204b of the portable terminal device 200b perform mutual authentication and key sharing (Step S115). Note that the details of the procedures when performing mutual authentication and key sharing are described later in the present disclosure.

When authentication of the portable terminal device 200b fails (“NO” in Step S116), the control unit 101b generates a message indicating that the authentication of the portable terminal device 200b has failed, and the display unit 107b displays the generated message (Step S117). This ends the operation of the sales device 100b.

When authentication of the sales device 100b fails (“NO” in Step S118), the control unit 201b generates a message indicating that the authentication of the sales device 100b has failed, and the display unit 207b displays the generated message (Step S119). This ends the operation of the portable terminal device 200b.

When mutual authentication and key sharing between the sales device 100b and the portable terminal device 200b are successful (“YES” in Step S116 and “YES” in Step S118), the control unit 101b and the control unit 201b establish a secure communication path (Step S120).

The control unit 201b reads out the model ID 261 stored in the model ID storage unit 214b (Step S155). Subsequently, the control unit 201b transmits the model ID 261 so read out to the sales device 100b via the secure communication path (Step S156).

The judgment unit 112b receives the model ID 261 via the secure communication path (Step S156).

Subsequently, the judgment unit 112b judges whether or not the received model ID 261 exists in the model list 160 (Step S157). When the model ID 261 does not exist in the model list 160 (“NO” in Step S157), the display unit 107b displays a message to that effect (Step S158). This ends the operation of the sales device 100b.

When the model ID 261 exists in the model list 160 (“YES” in Step S157), the control unit 101b transmits a request for a device key via the secure communication path (Step S159).

The control unit 201b receives the request for the device key via the secure communication path (Step S159). Subsequently, the control unit 201b reads out the device key 251 stored in the device key storage unit 210b (Step S122). Subsequently, the control unit 201b transmits the device key so read out to the sales device 100b via the secure communication path (Step S123).

The control unit 101b receives the device key via the secure communication path (Step S123).

In addition, the control unit 101b reads out a content key from the storage unit 102b (Step S121).

Subsequently, the control unit 101b generates an encrypted content key by encrypting the content key so read out by using the received device key (Step S124).

Subsequently, the control unit 101b transmits the encrypted content key to the portable terminal device 200b via the secure communication path (Step S125).

Subsequently, the control unit 201b receives the encrypted content key via the secure communication path (Step S125). Subsequently, the control unit 201b writes the received encrypted content key to the secure storage unit 202b (Step S126).

The control unit 101b reads out encrypted content from the storage unit 102b (Step S127). Subsequently, the control unit 101b transmits the encrypted content to the portable terminal device 200b via the communication unit 103b and the network 20b (Step S128).

Subsequently, the control unit 201b receives the encrypted content via the communication unit 203b and the network 20b (Step S128). Subsequently, the control unit 201b writes the received encrypted content to the secure storage unit 202b (Step S129).

The control unit 101b reads out a usage rule from the storage unit 102b (Step S130). Subsequently, the control unit 101b transmits the usage rule to the portable terminal device 200b via the secure communication path (Step S131).

Subsequently, the control unit 201b receives the usage rule via the secure communication path (Step S131). Subsequently, the control unit 201b writes the received usage rule to the secure storage unit 202b (Step S132). This ends the operation of the portable terminal device 200b.

The authentication unit 104b of the sales device 100b and the authentication unit 304b of the management device 300b perform mutual authentication and key sharing (Step S133).

When authentication of the management device 300b fails (“NO” in Step S134), the control unit 101b generates a message indicating that the authentication of the management device 300b has failed, and the display unit 107b displays the generated message (Step S135). This ends the operation of the sales device 100b.

When authentication of the sales device 100b fails (“NO” in Step S136), the control unit 301b generates a message indicating that the authentication of the sales device 100b has failed, and the display unit 307b displays the generated message (Step S137). This ends the operation of the management device 300b.

When mutual authentication and key sharing between the sales device 100b and the management device 300b are successful (“YES” in Step S134 and “YES” in Step S136), the control unit 101b and the control unit 301b establish a secure communication path (Step S138).

The control unit 101b transmits the content ID, the user ID, and the password to the management device 300b via the secure communication path (Step S139). The control unit 301b receives the content ID, the user ID, and the password from the sales device 100b via the secure communication path (Step S139).

The control unit 101b transmits the name, the address, and the E-mail address to the management device 300b via the secure communication path (Step S140). The control unit 301b receives the name, the address, and the E-mail address from the sales device 100b via the secure communication path (Step S140).

The control unit 101b transmits the sales price and the sales date to the management device 300b via the secure communication path (Step S141). The control unit 301b receives the sales price and the sales date from the sales device 100b via the secure communication path (Step S141).

The user information management unit 309b writes the content ID, the user ID, the sales price, and the sales date to the sales information table 340 in an associated state (Step S142). In addition, the user information management unit 309b writes the user ID, the password, the name, the address, and the E-mail address to the user information table 320 in an associated state (Step S143).

This ends the operations when content is sold in a movie theater.

(1) Operations when Selling Content in Airplane

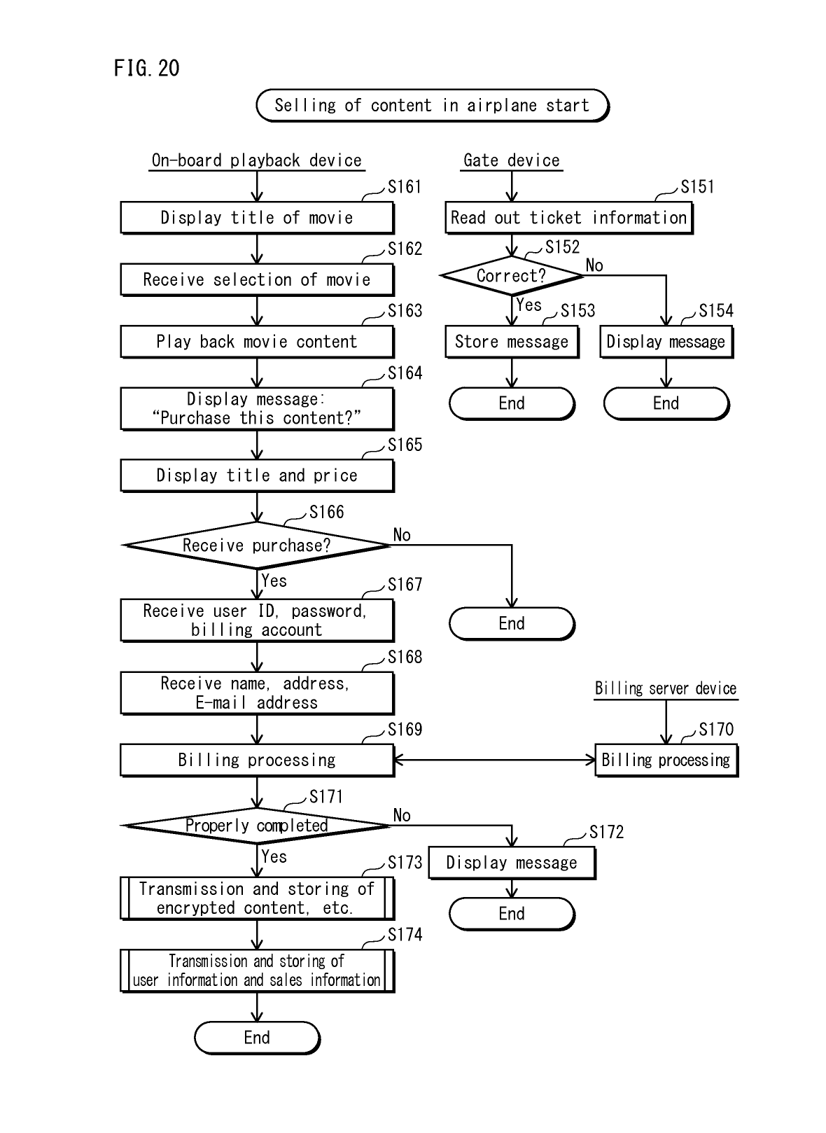

In the following, description is provided on operations of the gate device 900b and operations, when content is sold on-board an airplane, of the on-board playback device 400b, the billing server device 500b, the portable terminal device 200b, and the management device 200b, by referring to the sequence diagram in FIG. 20.

The gate device 900b reads ticket information from a boarding pass (Step S151). As already described above, when ticket information is acquired from a boarding pass, the ticket information includes: (i) identification information indicating a boarding pass; (ii) a flight ID identifying a flight; (iii) the name, the age, and the sex of a passenger of the flight; (iv) date/time information indicating the date/time that the flight departs; and (v) a seat ID identifying a seat in an airplane. The gate device 900b judges whether or not the ticket information so read is correct (Step S152). The judgment of whether or not ticket information is correct is mainly performed according to whether or not (i) a flight ID included in the ticket information and (ii) a flight ID of a flight that a passenger is intending to board match. Judgment is also performed of whether or not identification information included in the ticket information indicates acquisition from a boarding pass, whether or not date/time information included in the ticket information matches a departure date/time of the flight that the passenger is intending to board, etc. When judged that the ticket information is not correct (“NO” in Step S152), the gate device 900b generates a message indicating that the boarding pass is not correct, and displays the generated message (Step S153). In such a case, the gate device 900b opens up the gate doors thereof, whereby a passenger is blocked from passing the gate device 900b (Step S154).

When judged that the ticket information is correct (“YES” in Step S152), the gate device 900b generates a message indicating that the boarding pass is correct, and stores the generated message (Step S153). In such a case, the gate device 900b retracts the gate doors thereof, whereby a passenger is allowed to pass the gate device 900b.

The display unit 407b of the on-board playback device 400b displays titles of movies (Step S161), and the input reception unit 408b receives a selection of a movie from a user (Step S162). The display unit 407b plays back and displays content corresponding to the movie (Step S163).

The display unit 407b displays a message asking the user whether or not the user would like to purchase the content, after or during playback of the content (Step S164). Subsequently, the display unit 407b displays a title and a price of the content (Step S165).

When the input reception unit 408b receives non-purchase of the content from the user (“NO” in Step S166), the operation of the on-board playback device 400b ends.

When the input reception unit 408b receives a purchase of the content from the user (“YES” in Step S166), the input reception unit 408b goes on to receive, from the user, a user ID, a password, and a billing account of the user (Step S167). Further, the input reception unit 408b receives, from the user, a name, an address, and an E-mail address of the user (Step S168).

Subsequently, the control unit 401b performs billing processing with the billing server device 500b via the communication unit 403b (Steps S169 and S170).

When billing processing is not properly completed (“NO” in Step S171), the control unit 401b generates a message indicating that billing processing is not properly completed, and the display unit 407b displays the generated message (Step S172). This ends the operation of the on-board playback device 400b.

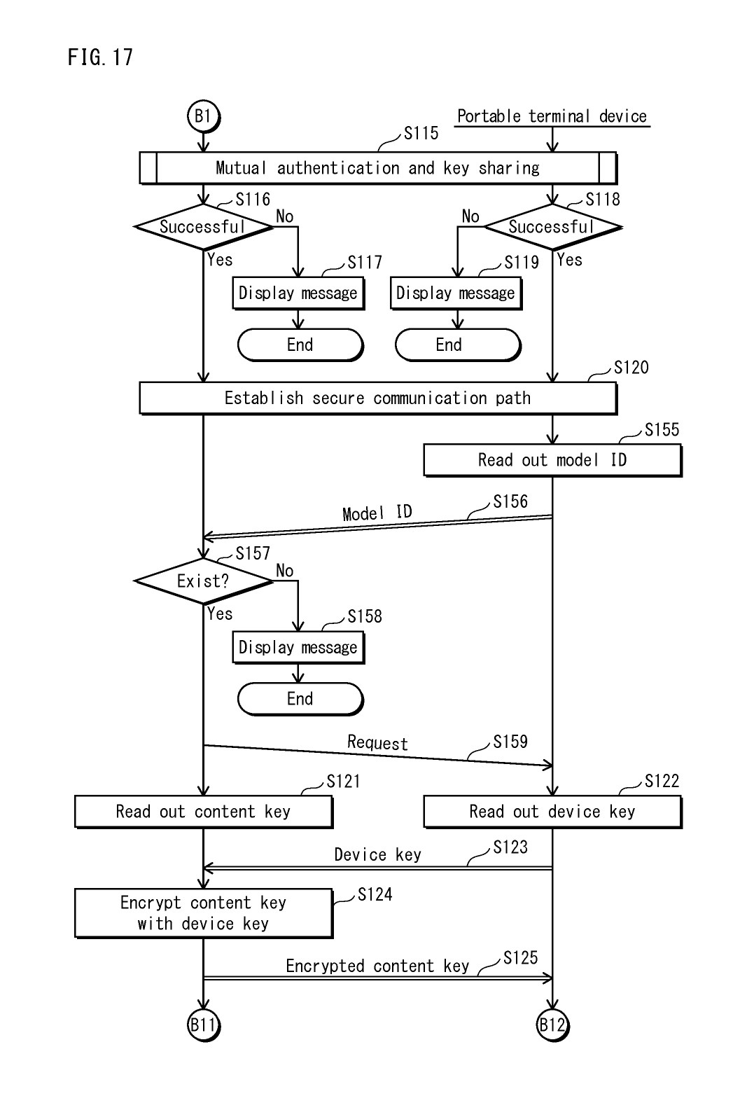

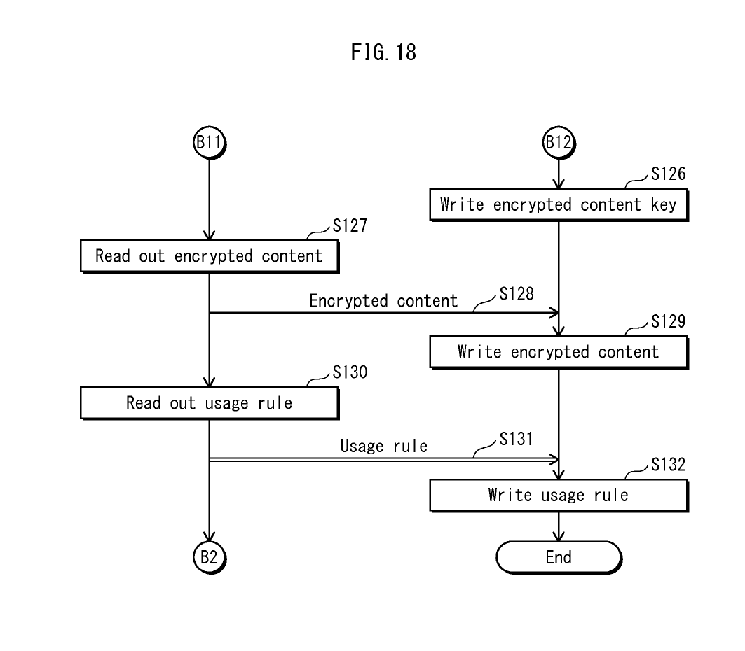

When billing processing is properly completed (“YES” in Step S171), transmitting and storing of encrypted content, etc., are performed (Step S173). The details of the operations in the transmitting and storing of encrypted content, etc., in Step S173 are similar to those in Steps S115 through S132 illustrated in FIGS. 17 and 18.

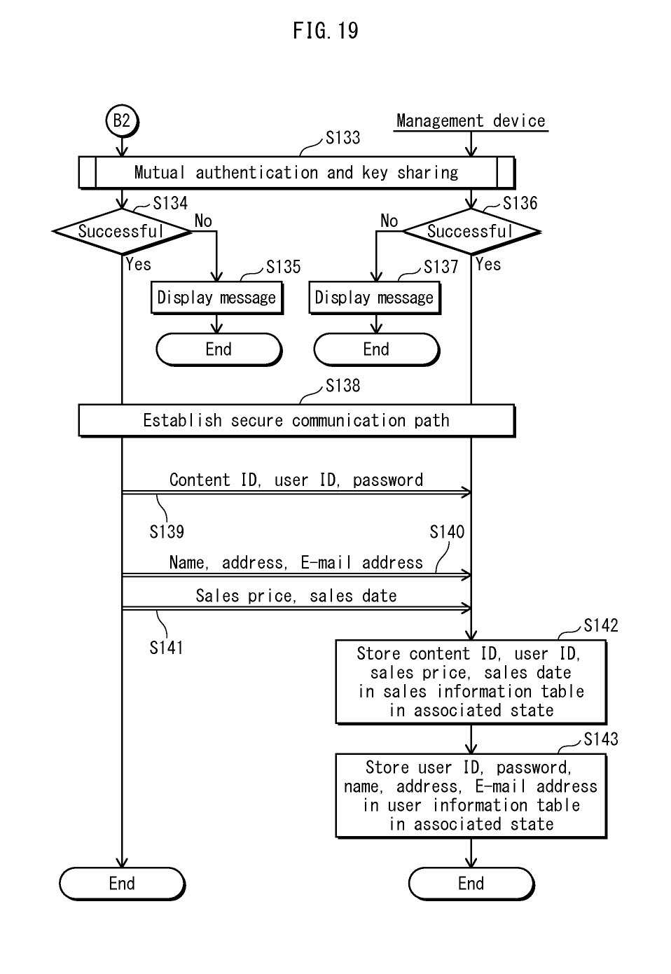

Subsequently, transmitting and storing of user information and sales information are performed (Step S174). The details of the operations in the transmitting and storing of user information and sales information in Step S174 are similar to those in Steps S133 through S143 illustrated in FIG. 19.

This ends the operations when content is sold on-board an airplane.

(3) Operations of Portable Terminal Device 200b when Playing Back Content.

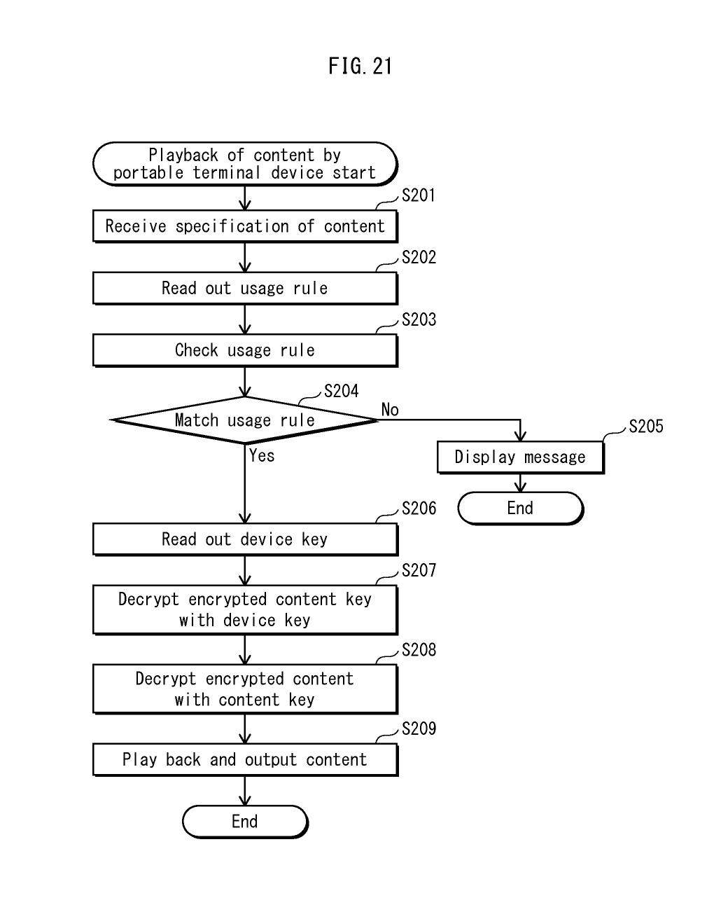

In the following, description is provided on operations of the portable terminal device 200b when playing back content, while referring to the flowchart illustrated in FIG. 21.

The input reception unit 208b receives a specification of content from a user (Step S201).

Subsequently, a usage rule 241 corresponding to a content ID identifying the content a specification of which is received is read out from the secure storage unit 202b (Step S202). Subsequently, the usage rule so read out is checked (Step S203). When the use of the content does not match the usage rule (“NO” in Step S204), the control unit 201b generates a message indicating that the use of the content does not match the usage rule, and the display unit 207b displays the generated message (Step S205). This ends the operations of the portable terminal device 200b for playing back content.

When the use of the content matches the usage rule (“YES” in Step S204), the encryption processing unit 205b reads out the device key 251 from the device key storage unit 210b (Step S206). Subsequently, the encryption processing unit 205b generates a content key by decrypting an encrypted content key by using the device key (Step S207). Subsequently, the encryption processing unit 205b generates content by decrypting encrypted content by using the content key (Step S208). Subsequently, the playback unit 209b plays back the content, and the display unit 207b displays the content (Step S209).

This ends the operations of the portable terminal device 200b for playing back content.

(4) Operations of Management Device 300b when Notifying Purchasable Period Start Date

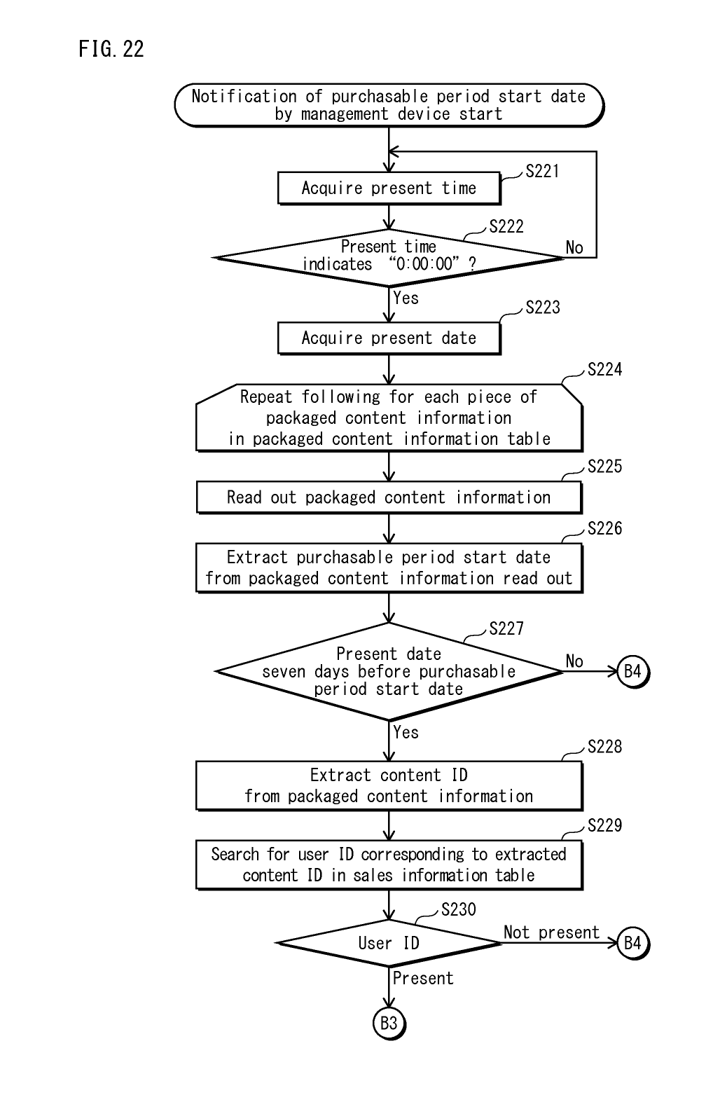

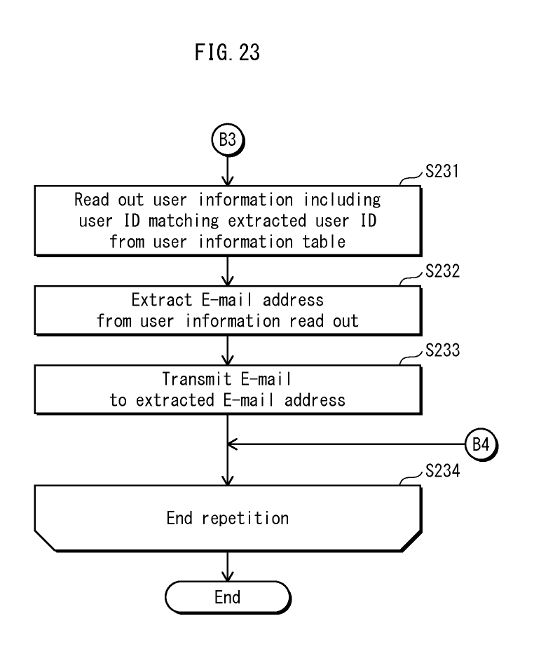

In the following, description is provided on operations of the management device 300b when notifying a user of a purchasable period start date, while referring to the flowchart illustrated in FIGS. 22 and 23.

The notification unit 311b acquires a present time (Step S221). Subsequently, the notification unit 311b checks whether or not the present time is “0:00:00” (i.e., midnight) (Step S222). When the present time is not “0:00:00” (“NO” in Step S222), processing returns to Step S221 and is repeated once again.

When the present time is “0:00:00” (“YES” in Step S222), the notification unit 311b acquires the present date (Step S223).

Subsequently, the notification unit 311b performs the processing from Step S225 to Step S233 for each piece of packaged content information in the packaged content information table 330 (Steps S224 through S234).

The notification unit 311b reads out one piece of packaged content information from the packaged content information table 330 (Step S225). Subsequently, the notification unit 311b extracts a purchasable period start date from the packaged content information so read out (Step S226). Subsequently, the notification unit 311b checks whether or not the present date is seven days before the purchasable period start date (Step S227).

When the present date is not seven days before the purchasable period start date (“NO” in Step S227), processing proceeds to Step S234.

When the present date is seven days before the purchasable period start date (“YES” in Step S227), the notification unit 311b extracts a content ID from the packaged content information read out (Step S228). Subsequently, the notification unit 311b searches the sales information table 340 for a user ID associated with the extracted content ID (Step S229).

When such a user ID is not present in the sales information table 340 (“Not present” in Step S230), the notification unit 311b proceeds to the processing in Step S234.

When such a user ID is present in the sales information table 340 (“Present” in Step S230), the notification unit 311b reads out, from the user information table 320, a piece of user information including a user ID matching the extracted user ID (Step S231). Subsequently, the notification unit 311b extracts an E-mail address from the user information so read out (Step S232). Subsequently, the notification unit 311b generates an E-mail addressed to a user, and transmits the generated E-mail to the extracted E-mail address (Step S233). The E-mail includes description that a purchasable period start date starts in seven days from the present date.

This ends the operations of the management device 300b when notifying a purchasable period start date.

Note that alternatively, the notification unit 311b may send to a user an E-mail including description that a purchasable period start date has been set when a purchasable period start date of content is set.

(5) Operations of Playback Device 600b when Acquiring Content

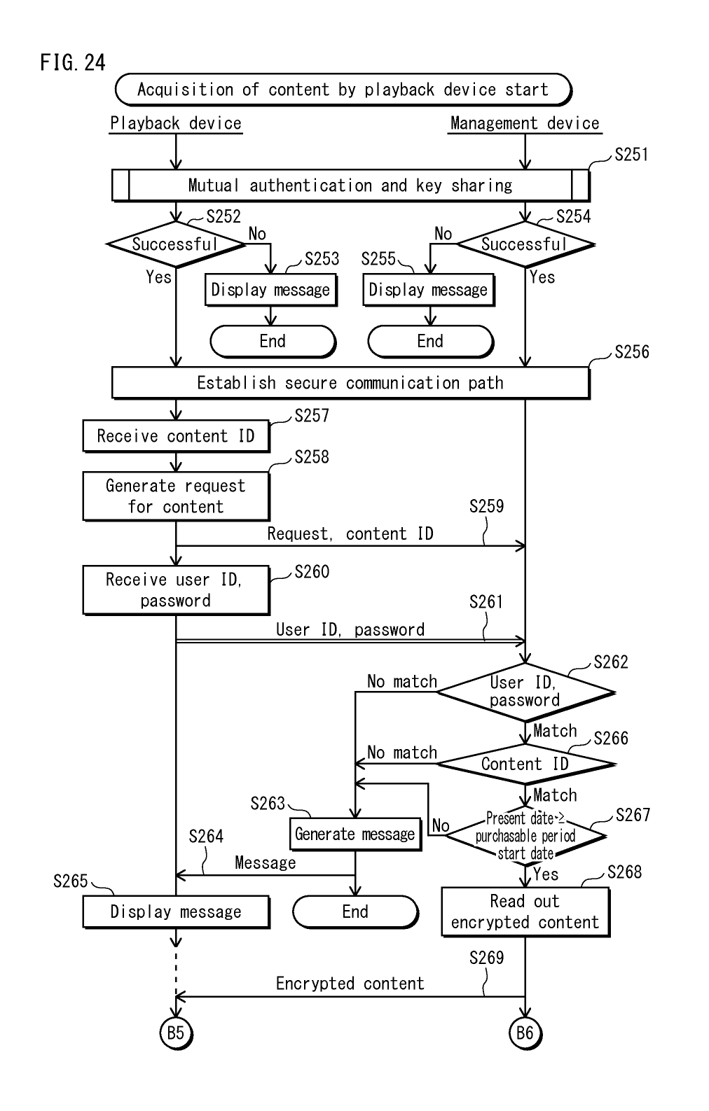

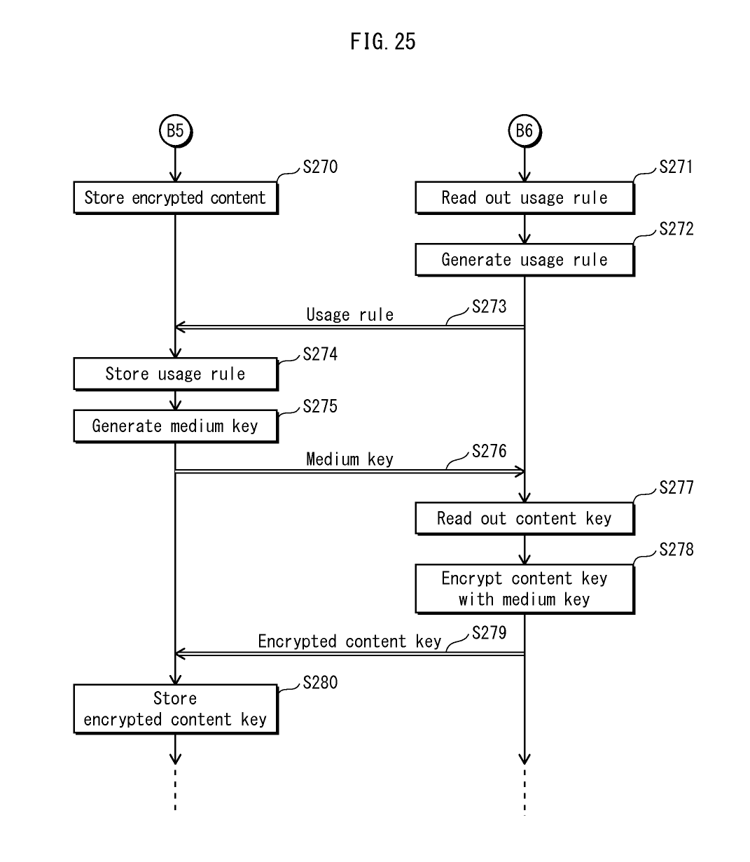

In the following, description is provided on operations of the playback device 600b when acquiring content, by referring to the sequence diagram in FIGS. 24 and 25.

The authentication unit 604b of the playback device 600b and the authentication unit 304b of the management device 300b perform mutual authentication and key sharing (Step S251). Note that the details of the procedures when performing mutual authentication and key sharing are described later in the present disclosure.

When authentication of the management device 300b fails (“NO” in Step S252), the control unit 601b generates a message indicating that the authentication of the management device 300b has failed, and the display unit 607b displays the generated message (Step S253). This ends the operation of the playback device 600b.

When authentication of the playback device 600b fails (“NO” in Step S254), the control unit 301b generates a message indicating that the authentication of the playback device 600b has failed, and the display unit 307b displays the generated message (Step S255). This ends the operation of the management device 300b.

When mutual authentication and the key sharing between the playback device 600b and the management device 300b are successful (“YES” in Step S252 and “YES” in Step S254), the control unit 601b and the control unit 301b establish a secure communication path (Step S256).

The input reception unit 608b receives input of a content ID from a user (Step S257). The control unit 601b generates a request for content (Step S258). Subsequently, the control unit 601b transmits the request for content and the content ID to the management device 300b via the communication unit 603b and the network 20b (Step S259). Subsequently, the control unit 301b receives the request for content and the content ID from the playback device 600b via the communication unit 303b and the network 20b (Step S259).

The input reception unit 608b receives input of a user ID and a password from the user (Step S260). Subsequently, the control unit 601b transmits the user ID and the password to the management device 300b via the secure communication path (Step S261). Subsequently, the control unit 301b receives the user ID and the password from the playback device 600b via the secure communication path (Step S261).

The judgment unit 306b judges whether or not the user ID and the password so received are stored in the sales information table 340 (Step S262). When the user ID and the password are not stored in the sales information table 340 (“No match” in Step S262), the judgment unit 306b generates a message to that effect (Step S263), and transmits the generated message to the playback device 600b (Step S264).

The communication unit 603b of the playback device 600b receives the message (Step S264), and the display unit 607b displays the received message (Step S265).

When the user ID and the password received are stored in the sales information table 340 (“Match” in Step S262), the judgment unit 306b judges whether or not the received content ID is stored in the sales information table 340 (Step S266). When the content ID is not stored in the sales information table 340 (“No match” in Step S266), the judgment unit 306b generates a message to that effect (Step S263), and transmits the generated message to the playback device 600b (Step S264).

When the received content ID is stored in the sales information table 340 (“Match” in Step S266), the judgment unit 306b compares the present date and a purchasable period start date stored in the packaged content information table 330 (Step S267). When the present date is before the purchasable period start date (“NO” in Step S267), the judgment unit 306b generates a message to that effect (Step S263), and transmits the generated message to the playback device 600b (Step S264).

When the present date is on or after the purchasable period start date (“YES” in Step S267), the judgment unit 306b permits distribution of the requested content. The communication unit 303b, according to an instruction from the judgment unit 306b, reads out encrypted content from the storage unit 302b (Step S268). Subsequently, the communication unit 303b transmits the encrypted content so read out to the playback device 600b via the network 20b (Step S269).

The control unit 601b receives the encrypted content from the management device 300b via the communication unit 603b and the network 20b (Step S269). Subsequently, the control unit 601b writes the received encrypted content to the portable recording medium 602b (Step S270).

Subsequently, the control unit 301b reads out a usage rule including the received content ID from the usage rule table 350 of the storage unit 302b (Step S271), and generates a new usage rule by updating the usage rule so read out (Step S272). Specifically, in the new usage rule, the early-stage content identification flag is set to indicate “0”, and the playback-available period is set to a period whose start date is either on or after the purchasable period start date. Subsequently, the control unit 301b transmits the generated usage rule to the playback device 600b via the secure communication path (Step S273).

The control unit 601b receives the usage rule from the management device 300b via the secure communication path (Step S273). Subsequently, the control unit 601b writes the received usage rule to the portable recording medium 602b (Step S274).

The control unit 601b generates a medium key by using the medium key ID 651 stored in the portable recording medium 602b (Step S275), and transmits the generated medium key to the management device 300b via the secure communication path (Step S276).

The control unit 301b receives the medium key from the playback device 600b via the secure communication path (Step S276). Subsequently, the encryption processing unit 305b, by being controlled by the control unit 301b, reads out a content key from the storage unit 302b (Step S277). Subsequently, the encryption processing unit 305b, by being controlled by the control unit 301b, generates an encrypted content key by encrypting the content key so read out by using the received medium key (Step S278). Subsequently, the encryption processing unit 305b transmits the encrypted content key to the portable terminal device 600b via the secure communication path (Step S279).

The control unit 601b receives the encrypted content key from the management device 300b via the secure communication path (Step S279). Subsequently, the control unit 601b writes the received encrypted content key to the portable recording medium 602b (Step S280).

This ends the operations of the playback device 600b when acquiring content.

(6) Operations of Playback Device 600b for Playing Back Content

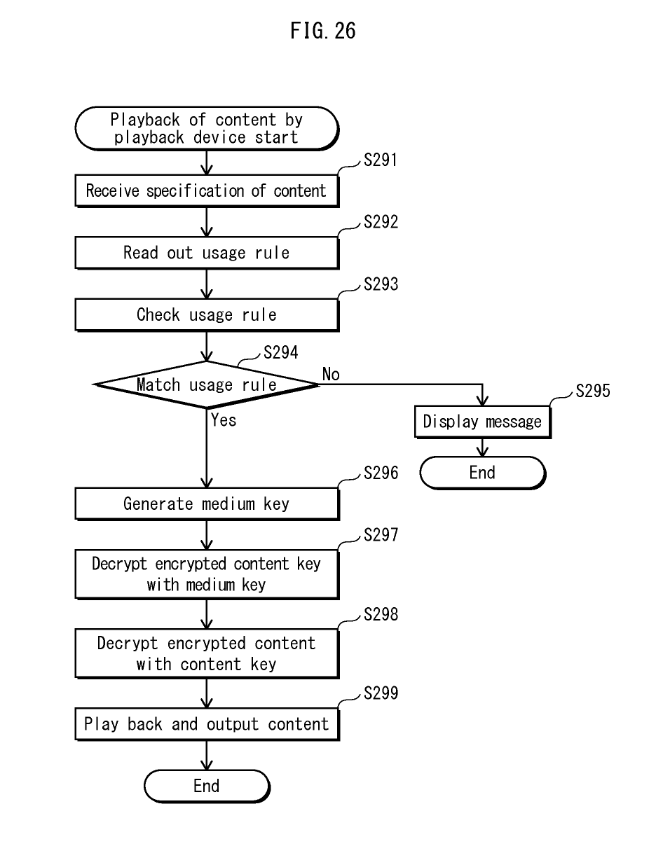

In the following, description is provided on operations of the portable terminal device 600b for playing back content, while referring to the flowchart illustrated in FIG. 26.

The input reception unit 608b receives a specification of content from a user (Step S291).

Subsequently, a usage rule 641 corresponding to a content ID identifying the content a specification of which is received is read out from the portable recording medium 602b (Step S292). Subsequently, the usage rule so read out is checked (Step S293). When the use of the content does not match the usage rule (“NO” in Step S294), the control unit 601b generates a message indicating that the use of the content does not match the usage rule, and the display unit 607b displays the generated message (Step S295). This ends the operations of the portable terminal device 600b for playing back content.

When the use of the content matches the usage rule (“YES” in Step S294), the encryption processing unit 605b generates a medium key by using the medium ID 651 stored in the portable recording medium 602b (Step S296). Subsequently, the encryption processing unit 605b generates a content key by decrypting an encrypted content key stored in the portable recording medium 602b by using the generated medium key (Step S297). Subsequently, the encryption processing unit 605b generates content by decrypting encrypted content stored in the portable recording medium 602b by using the content key (Step S298). Subsequently, the playback unit 606b plays back the content, and the display unit 607b outputs the content (Step S299).

This ends the operations of the portable terminal device 600b for playing back content.

(7) Operations of Authentication Unit 104b of Sales Device 100b and Authentication Unit 204b of Portable Terminal Device 200b when Performing Mutual Authentication and Key Sharing

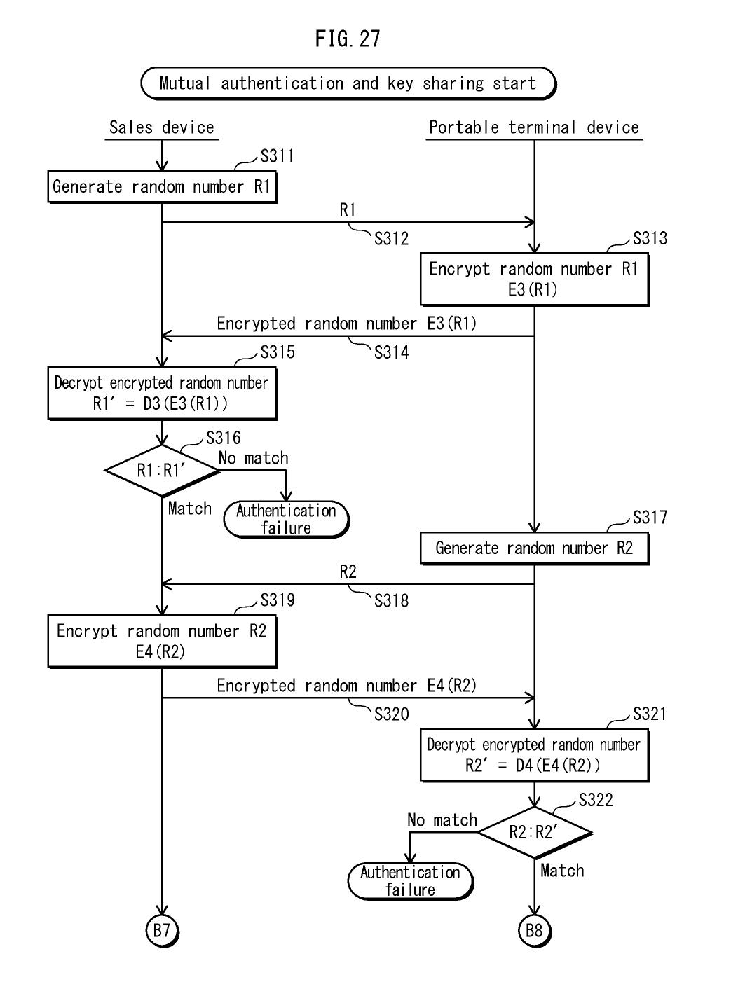

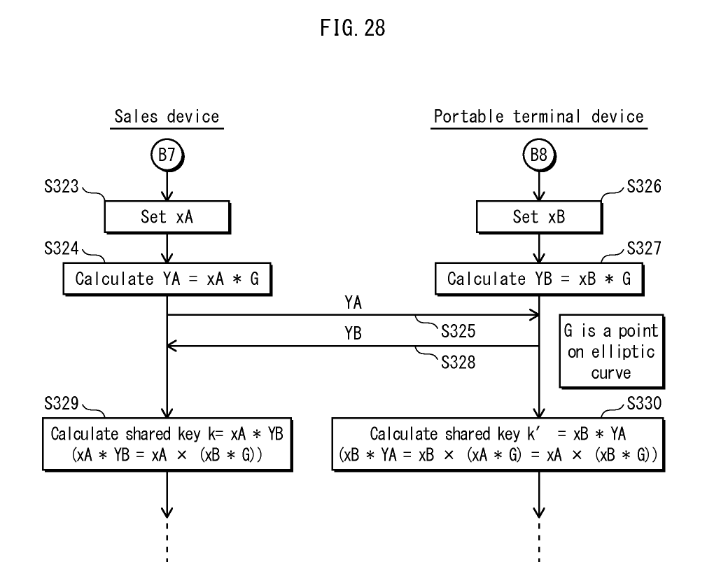

In the following, description is provided on the operations of the authentication unit 104b of the sales device 100b and the authentication unit 204b of the portable terminal device 200b when performing mutual authentication and key sharing, by referring to the sequence diagram in FIGS. 27 and 28.

The authentication unit 104b generates a random number R1 (Step S311). Subsequently, the authentication unit 104b transmits the generated random number R1 to the portable terminal device 200b (Step S312).

The encryption processing unit 205b receives the random number R1 from the sales device 100b (Step S312). Subsequently, an encrypted random number E3(R1) is generated by encrypting the random number R1 by applying an encryption algorithm E3 (Step S313), and the generated encrypted random number E3(R1) is transmitted to the sales device 100b (Step S314).

The encryption processing unit 105b receives the encrypted random number E3(R1) from the portable terminal device 200b (Step S314). Subsequently, decrypted text RP, which equals D3(E3(R1)), is generated by decrypting the received encrypted random number E3(R1) by applying a decryption algorithm D3 (Step S315).

The authentication unit 104b compares the random number R1 and the decrypted text R1′ (Step S316). When the random number R1 and the decrypted text R1′ do not match (“No match” in Step S316), the authentication unit 104b determines that the portable terminal device 200b is not authentic, outputs a result indicating failure of authentication, and ends the authentication processing.

The authentication unit 204b generates a random number R2 (Step S317). Subsequently, the authentication unit 204b transmits the generated random number R2 to the sales device 100b (Step S318).

On the other hand, when the random number R1 and the decrypted text R1′ match (“Match” in Step S316), the authentication unit 104b determines that the portable terminal device 200b is authentic. The encryption processing unit 105b receives the random number E2 from the portable terminal device 200b (Step S318). An encrypted random number E4(R2) is generated by encrypting the random number R2 by applying an encryption algorithm E4 (Step S319), and the generated encrypted random number E4(R2) is transmitted to the portable terminal device 200b (Step S320).

The encryption processing unit 205b receives the encrypted random number E4(R2) from the sales device 100b (Step S320). Subsequently, decrypted text R2′, which equals D4(E4(R2)), is generated by decrypting the received encrypted random number E4(R2) by applying a decryption algorithm D4 (Step S321).

The authentication unit 204b compares the random number R2 and the decrypted text R2′ (Step S322). When the random number R2 and the decrypted text R2′ do not match (“No match” in Step S322), the authentication unit 204b determines that the sales device 100b is not authentic, and outputs a result indicating failure of authentication.

On the other hand, when the random number R2 and the decrypted text R2′ match (“Match” in Step S322), the authentication unit 204b determines that the sales device 100b is authentic, and outputs a result indicating successful completion of authentication.

When mutual authentication is successful (“Match” in Step S316, and “Match” in Step S322), the encryption processing unit 105b sets scalar xA (Step S323). Subsequently, YA=xA*G is calculated (Step S324). Here, YA and G are points on an elliptic curve. Subsequently, the encryption processing unit 105b transmits YA to the portable terminal device 200b (Step S325).

When mutual authentication is successful (“Match” in Step S316, and “Match” in Step S322), the encryption processing unit 205b sets scalar xB (Step S326). Subsequently, YB=xB*G is calculated (Step S327). Here, YB is a point on the elliptic curve. Subsequently, the encryption processing unit 205b transmits YB to the sales device 100b (Step S328).

Subsequently, the encryption processing unit 105b calculates a shared key k=xA*YB (Step S329). The shared key k is a point on the elliptic curve. Here, note that among the coordinates of the shared key k, which is a point on the elliptic curve, the x-axis coordinate of the point may be used independently as the shared key k.

Further, the encryption processing unit 205b calculates a shared key k′=xB*YA. The shared key k′ is a point on the elliptic curve (Step S330). Here, note that among the coordinates of the shared key k′, which is a point on the elliptic curve, the x-axis coordinate of the point may be used independently as the shared key k′.

Here, the shared key

$$\begin{matrix}k = xA * YB \\ = xA \times ( xB * G ) \\ = xB \times ( xA * G ) \\ = xB * YA \\ = shared key {k}^{′}\end{matrix}$$

This ends the operations of the authentication unit 104b of the sales device 100b and the authentication unit 204b of the portable terminal device 200b for performing mutual authentication and key sharing.

A secure communication path between the sales device 100b and the portable terminal device 200b is set, based on a predetermined communication path and by using the shared keys k and k′ generated as described above. For example, as a communication path between the sales device 100b and the portable terminal device 200b, a communication path utilizing short-distance wireless communication may be established by the short-distance wireless unit 106b of the sales device 100b and the short-distance wireless unit 206b of the portable terminal device 200b.

Next, description is provided on transmission and reception of data via the secure communication path.

When transmitting data to the portable terminal device 200b via the secure communication path, the sales device 100b generates encrypted data by encrypting the data by using the shared key k. The sales device 100b transmits the generated encrypted data to the portable terminal device 200b. The portable terminal device 200b, when receiving the encrypted data, generates data by decrypting the encrypted data by using the shared key k′. Thus, the transmission of data from the sales device 100b to the portable terminal device 200b is performed in a safe manner. The transmission of data from the portable terminal device 200b to the sales device 100b is performed in a similar manner Here, the encryption algorithm for performing encryption and the decryption algorithm for performing decryption are, for example, AES.

Note that mutual authentication and key sharing between any pair of devices among the following are performed in a similar manner as described above: the sales device 100b; the on-board playback device 400b; the portable terminal device 200b; the management device 300b; the billing server device 500b; and the playback devices 600b, . . . , 601b.

2.10 Summary of Embodiment 2

In the content distribution system 10b, during an initial release period of content, which precedes a purchasable period of the content, selling of the content is permitted to a user who is entitled to receive a service provided at a theater or a movie theater, in an airplane, or in a hotel, by making a payment for the service. During the initial release period, a user who is entitled to receive a service as described above is able to acquire and store content to a portable terminal device that the user has, and is able to play back the content, although playback of the content is limited to playback on the portable terminal device.

This enables a user who is impressed by a movie that he/she has seen at a theater or a movie theater, in an airplane, or in a hotel room, to acquire content corresponding to the movie and re-experience the excitement at home.

Here, note that typically, a portable terminal device has a display screen that is smaller in size than that of a stationary television, etc. As such, the user having acquired content is permitted to play back the content only on a small screen of the portable terminal device that the user has. Due to this, even if the user and his/her family were to play back and thus view the content on the user's portable terminal device, the content would be less impressive and powerful compared to when viewed on a large screen in a theater or a movie theater. Accordingly, the availability of the content for playback on a portable terminal device would not keep a family having viewed the content on a portable terminal device from visiting a movie theater or a theater.

In addition, encrypted content stored to a portable terminal device that a user has is generated by encrypting plaintext content by using a content key. Further, the content key is stored to the portable terminal device in an encrypted state, encrypted by using a device key unique to the portable terminal device. Due to this, even when the encrypted content and the encrypted content key are copied from the user's portable terminal device to another portable terminal device or a playback device, the copy destination device does not have the device key and thus would not be able to decrypt the encrypted content key. Due to this, the copy destination device would not be able to decrypt the encrypted content. As such, even when the content is copied to a device or a recording medium other than the user's portable terminal device, the content cannot be played back at the copy destination. This prevents the content from being copied in an unauthorized manner to devices and recording media other than the user's portable terminal device.

In addition, in the content distribution system 10b, when a user purchases content while the content is still being shown in theaters or is being exclusively shown on-board airplanes, the management device 300b manages the right to view the content in association with the user. Owing to this, when the release phase shifts from the initial release period of the content to a purchasable period of the content, where the content is made purchasable in the form of a packaged medium, a notification is made to the user of the purchasable period start date of the content, and permission is granted to the user to view the content on a playback device that the user has. Accordingly, the provision of content to users is performed in a flexible manner.

### 3. Embodiment 3

Embodiment 3 provides description on a content distribution system 10c, as another example of implementation of the present invention.

3.1 Content Distribution System 10c

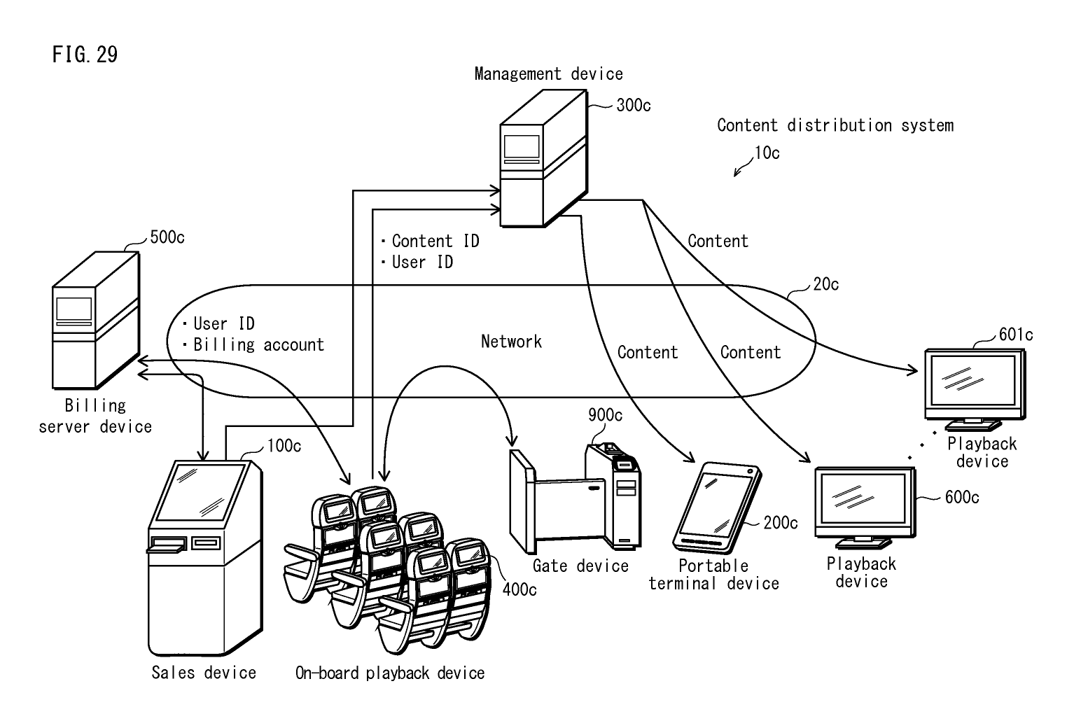

As illustrated in FIG. 29, the content distribution system 10c includes: a sales device 100c; an on-board playback device 400c; a portable terminal device 200c; a management device 300c; a billing server device 500c; playback devices 600c, . . . , 601c; and a gate device 900c. The sales device 100c, the on-board playback device 400c, the portable terminal device 200c, the management device 300c, the billing server device 500c, and the playback devices 600c, . . . , 601c are all connected to a network 20c. The gate device 400c and the gate device 900c are connected to one another via the network 20c.

The sales device 100c, the on-board playback device 400c, the portable terminal device 200c, the management device 300c, the billing server device 500c, the playback devices 600c, . . . , 601c, and the gate device 900c have the same structures as the sales device 100b, the on-board playback device 400b, the portable terminal device 200b, the management device 300b, the billing server device 500b, the playback devices 600b, . . . , 601b, and the gate device 900b in the content distribution system 10b, respectively. In the following, description is provided while focusing on the differences between the devices in the content distribution system 10c and the devices in the content distribution system 10b.

In the content distribution system 10b, the portable terminal device 200b, when purchasing content, acquires the content from the sales device 100b or the on-board playback device 400b. In contrast, in the content distribution system 10c, the acquisition of purchased content is performed as follows. A user performs procedures for purchasing content by using the sales device 100c or the on-board playback device 400c. When the procedures for purchasing the content are completed, the user then acquires the content from the management device 300c via the network 20c, by using the portable terminal device 200c. Here, it should be noted that the acquisition of content can be performed only from a single device, i.e., the portable terminal device 200c.

3.2 Sales Device 100c

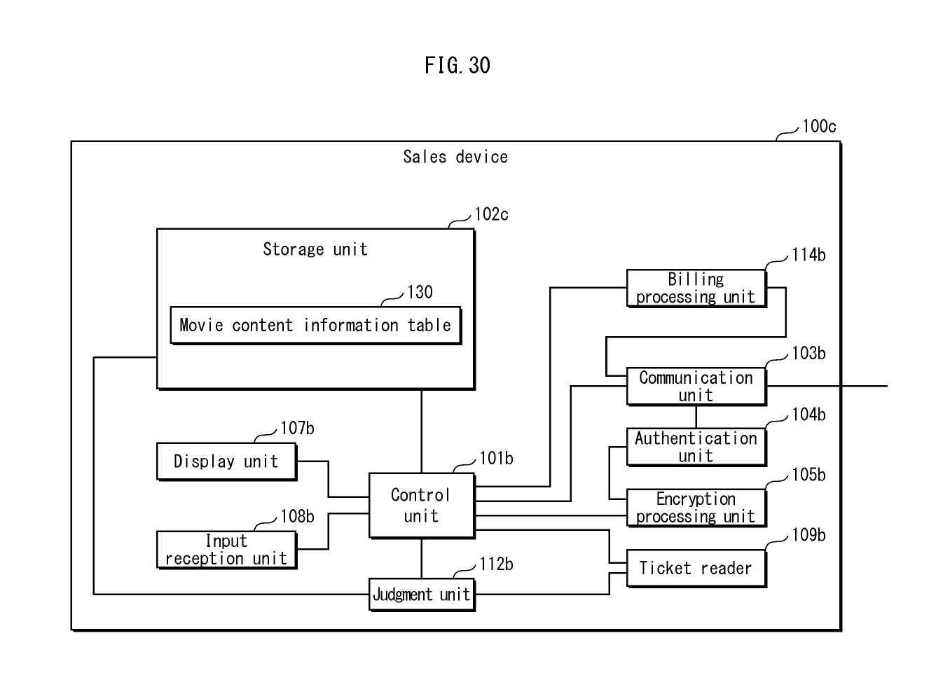

As illustrated in FIG. 30, the sales device 100c includes: the control unit 101b; a storage unit 102c; the communication unit 103b; the authentication unit 104b; the encryption processing unit 105b; the display unit 107b; the input reception unit 108b; the ticket reader 109b; the judgment unit 112b; and the billing processing unit 114b.

In specific, the sales device 100c includes a microprocessor, a RAM, a ROM, a hard disk device, etc., which are not illustrated in FIG. 30. In this sense, the sales device 100c is similar to the sales device 100b. The microprocessor operates in accordance with computer programs stored in the RAM, the ROM, and the hard disk device, whereby the sales device 100c achieves the functions thereof.

The control unit 101b, the communication unit 103b, the authentication unit 104b, the encryption processing unit 105b, the display unit 107b, the input reception unit 108b, the ticket reader 109b, the judgment unit 112b, and the billing processing unit 114b have the same structures as the control unit 101b, the communication unit 103b, the authentication unit 104b, the encryption processing unit 105b, the display unit 107b, the input reception unit 108b, the ticket reader 109b, the judgment unit 112b, and the billing processing unit 114b in the sales device 100b, respectively.

The sales device 100c does not include the short-distance wireless unit 106b, which is included in the sales device 100b.

As illustrated in FIG. 30, the storage unit 102c stores the movie content information table 130. Description on the movie content information table 130 has already been provided above.

3.3 On-board Playback Device 400c

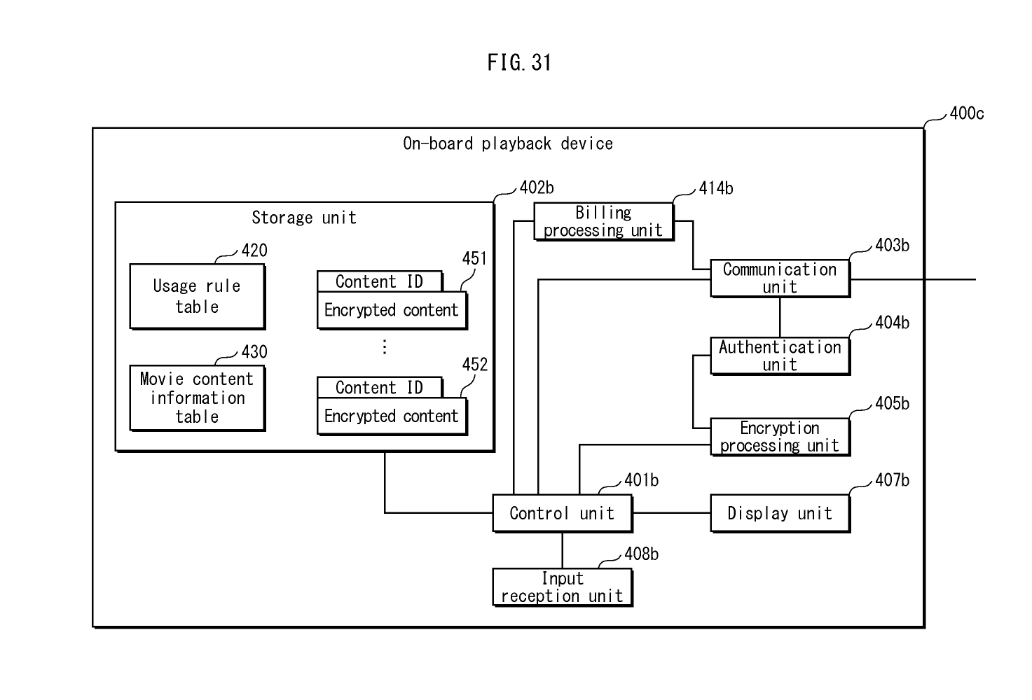

As illustrated in FIG. 31, the on-board playback device 400c includes: the control unit 401b; the storage unit 402b; the communication unit 403b; the authentication unit 404b; the encryption processing unit 405b; the display unit 407b; the input reception unit 408b; and the billing processing unit 414b.

In specific, the on-board playback device 400c includes a microprocessor, a RAM, a ROM, a hard disk, etc., which are not illustrated in FIG. 31. In this sense, the on-board playback device 400c is similar to the on-board playback device 400b. The microprocessor operates in accordance with computer programs stored in the RAM, the ROM, and the hard disk device, whereby the playback device 400c achieves the functions thereof.

The on-board playback device 400c does not include the short-distance wireless unit 406b, which is included in the on-board playback device 400b.

3.4 Management Device 300c

The storage unit 302b of the management device 300c additionally stores a model list 360.

The model list 360 includes a plurality of model IDs. Each model ID identifies a corresponding model of portable terminal devices. In the present disclosure, a portable terminal device is defined as a terminal device having a display screen of a predetermined size or smaller. For instance, the size of the display screen is 300 dots or smaller in the vertical direction and 240 dots or smaller in the lateral direction.

3.5 Operations in Content Distribution System 10c

In the following, description is provided on operations in the content distribution system 10c.

(1) Operations when Selling Content in Movie Theater

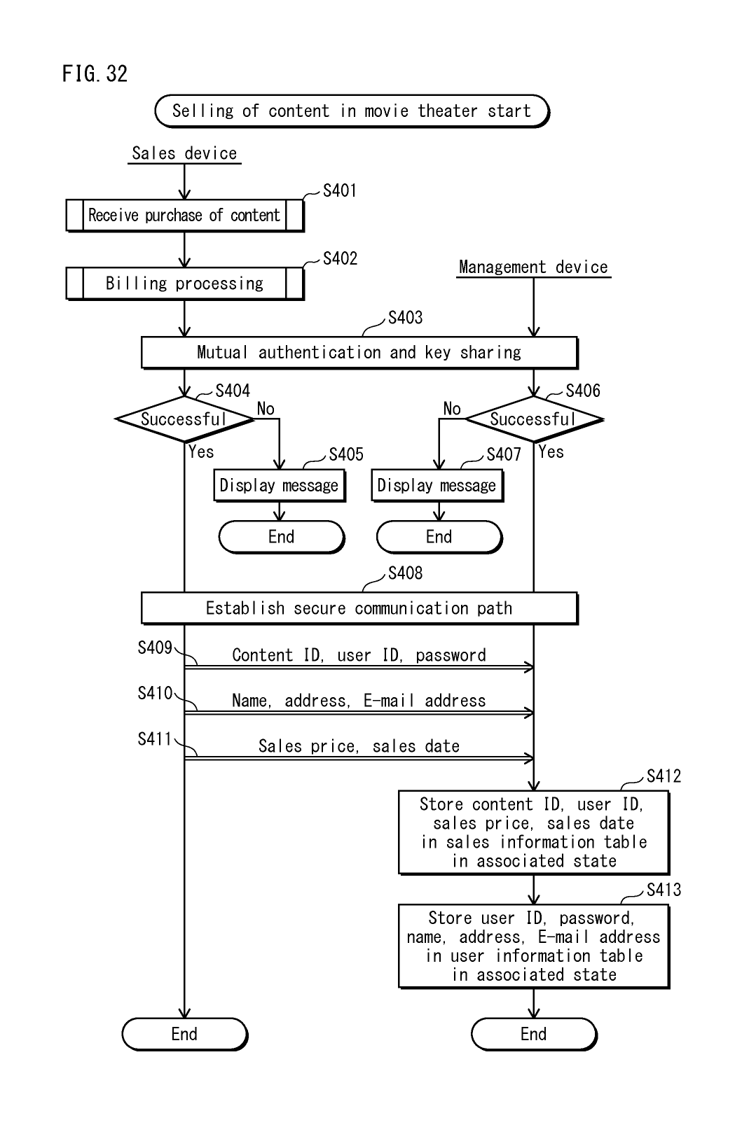

In the following, description is provided on operations, when content is sold in a movie theater, of the sales device 100c and the management device 300c, by referring to the sequence diagram in FIG. 32.

The sales device 100c receives a purchase of content from a user (Step S401). The operations when receiving a purchase of content in Step S401 are similar to those in Steps S100 through S108 illustrated in FIG. 16. Thus, detailed description thereon is not provided.

Subsequently, the sales device 100c and the billing server device 500c perform billing processing (Step S402). The operations when performing billing processing in Step S402 are similar to those in Steps S109 through S114 illustrated in FIG. 16. Thus, detailed description thereon is not provided.

When the billing processing is properly completed, the authentication unit 104b of the sales device 100c and the authentication unit 304b of the management device 300c perform mutual authentication and key sharing (Step S403). Note that the details of the mutual authentication and key sharing are as already described above.

When authentication of the management device 300c fails (“NO” in Step S404), the control unit 101b generates a message indicating that the authentication of the management device 300c has failed, and the display unit 107b displays the generated message (Step S405). This ends the operation of the sales device 100c.

When authentication of the sales device 100c fails (“NO” in Step S406), the control unit 301b generates a message indicating that the authentication of the sales device 100c has failed. The display unit 307b displays the generated message (Step S407). This ends the operation of the management device 300c.

When mutual authentication and the key sharing between the sales device 100c and the management device 300c are successful (“YES” in Step S404 and “YES” in Step S406), the control unit 101b and the control unit 301b establish a secure communication path (Step S408).

The control unit 101b transmits a content ID, a user ID, and a password to the management device 300c via the secure communication path (Step S409). The control unit 301b receives the content ID, the user ID, and the password from the sales device 100c via the secure communication path (Step S409).

The control unit 101b transmits a name, an address, and an E-mail address to the management device 300c via the secure communication path (Step S410). The control unit 301b receives the name, the address, and the E-mail address from the sales device 100c via the secure communication path (Step S410).

The control unit 101b transmits a sales price and a sales date to the management device 300c via the secure communication path (Step S411). The control unit 301b receives the sales price and the sales date from the sales device 100c via the secure communication path (Step S411).

The user information management unit 309b writes the content ID, the user ID, the sales price, and the sales date to the sales information table 340 in an associated state (Step S412). In addition, the user information management unit 309b writes the user ID, the password, the name, the address, and the E-mail address to the user information table 320 in an associated state (Step S413).

This ends the processing in the sales device 100c and the management device 300c.

(2) Operations when Selling Content in Airplane

Here, the operations of the gate device 900c are similar to those in Steps S151 through S154 illustrated in FIG. 20. In addition, the operations of the on-board playback device 400c, the billing server device 500c, and the management device 300c when content is sold in an airplane are similar to those in Steps S161 through Step S172, and Step S174 in FIG. 20. Thus, detailed description thereon is not provided.

(3) Operations of Portable Terminal Device 200c when Acquiring Content.

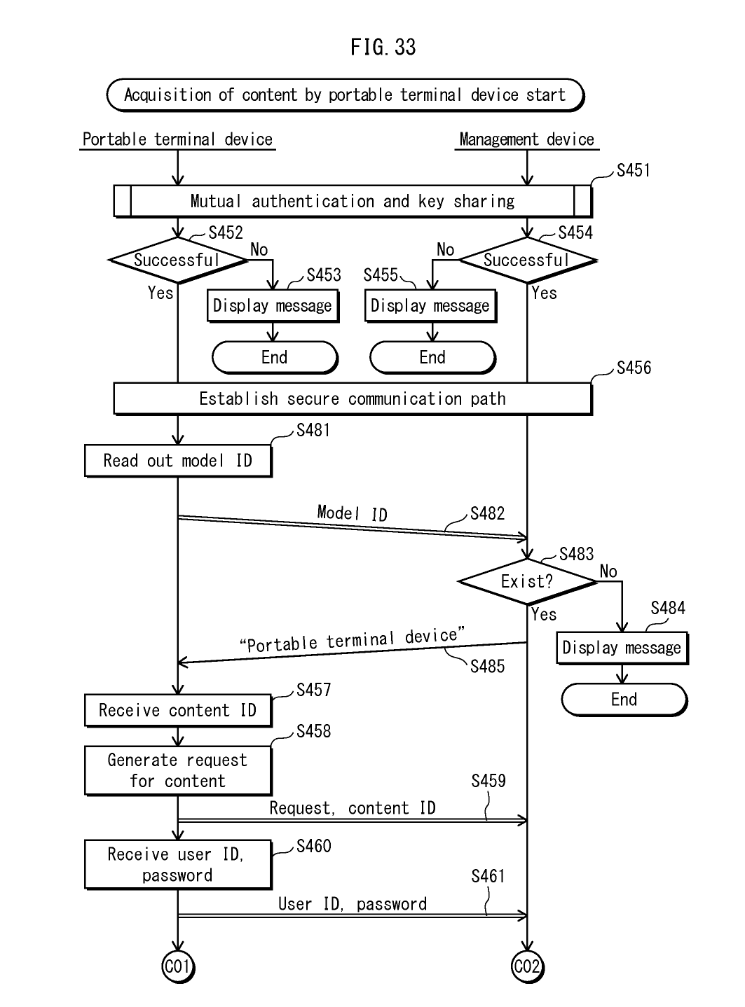

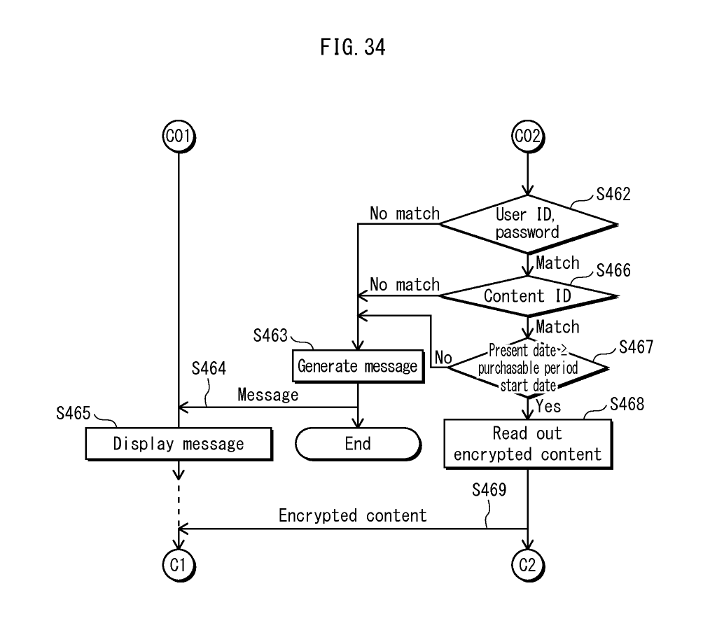

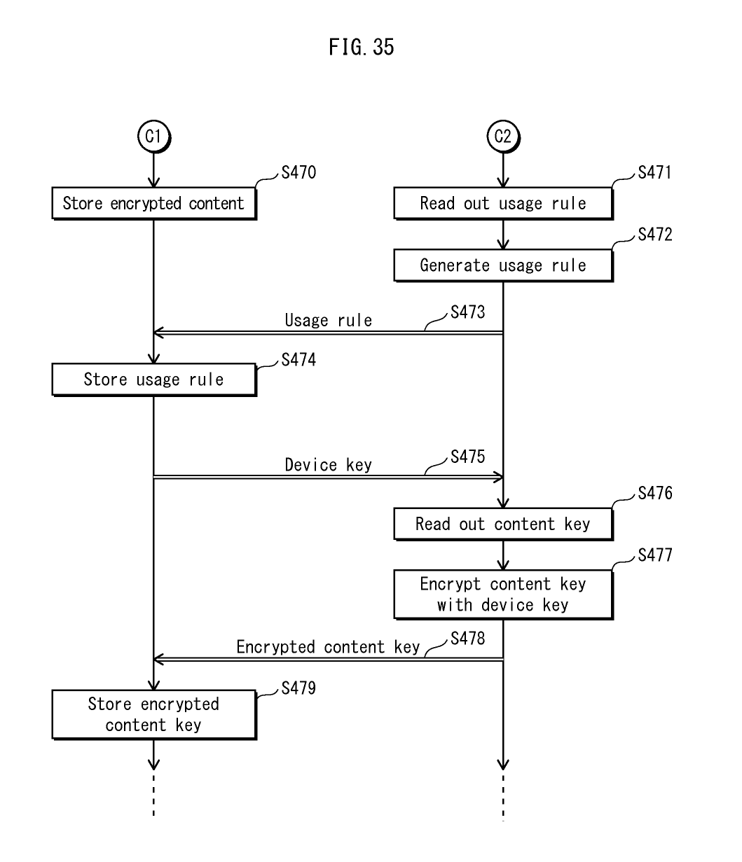

In the following, description is provided on operations of the portable terminal device 200c when acquiring content, by referring to the sequence diagram in FIGS. 33 through 35.

The authentication unit 204b of the portable terminal device 200c and the authentication unit 304b of the management device 300c perform mutual authentication and key sharing (Step S451). Note that the details of the mutual authentication and key sharing have already been described above.

When authentication of the management device 300c fails (“NO” in Step S452), the control unit 201b generates a message indicating that the authentication of the management device 300c has failed. The display unit 207b displays the generated message (Step S453). This ends the operation of the portable terminal device 200c.

When authentication of the portable terminal device 200c fails (“NO” in Step S454), the control unit 301b generates a message indicating that the authentication of the portable terminal device 200c has failed. The display unit 307b displays the generated message (Step S455). This ends the operation of the management device 300b.

When mutual authentication and the key sharing between the portable terminal device 200c and the management device 300c are successful (“YES” in Step S452 and “YES” in Step S454), the control unit 201b and the control unit 301b establish a secure communication path (Step S456).

The control unit 201b reads out the model ID 261 stored in the model ID storage unit 214b (Step S481). Subsequently, the control unit 201b transmits the model ID 261 so read out to the management device 300c via the secure communication path (Step S482).

The control unit 301b receives the model ID 261 via the secure communication path (Step S482).

Subsequently, the control unit 301b judges whether or not the received model ID 261 exists in the model list 360 (Step S483). When the model ID 261 does not exist in the model list 360 (“NO” in Step S483), the display unit 307b displays a message to that effect (Step S484). This ends the operation of the management device 300c.

When the model ID 261 exists in the model list 360 (“YES” in Step S483), the control unit 301b transmits a message indicating that the portable terminal device 200c is a portable terminal device (Step S485).

The input reception unit 208b receives input of a content ID from a user (Step S457). The control unit 201b generates a request for content (Step S458). Subsequently, the control unit 201b transmits the request for content and the content ID to the management device 300c via the secure communication path (Step S459). Subsequently, the control unit 301b receives the request for content and the content ID from the portable terminal device 200c via the secure communication path (Step S459).

The input reception unit 208b receives input of a user ID and a password from the user (Step S460). Subsequently, the control unit 201b transmits the user ID and the password to the management device 300c via the secure communication path (Step S461). Subsequently, the control unit 301b receives the user ID and the password from the portable terminal device 200c via the secure communication path (Step S461).

The judgment unit 306b judges whether or not the user ID and the password so received are stored in the sales information table 340 (Step S462). When the user ID and the password are not stored in the sales information table 340 (“No match” in Step S462), the judgment unit 306b generates a message to that effect (Step S463). Subsequently, the judgment unit 306b transmits the generated message to the portable terminal device 200c (Step S464).

The communication unit 203b of the portable terminal device 200c receives the message (Step S464), and the display unit 207b displays the received message (Step S465).

When the user ID and the password received are stored in the sales information table 340 (“Match” in Step S462), the judgment unit 306b judges whether or not the received content ID is stored in the sales information table 340 (Step S466). When the user ID and the password are not stored in the sales information table 340 (“No match” in Step S466), the judgment unit 306b generates a message to that effect (Step S463). Subsequently, the judgment unit 306b transmits the generated message to the portable terminal device 200c (Step S464).

When the received content ID is stored in the sales information table 340 (“Match” in Step S466), the judgment unit 306b compares the present date and a purchasable period start date stored in the packaged content information table 330 (Step S467). When the present date is before the purchasable period start date (“NO” in Step S467), the judgment unit 306b generates a message to that effect (Step S463). Subsequently, the judgment unit 306b transmits the generated message to the portable terminal device 200c (Step S464).

When the present date is on or after the purchasable period start date (“YES” in Step S467), the judgment unit 306b permits the distribution of content. The communication unit 303b, according to an instruction from the judgment unit 306b, reads out encrypted content from the storage unit 302b (Step S468). Subsequently, the communication unit 303b transmits the encrypted content so read out to the portable terminal device 200c via the network 20c (Step S469).

The control unit 201b receives the encrypted content from the management device 300c via the communication unit 203b and the network 20c (Step S469). Subsequently, the control unit 201b writes the received encrypted content to the secure storage unit 202b (Step S470).

Subsequently, the control unit 301b reads out a usage rule including the received content ID from the usage rule table 350 of the storage unit 302b (Step S471). Subsequently, the control unit 301b generates a new usage rule by updating the usage rule so read out (Step S472). Specifically, in the new usage rule, the early-stage content identification flag is set to indicate “0”, and the playback-available period is set to a period whose start date is either on or after the purchasable period start date. Subsequently, the control unit 301b transmits the generated usage rule to the portable terminal device 200c via the secure communication path (Step S473).

The control unit 201b receives the usage rule from the management device 300c via the secure communication path (Step S473). Subsequently, the control unit 201b writes the received usage rule to the secure storage unit 202b (Step S474).

The control unit 201b reads out the device key 251 stored in the device key storage unit 210b. Subsequently, the control unit 201b transmits the device key so read out to the management device 300c via the secure communication path (Step S475).

The control unit 301b receives the device key from the portable terminal device 200c via the secure communication path (Step S475). Subsequently, the encryption processing unit 305b, by being controlled by the control unit 301b, reads out a content key from the storage unit 302b (Step S476). Subsequently, the encryption processing unit 305b, by being controlled by the control unit 301b, generates an encrypted content key by encrypting the content key so read out by using the received device key (Step S477). Subsequently, the encryption processing unit 305b transmits the encrypted content key to the portable terminal device 200c via the secure communication path (Step S478).

The control unit 201b receives the encrypted content key from the management device 300c via the secure communication path (Step S478). Subsequently, the control unit 201b writes the received encrypted content key to the secure storage unit 202b (Step S479).

This ends the operations of the portable terminal device 200c when acquiring content.

3.4 Other Matters

In the content distribution system 10c, the acquisition of purchased content is performed as follows. After a user performs procedures for purchasing content by using the sales device 100c (or the on-board playback device 400c), the user is able to acquire the content from the management device 300c by using only a single device, i.e., the portable terminal device 200c.

The acquisition of content is performed as follows.

When a user performs procedures for purchasing content by using the sales device 100c (or the on-board playback device 400c), the user inputs a unique device ID of the portable terminal device 200c to the sales device 100c (or the on-board playback device 400c). Alternatively, the sales device 100c (or the on-board playback device 400c) may acquire, from the portable terminal device 200c, the device ID of the portable terminal device 200c via short-distance wireless communication. The sales device 100c (or the on-board playback device 400c) transmits the device ID, which is either input or acquired as described above, to the management device 300c, in association with a user ID. The management device 300c stores the user ID and the device ID in an associated state.

Further, when acquiring the content from the management device 300c, the portable terminal device 200c the user has transmits the device ID thereof to the management device 300c. The management device 300c receives the device ID and compares the received device ID and the device ID stored therein. When the received device ID and the device ID stored therein match, the management device 300c permits transmission of the content to the portable terminal device 200c. When the received device ID and the device ID stored therein do not match, the management device 300c prohibits transmission of the content to the portable terminal device 200c.

### 4. Embodiment 4

Embodiment 4 provides description on a content distribution system 10d, as another example of implementation of the present invention.

4.1 Content Distribution System 10d

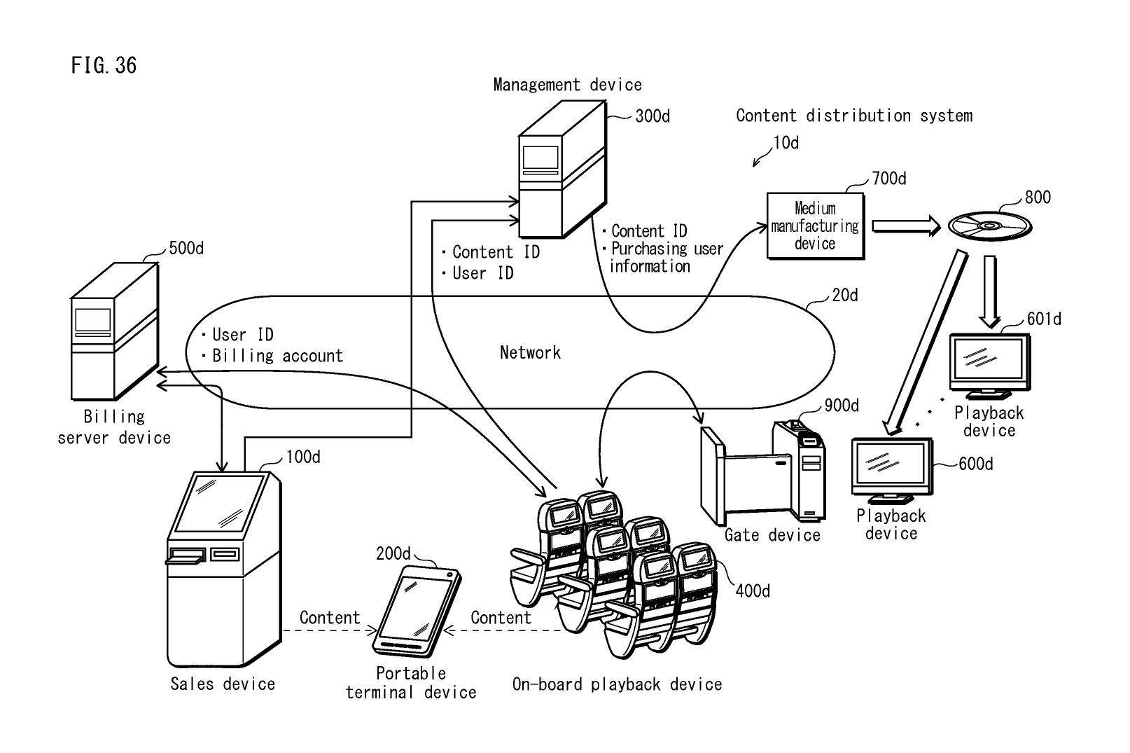

As illustrated in FIG. 36, the content distribution system 10d includes: a sales device 100d; an on-board playback device 400d; a portable terminal device 200d; a management device 300d; a billing server device 500d; a medium manufacturing device 700d; playback devices 600d, . . . , 601d; and a gate device 900d. The sales device 100d, the on-board playback device 400d, the management device 300d, the billing server device 500d, and the media manufacturing device 700d are all connected to a network 20d. The on-board playback device 400d and the gate device 900d are connected to one another via the network 20d.

The sales device 100d, the on-board playback device 400d, the portable terminal device 200d, the management device 300d, the billing server device 500d, the playback devices 600d, . . . , 601d, and the gate device 900d have the same structures as the sales device 100b, the on-board playback device 400b, the portable terminal device 200b, the management device 300b, the billing server device 500b, the playback devices 600b, . . . , 601b, and the gate device 900b in the content distribution system 10b, respectively. The content distribution system 10b does not include the medium manufacturing device 700d.

In the following, description is provided while focusing on the differences between the content distribution system 10d and the content distribution system 10b.

4.2 Management Device 300d

The management device 300d has the same structure as the management device 300b in the content distribution system 10b.

In the following, description is provided while focusing on the differences between the management device 300d and the management device 300b.

(1) Control Unit 301b

When mutual authentication between the management device 300d and the medium manufacturing device 700d is successful, the control unit 301b performs the following procedures (a) through (f) for each piece of sales information in the sales information table 340 stored in the storage unit 302b.

(a) The control unit 301b reads out one piece of sales information from the sales information table 340.

(b) The control unit 301b extracts a content ID from the sales information read out.

(c) The control unit 301b reads out packaged content information including the same content ID as the extracted content ID, and extracts a purchasable period start date from the packaged content information so read out.

(d) The control unit 301b compares the present date and the extracted purchasable period start date.

(d-1) When the present date and the purchasable period start date are not equal, the control unit 301b ends processing related to the specific piece of sales information read out.

(d-2) When the present date and the extracted purchasable period start date are equal, the control unit 301b extracts a user ID from the sales information.

(e) The control unit 301b reads out, from the user information table 320, a piece of user information including the same user ID as the extracted user ID.

(f) The control unit 301b transmits the extracted content ID and the user information read out to the medium manufacturing device 700d via a secure communication path.

4.3 Medium Manufacturing Device 700d

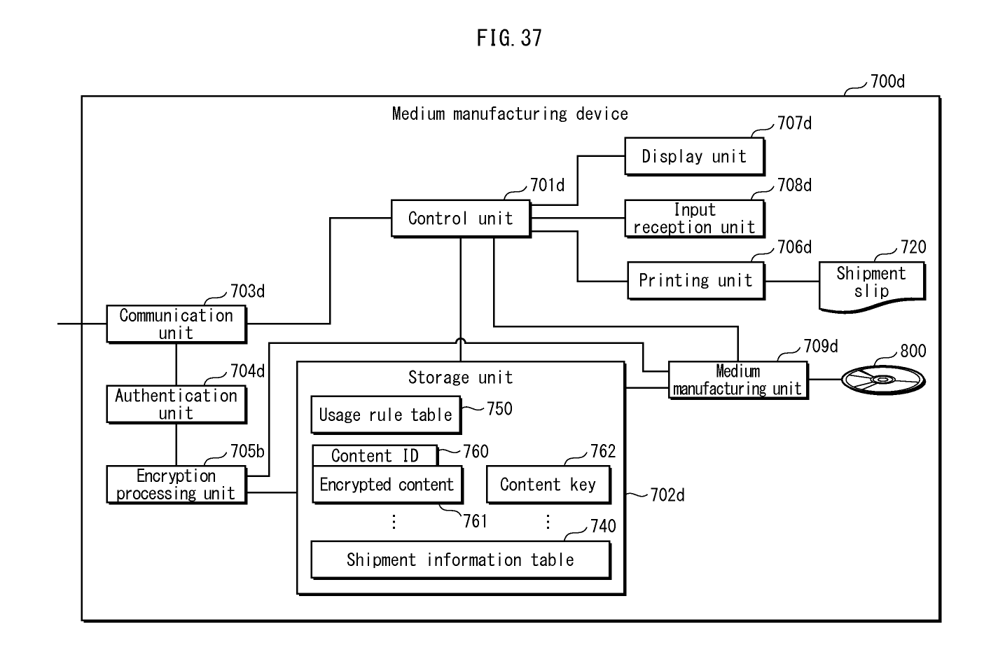

As illustrated in FIG. 37, the medium manufacturing device 700d includes: a control unit 701d; a storage unit 702d; a communication unit 703d; an authentication unit 704d; an encryption processing unit 705d; a printing unit 706d; a display unit 707d; an input reception unit 708d; and a medium manufacturing unit 709d.

In specific, the medium manufacturing device 700d includes a microprocessor, a RAM, a ROM, a hard disk device, etc., which are not illustrated in FIG. 37. The microprocessor operates in accordance with computer programs stored in the RAM, the ROM, and the hard disk device, whereby the medium manufacturing device 700d achieves the functions thereof.

Note that functional blocks of the medium manufacturing device 700d, such as the control unit 701d, the communication unit 703d, the authentication unit 704d, and the encryption processing unit 705d, are typically implemented by using LSIs, which is one type of an integrated circuit. The implementation of the above-described functional blocks by using LSIs may be performed such that a single LSI chip is used for each individual functional block. Alternatively, the above-described functional blocks may be implemented by using LSIs each including one or more of such functional blocks, or by using LSIs each including a part of each of the functional blocks.

The functional blocks may be implemented by using software, or a combination of software and LSIs. In such a case, the software may be tamper resistant.

(1) Storage Unit 702d

For example, the storage unit 702d is composed of a hard disk device.

As illustrated in FIG. 37, the storage unit 702d stores therein: a usage rule table 750; encrypted content 761 and the like; a content key 762 and the like; and a shipment information table 740.

The usage rule table 750 has the same data structure as the usage rule table 120 illustrated in FIG. 5. Further, description on encrypted content and content keys has already been provided above.

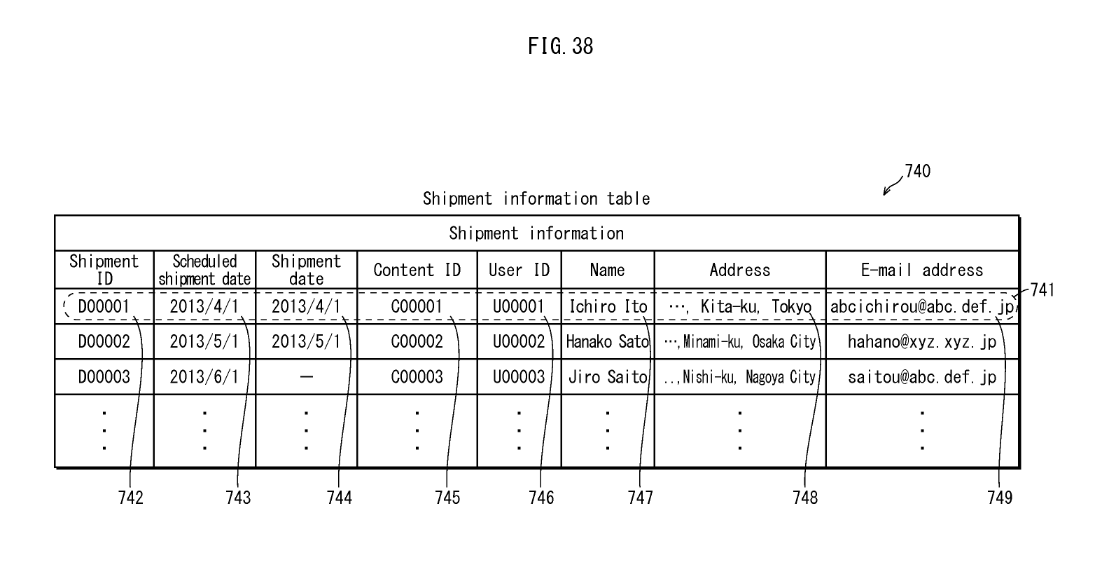

FIG. 38 illustrates one example of the shipment information table 740. The shipment information table 740 illustrated in FIG. 38 has areas for storing a plurality of pieces of shipment information. Each piece of shipment information corresponds to a packaged medium to be shipped to a user.

Each piece of shipment information includes: a shipment ID; a scheduled shipment date; a shipment date; a content ID; a user ID; a name; an address; and an E-mail address.

In each piece of shipment information, a shipment ID uniquely identifies the shipment information. In each piece of shipment information, a scheduled shipment date indicates a date on which the corresponding packaged medium is scheduled to be shipped. In each piece of shipment information, a shipment date indicates a date on which the corresponding packaged medium has actually been shipped. In each piece of shipment information, a content ID identifies packaged content included in the corresponding packaged medium. In each piece of shipment information, a user ID identifies the corresponding user. In each piece of shipment information, a name indicates the name of the corresponding user. In each piece of shipment information, an address indicates a residential location of the corresponding user. In each piece of shipment information, an E-mail address is an E-mail address allocated to the corresponding user.

As illustrated in FIG. 38, the shipment information table 740 includes shipment information 741. The shipment information 741 includes: a shipment ID 742 indicating “D00001”; a scheduled shipment date 743 indicating “2013/4/1”; a shipment date 744 indicating “2013/4/1”; a content ID 745 indicating “C00001”; a user ID 746 indicating “U00001”; a name 747 indicating “Ichiro Ito”; an address 748 indicating “ . . . , Kita-Ku, Tokyo”; and an E-mail address 749 indicating “abcichirou@abc.def.jp”.

(2) Communication Unit 703d, Authentication Unit 704d, Encryption Processing Unit 705d

The communication unit 703d performs transmission and reception of information with the management device 300d via the network 20d. The communication unit 703b may perform either wired communication or wireless communication.

The authentication unit 704d performs mutual authentication and key sharing with the management device 300d. Conventional technology such as ECDSA, ECDH, and AES are applicable in mutual authentication and key sharing. Note that detailed explanation concerning mutual authentication and key sharing is not provided here in the present disclosure.

The encryption processing unit 705d performs encryption processing, utilizing encryption technology, for confirming a communication opponent, and encryption processing for ensuring confidentiality of data. Conventional technology such as ECDSA, ECDH, and AES are applicable in encryption processing. Note that detailed explanation concerning encryption processing is not provided here in the present disclosure.

(3) Printing Unit 706d

The printing unit 706d prints shipment slips by using shipment information included in the shipment information table 740. A shipment slip has printed thereon: a shipment ID; a scheduled shipment date; a shipment date; a content ID; a user ID; a name; an address; and an E-mail address.

(4) Display Unit 707d, Input Reception Unit 708d

The display unit 707d displays shipment information.

The input reception unit 708d receives a shipment instruction from an operator, and outputs the received shipment instruction to the control unit 701d.

(5) Medium Manufacturing Unit 709d

The medium manufacturing unit 709d receives a usage rule, encrypted content, and an encrypted content key from the control unit 701d. Further, the medium manufacturing unit 709d writes the usage rule, the encrypted content, and the encrypted content key so received to a recording medium 800.

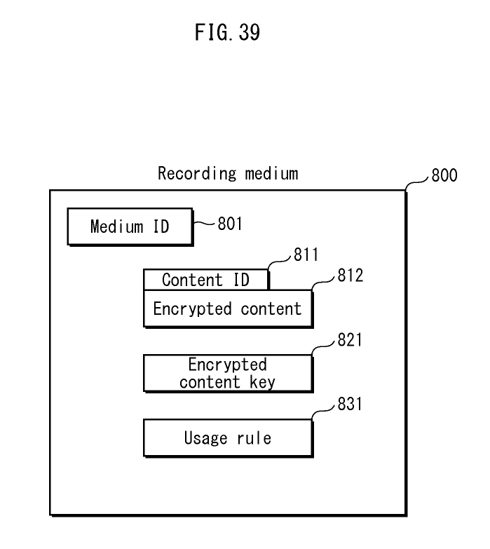

FIG. 39 illustrates one example of the recording medium 800. The recording medium 800 illustrated in FIG. 39 has recorded thereon encrypted content 812 having a content ID 811 associated therewith, an encrypted content key 821, and a usage rule 831. In addition, the recording medium 800 has a medium ID 801. The medium ID 801 uniquely identifies the recording medium 800.

(6) Control Unit 701d

The control unit 701d receives a content ID and user information from the management device 300d via the secure communication path. Further, the control unit 701d writes shipment information including the received content ID and the received user information to the shipment information table 740.

The control unit 701d performs the following procedures (a) through (k) for each piece of shipment information in the shipment information table 740.

(a) The control unit 701d reads out one piece of shipment information.

(b) The control unit 701d judges whether the packaged medium corresponding to the shipment information so read out has already been shipped by determining whether or not the shipment information includes a shipment date.

(c) When the packaged medium corresponding to the shipment information read out has already been shipped, the control unit 701d ends processing related to the specific piece of shipment information.

(d) When the packaged medium corresponding to the shipment information read out has not yet been shipped, the control unit 701d outputs the shipment information to the display unit 707d and causes the display unit 707d to display the shipment information.

(e) The control unit 701d receives a shipment instruction from the input reception unit 708d.

(f) The control unit 701d outputs the shipment information read out to the printing unit 706d and causes the printing unit 706d to print a shipping slip by using the received shipment information.

(g) The control unit 701d generates a medium key by using the medium ID recorded on the recording medium 800. For example, a hash value that is generated by performing a hash calculation (SHA-1, for example) on the medium ID is used as the medium key. Further, the control unit 701d reads out a content key from the storage unit 702d. Further, the control unit 701d causes the encryption processing unit 705d to generate an encrypted content key by encrypting the content key read out by using the generated medium key.

encrypted content key=E(medium key, content key)

(h) The control unit 701d outputs the generated encrypted content key to the medium manufacturing unit 709d. Further, the control unit 701d controls the medium manufacturing unit 709d so that the medium manufacturing unit 709d writes the received encrypted content key to the recording medium 800.

(i) The control unit 701d reads out encrypted content from the storage unit 702d and outputs the encrypted content so read out to the medium manufacturing unit 709d. Further, the control unit 701d controls the medium manufacturing unit 709d so that the medium manufacturing unit 709d writes the encrypted content to the recording medium 800.

(j) The control unit 701d reads out, from the usage rule table 750, a usage rule corresponding to the extracted content ID, and outputs the usage rule so read out to the medium manufacturing unit 709d. Further, the control unit 701d controls the medium manufacturing unit 709d so that the medium manufacturing unit 709d writes the usage rule to the recording medium 800.

(k) The control unit 701d writes the present date to the “shipment date” field of the shipment information read out in the shipment information table 740.

4.2 Operations when Manufacturing Packaged Medium

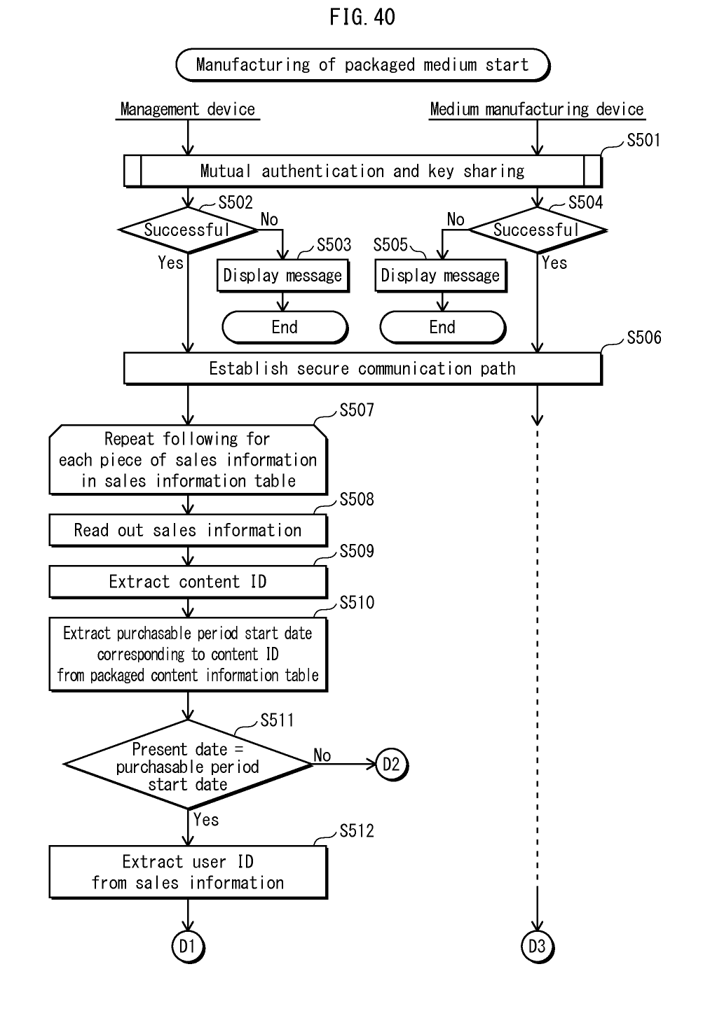

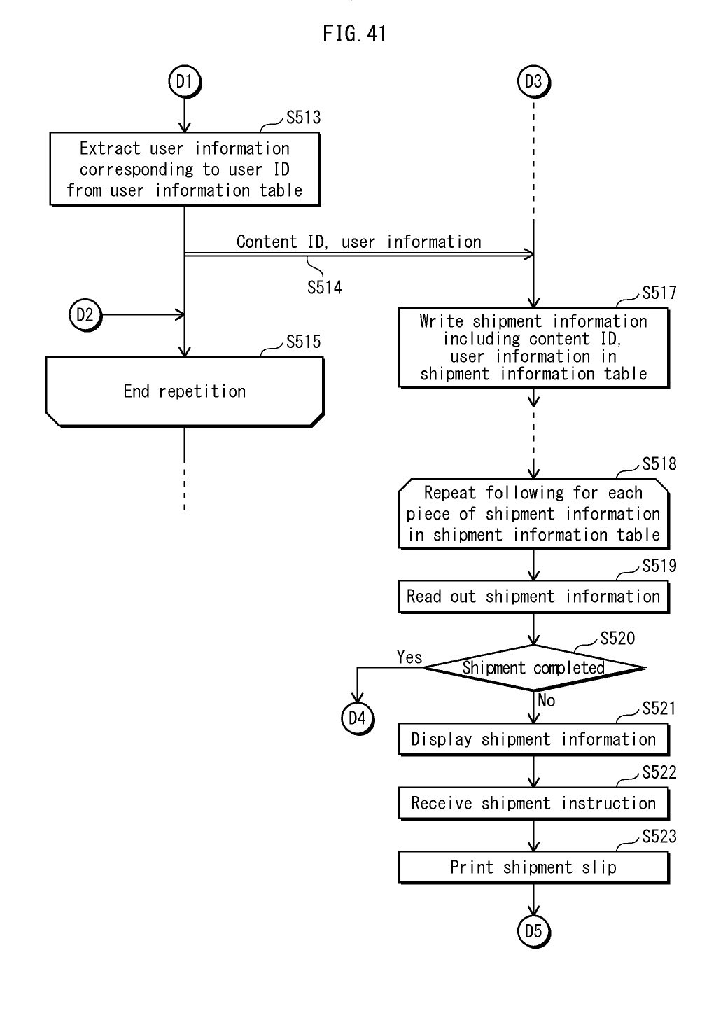

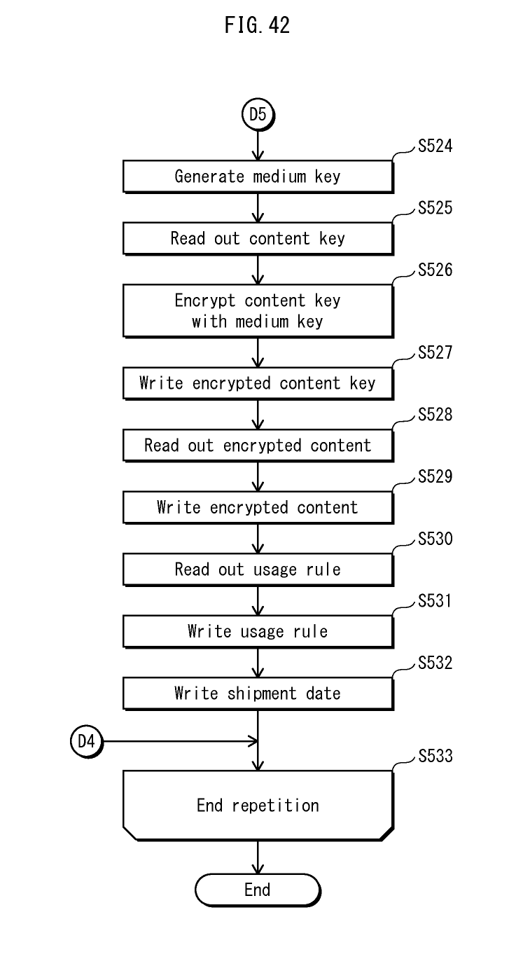

In the following, description is provided on operations of the medium manufacturing device 700d when manufacturing a packaged medium, by referring to the sequence diagram in FIGS. 40 through 42.

The authentication unit 304b of the management device 300d and the authentication unit 704d of the medium manufacturing device 700d perform mutual authentication and key sharing on a regular basis (Step S501). For example, the authentication unit 304b and the authentication unit 704d may perform mutual authentication and key sharing once a day. Note that the details of the mutual authentication and key sharing have already been described above.

When authentication of the medium manufacturing device 700d fails (“NO” in Step S502), the control unit 301b generates a message indicating that the authentication of the medium manufacturing device 700d has failed, and the display unit 307b displays the generated message (Step S503). This ends the operation of the management device 300d.

When authentication of the management device 300d fails (“NO” in Step S504), the control unit 701b generates a message indicating that the authentication of the management device 300d has failed, and the display unit 707d displays the generated message (Step S505). This ends the operation of the management device 700d.

When mutual authentication and the key sharing between the medium manufacturing device 700d and the management device 300d are successful (“YES” in Step S502 and “YES” in Step S504), the control unit 301b and the control unit 701d establish a secure communication path (Step S506).

The control unit 301b performs the processing from Step S508 to Step S514 for each piece of sales information included in the sales information table 340 stored in the storage unit 302b (Steps S507 through S515).

The control unit 301b reads out one piece of sales information from the sales information table 340 (Step S508). Subsequently, the control unit 301b extracts a content ID from the sales information read out (Step S509). Subsequently, the control unit 301b reads out packaged content information including the same content ID as the extracted content ID from the packaged content information table 330. Subsequently, the control unit 301b extracts a purchasable period start date from the packaged content information so read out (Step S510).

Subsequently, the control unit 301b compares the present date and the extracted purchasable period start date (Step S511). When the present date and the purchasable period start date are not equal (“NO” in Step S511), the control unit 301b proceeds to the processing in Step S515.

When the present date and the extracted purchasable period start date are equal (“YES” in Step S511), the control unit 301b extracts a user ID from the sales information (Step S512).

Subsequently, the control unit 301b reads out, from the user information table 320, a piece of user information including the same user ID as the extracted user ID (Step S513).

Subsequently, the control unit 301b transmits the extracted content ID and the user information read out to the medium manufacturing device 700d via the secure communication path (Step S514).

The control unit 701d receives the content ID and the user information from the management device 300d via the secure communication path (Step S514). Subsequently, the control unit 701d writes shipment information including the received content ID and the received user information to the shipment information table 740 (Step S517).

The control unit 701b performs the processing from Step S519 to Step S532 for each piece of shipment information included in the shipment information table 740 (Steps S518 through S533).

The control unit 701b reads out one piece of sales information from the sales information table 740 (Step S519). Subsequently, the control unit 701d judges whether the packaged medium corresponding to the shipment information has already been shipped by determining whether or not the shipment information includes a shipment date (Step S520). When the packaged medium corresponding to the shipment information has already been shipped (“YES” in Step S520), the control unit 701d proceeds to processing in Step S533.

When the packaged medium corresponding to the shipment information has not yet been shipped (“NO” in Step S520), the control unit 701d outputs the shipment information read out to the display unit 707d, and the display unit 707d displays the shipment information (Step S521). Subsequently, the input reception unit 708d receives a shipment instruction from the operator, and outputs the shipment instruction to the control unit 701d (Step S522). When receiving the shipment instruction, the control unit 701d outputs the shipment information read out to the printing unit 706d, and the printing unit 706d prints a shipment slip by using the received shipment information (Step S523).

Subsequently, the control unit 701d generates a medium key (Step S524) and reads out a content key from the storage unit 702d (Step S525). Subsequently, the control unit 701d causes the encryption processing unit 705d to generate an encrypted content key by encrypting the content key read out by using the generated medium key (Step S526).

encrypted content key=E(medium key, content key)

Subsequently, the control unit 701d outputs the generated encrypted content key to the medium manufacturing unit 709d. The medium manufacturing unit 709d receives the encrypted content key and writes the encrypted content key so received to the recording medium 800 (Step S527).

Subsequently, the control unit 701d reads out encrypted content from the storage unit 702d and outputs the encrypted content so read out to the medium manufacturing unit 709d (Step S528). Subsequently, the medium manufacturing unit 709d receives the encrypted content and writes the encrypted content so received to the recording medium 800 (Step S529).

Subsequently, the control unit 701d reads out a usage rule corresponding to the extracted content ID from the usage rule table 750 stored in the storage unit 702d. Subsequently, the control unit 701d outputs the usage rule so read out to the medium manufacturing unit 709d (Step S530). Subsequently, the medium manufacturing unit 709d receives the usage rule and writes the usage rule so received to the recording medium 800 (Step S531).

Subsequently, the control unit 701d writes the present date to the “shipment date” field of the shipment information in the shipment information table 740 (Step S532).

This concludes the description on the operations of the medium manufacturing device 700d when manufacturing a packaged medium.

### 5. Embodiment 5

Embodiment 5 provides description on a content distribution system 10e, as another example of implementation of the present invention.

5.1 Content Distribution System 10e

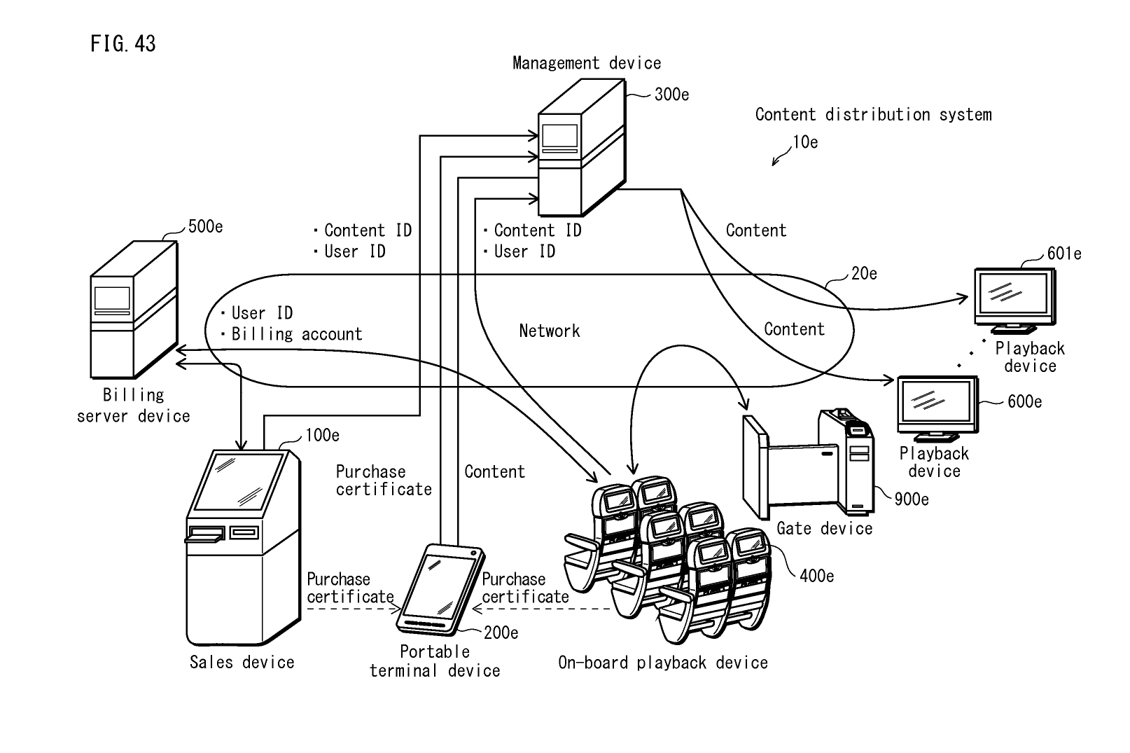

As illustrated in FIG. 43, the content distribution system 10e includes: a sales device 100e; an on-board playback device 400e; a portable terminal device 200e; a management device 300e; a billing server device 500e; playback devices 600e, . . . , 601e; and a gate device 900e. The sales device 100e, the on-board playback device 400e, the portable terminal device 200e, the management device 300e, the billing server device 500e, and the playback devices 600e, . . . , 601e are all connected to a network 20e. The on-board playback device 400e and the gate device 900e are connected to one another via the network 20e.

The sales device 100e, the on-board playback device 400e, the portable terminal device 200e, the management device 300e, the billing server device 500e, the playback devices 600e, . . . , 601e, and the gate device 900e have the same structures as the sales device 100b, the on-board playback device 400b, the portable terminal device 200b, the management device 300b, the billing server device 500b, the playback devices 600b, . . . , 601b, and the gate device 900b in the content distribution system 10b, respectively.

In the following, description is provided while focusing on the differences between the content distribution system 10e and the content distribution system 10b.

5.2 Sales Device 100e

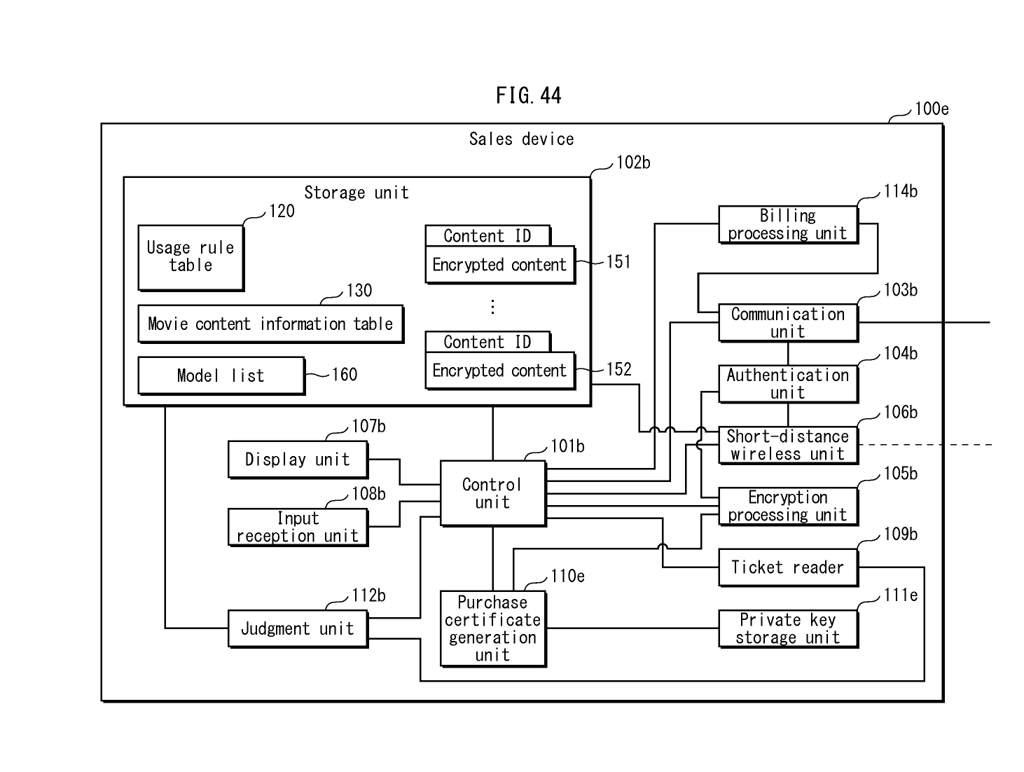

As illustrated in FIG. 44, the sales device 100e includes: the control unit 101b; the storage unit 102b; the communication unit 103b; the authentication unit 104b; the encryption processing unit 105b; the short-distance wireless unit 106b; the display unit 107b; the input reception unit 108b; the ticket reader 109b; the judgment unit 112b; a purchase certificate generation unit 110e; a private key storage unit 111e; and a billing processing unit 114e.

The control unit 101b, the storage unit 102b, the communication unit 103b, the authentication unit 104b, the encryption processing unit 105b, the short-distance wireless unit 106b, the display unit 107b, the input reception unit 108b, the ticket reader 109b, the judgment unit 112b, and the billing processing unit 114b included in the sales device 100e have the same structures as the control unit 101b, the storage unit 102b, the communication unit 103b, the authentication unit 104b, the encryption processing unit 105b, the short-distance wireless unit 106b, the display unit 107b, the input reception unit 108b, the ticket reader 109b, the judgment unit 112b, and the billing processing unit 114b included in the sales device 100b in the content distribution system 10b, respectively.

(1) Private Key Storage Unit 111e

For example, the private key storage unit 111e is composed of a non-volatile semiconductor memory. The private key storage unit 111e stores a private key allocated to the sales device 100e. Here, the private key is a private key generated by applying a key generation algorithm that uses a public key cryptosystem. By generating a private key by applying this key generation algorithm, a public key that forms a pair with the private key is also generated.

One example of a key generation algorithm that uses a public key cryptosystem is ECDSA.

(2) Purchase Certificate Generation Unit 110e

The purchase certificate generation unit 110e, by being controlled by the control unit 101b, generates a purchase certificate as described in the following.

The purchase certificate generation unit 110e receives purchase data from the control unit 101b. The purchase data includes: a purchase certificate ID; a content ID; a title; a sales price; a sales date; a sales device ID; and user information.

The user information includes: a user ID; a name; an address; and an E-mail address.

The purchase certificate ID identifies a corresponding purchase certificate. The content ID identifies content. The title is the title of the content. The sales price indicates the price at which the content has been sold. The sales date indicates the date on which the content has been sold. The sales device ID identifies the sales device having sold the content.

The user information is information related to a user having purchased the content. The user ID identifies the user. The name is the name of the user. The address indicates the residential location of the user. The E-mail address is the E-mail address allocated to the user.

The purchase certificate generation unit 110e reads out the private key of the sales device 100e from the private key storage unit 111e. Further, the purchase certificate generation unit 110e causes the encryption processing unit 105b to generate signature data by applying a digital signature algorithm S to the received purchase data by using the private key so read out as a key.

signature data=S(private key, purchase data)

Here, S (A, B) indicates signature data generated by applying digital signature algorithm S to data B by using private key A. The digital signature algorithm S is, for example, a digital signature algorithm that uses ECDSA.

Further, the purchase certificate generation unit 110e generates a purchase certificate by concatenating the purchase data and the signature data in the stated order.

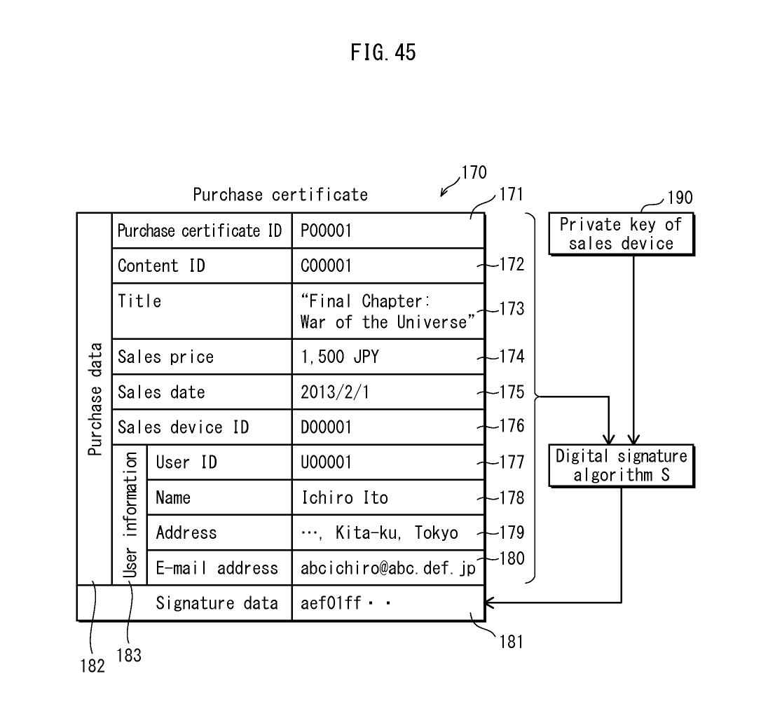

FIG. 45 illustrates a purchase certificate 170 as one example of the purchase certificate. The purchase certificate 170 is composed of purchase data 182 and signature data 181.

The purchase data 182 includes: a purchase certificate ID 171; a content ID 172; a title 173; a sales price 174; a sales date 175; a sales device ID 176; and user information 183. The user information 183 includes: a user ID 177; a name 178; an address 179; and an E-mail address 180.

The signature data 181 is generated by applying a digital signature algorithm S to the purchase data 182 by using a private key 190, which is the private key of the sales device 100e.

5.3 On-board Playback Device 400e

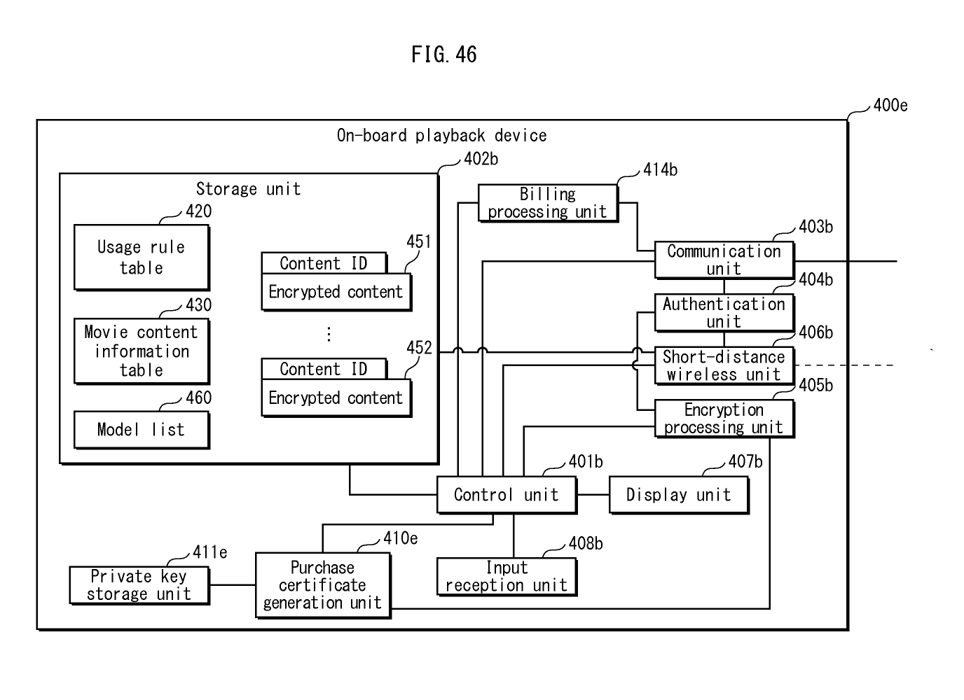

As illustrated in FIG. 46, the on-board playback device 400e includes: the control unit 401b; the storage unit 402b; the communication unit 403b; the authentication unit 404b; the encryption processing unit 405b; the short-distance wireless unit 406b; the display unit 407b; the input reception unit 408b; a purchase certificate generation unit 410e; and a private key storage unit 411e.

The control unit 401b, the storage unit 402b, the communication unit 403b, the authentication unit 404b, the encryption processing unit 405b, the short-distance wireless unit 406b, the display unit 407b, and the input reception unit 408b included in the on-board playback device 400e have the same structures as the control unit 401b, the storage unit 402b, the communication unit 403b, the authentication unit 404b, the encryption processing unit 405b, the short-distance wireless unit 406b, the display unit 407b, and the input reception unit 408b included in the on-board playback device 400b in the content distribution system 10b, respectively.

In the following, description is provided while focusing on the differences between the on-board playback device 400e and the on-board playback device 400b.

(1) Private Key Storage Unit 411e

For example, the private key storage unit 411e is composed of a non-volatile semiconductor memory. The private key storage unit 411e stores a private key allocated to the on-board playback device 400e. Here, the private key is a private key generated by applying a key generation algorithm that uses a public key cryptosystem. By generating a private key by applying this key generation algorithm, a public key that forms a pair with the private key is also generated.

One example of a key generation algorithm that uses a public key cryptosystem is ECDSA.

(2) Purchase Certificate Generation Unit 410e

The purchase certificate generation unit 410e has the same structure as the purchase certificate generation unit 110e included in the sales device 100e.

The purchase certificate generation unit 410e, by being controlled by the control unit 401b, receives purchase data from the control unit 401b. Further, the purchase certificate generation unit 410e reads out the private key of the on-board playback device 400e from the private key storage unit 411e. Further, the purchase certificate generation unit 410e causes the encryption processing unit 405b to generate signature data by applying a digital signature algorithm S to the received purchase data by using the private key so read out as a key. Further, the purchase certificate generation unit 410e generates a purchase certificate composed of the purchase data and the signature data.

5.4 Portable Terminal Device 200e

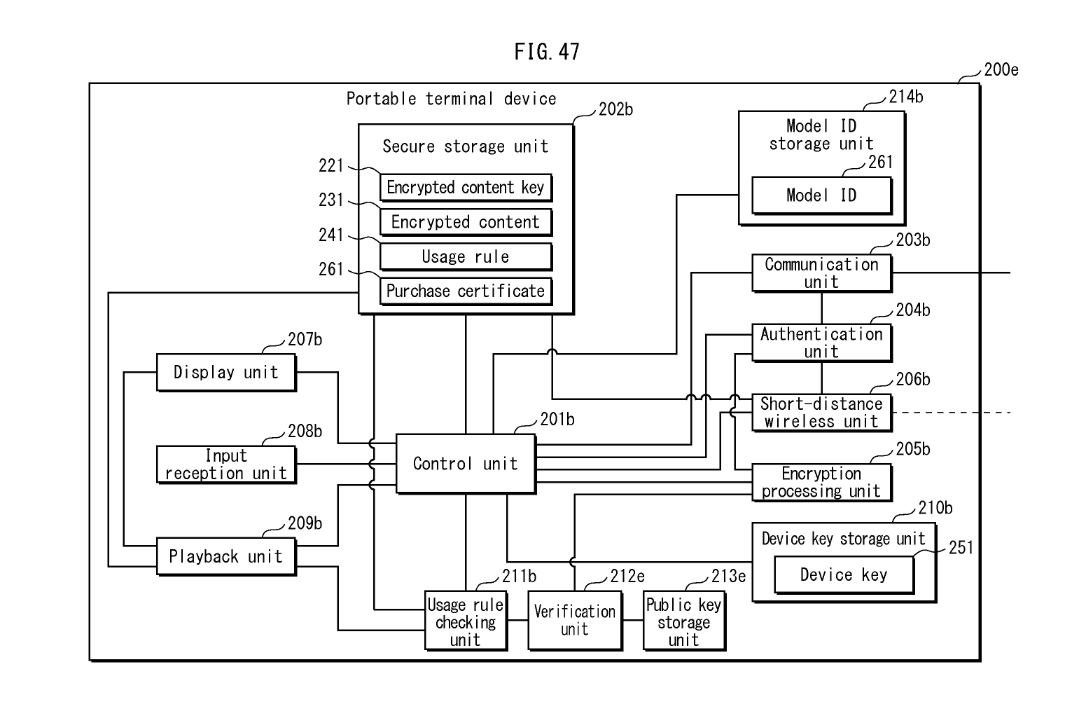

As illustrated in FIG. 47, the portable terminal device 200e includes: the control unit 201b; the secure storage unit 202b; the communication unit 203b; the authentication unit 204b; the encryption processing unit 205b; the short-distance wireless unit 206b; the display unit 207b; the input reception unit 208b; the playback unit 209b; the device key storage unit 210b; the usage rule checking unit 211b; a verification unit 212e; a public key storage unit 213e; and the model ID storage unit 214b.

The control unit 201b, the secure storage unit 202b, the communication unit 203b, the authentication unit 204b, the encryption processing unit 205b, the short-distance wireless unit 206b, the display unit 207b, the input reception unit 208b, the playback unit 209b, the device key storage unit 210b, the usage rule checking unit 211b, and the model ID storage unit 214b included in the portable terminal device 200e have the same structures as the control unit 201b, the secure storage unit 202b, the communication unit 203b, the authentication unit 204b, the encryption processing unit 205b, the short-distance wireless unit 206b, the display unit 207b, the input reception unit 208b, the playback unit 209b, the device key storage unit 210b, the usage rule checking unit 211b, and the model ID storage unit 214b included in the portable terminal device 200b in the content distribution system 10b, respectively.

In the following, description is provided while focusing on the differences between the portable terminal device 200e and the portable terminal device 200b.

(1) Secure Storage Unit 202b

The secure storage unit 202b stores a purchase certificate.

(2) Public Key Storage Unit 213e

For example, the private key storage unit 213e is composed of a non-volatile semiconductor memory. The public key storage unit 213e stores a public key allocated to the sales device 100e and a public key allocated to the on-board playback device 400e.

Here, each public key is a public key generated by applying a key generation algorithm that uses a public key cryptosystem. By generating a public key by applying this key generation algorithm, a private key that forms a pair with the public key is also generated.

One example of a key generation algorithm that uses a public key cryptosystem is ECDSA.

(3) Verification Unit 212e

The verification unit 212e reads out, from the public key storage unit 213e, the public key of the sales device 100e (or the public key of the on-board playback device 400e).

Further, the verification unit 212e performs verification of the purchase certificate stored in the secure storage unit 202b by applying a verification algorithm that uses a public key cryptosystem to the purchase certificate by using the public key of the sales device 100e (or the public key of the on-board playback device 400e). In addition, the verification unit 212e outputs a result (success or failure) of the verification.

5.5 Management Device 300e

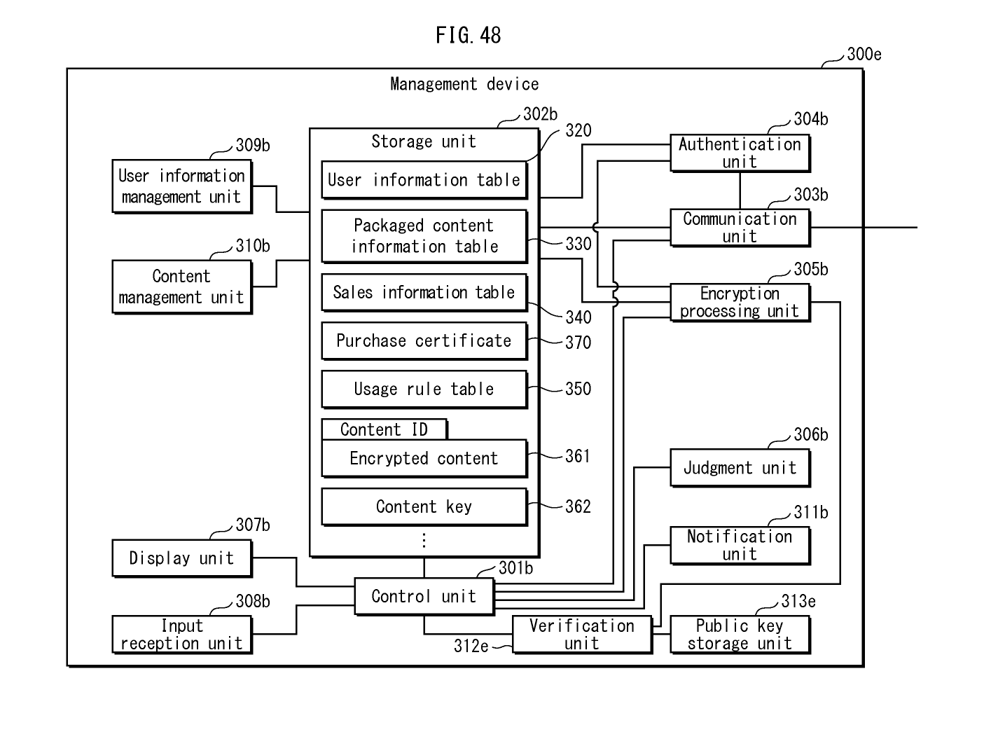

As illustrated in FIG. 48, the management device 300e includes: the control unit 301b; the storage unit 302b; the communication unit 303b; the authentication unit 304b; the encryption processing unit 305b; the judgment unit 306b; the display unit 307b; the input reception unit 308b; the user information management unit 309b; the content management unit 310b; the notification unit 311b; a verification unit 312e; and a public key storage unit 313e.

The control unit 301b, the storage unit 302b, the communication unit 303b, the authentication unit 304b, the encryption processing unit 305b, the judgment unit 306b, the display unit 307b, the input reception unit 308b, the user information management unit 309b, the content management unit 310b, and the notification unit 311b in the management device 300e have the same structures as the control unit 301b, the storage unit 302b, the communication unit 303b, the authentication unit 304b, the encryption processing unit 305b, the judgment unit 306b, the display unit 307b, the input reception unit 308b, the user information management unit 309b, the content management unit 310b, and the notification unit 311b included in the management device 300b in the content distribution system 10b, respectively.

In the following, description is provided while focusing on the differences between the management device 300e and the management device 300b.

(1) Storage Unit 302b

The storage unit 302b stores a purchase certificate 370.

(2) Public Key Storage Unit 313e

For example, the public key storage unit 313e is composed of a non-volatile semiconductor memory. The public key storage unit 313e stores the public key allocated to the sales device 100e and the public key allocated to the on-board playback device 400e.

Here, each key is a public key generated by applying a key generation algorithm that uses a public key cryptosystem. By generating a public key by applying this key generation algorithm, a private key that forms a pair with the public key is also generated.

One example of a key generation algorithm that uses a public key cryptosystem is ECDSA.

(3) Verification Unit 312e

The verification unit 312e reads out, from the public key storage unit 313e, the public key of the sales device 100e (or the public key of the on-board playback device 400e).

Further, the verification unit 312e performs verification of the purchase certificate stored in the storage unit 302b by applying a verification algorithm that uses a public key cryptosystem to the purchase certificate by using the public key of the sales device 100e (or the public key of the on-board playback device 400e). In addition, the verification unit 312e outputs a result (success or failure) of the verification.

5.6 Operations in Content Distribution System 10e

In the following, description is provided on operations of the content distribution system 10e, while focusing on the differences between the operations of the content distribution system 10e and the operations of the content distribution system 10b.

(1) Operations when Selling Content in Movie Theater

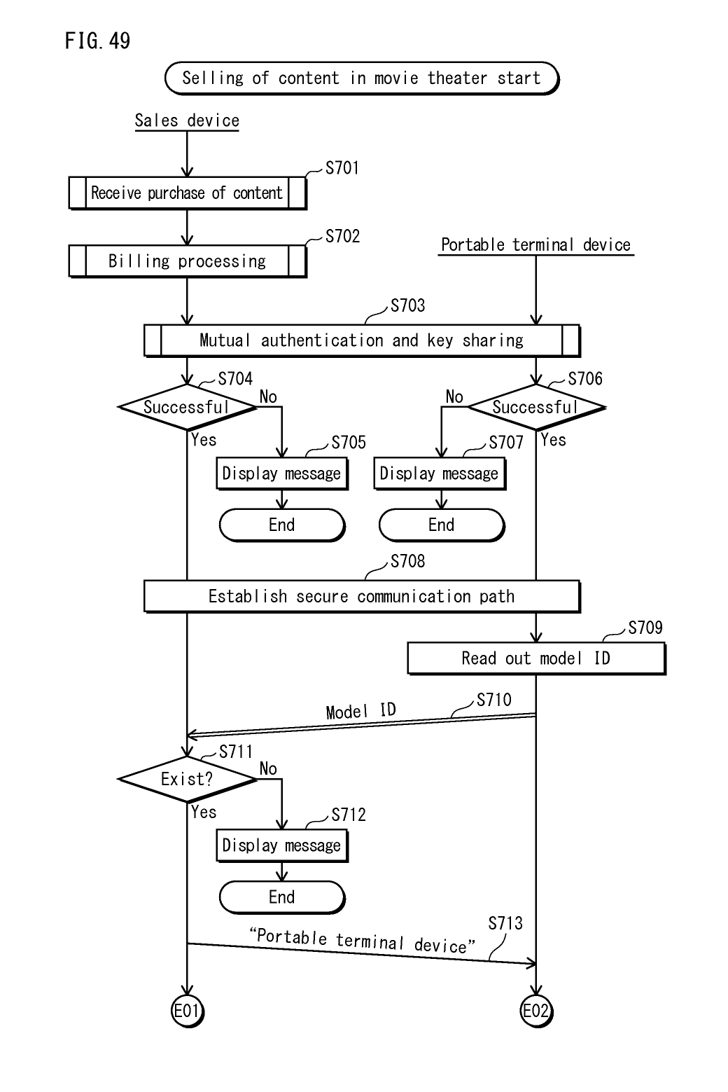

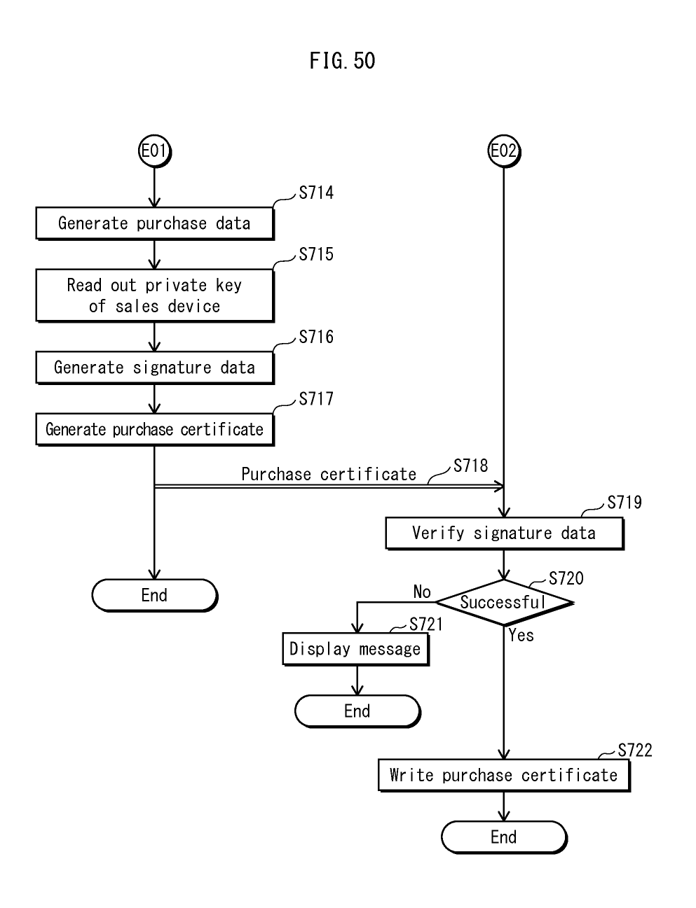

In the following, description is provided on operations, when content is sold in a movie theater, of the sales device 100e and the portable terminal device 200e, by referring to the sequence diagram in FIGS. 49 and 50.

The sales device 100e receives a purchase of content from a user (Step S701). The operations when receiving a purchase of content in Step S701 are similar to those in Steps S100 through S108 illustrated in FIG. 16. Thus, detailed description thereon is not provided.

Subsequently, the sales device 100e and the billing server device 500e perform billing processing (Step S702). The operations when performing billing processing in Step S702 are similar to those in Steps S109 through S114 illustrated in FIG. 16. Thus, detailed description thereon is not provided.

When the billing processing is properly completed, the authentication unit 104b of the sales device 100e and the authentication unit 204b of the portable terminal device 200e perform mutual authentication and key sharing (Step S703). Note that the details of the mutual authentication and key sharing have already been described above.

When authentication of the portable terminal device 200e fails (“NO” in Step S704), the control unit 101b generates a message indicating that the authentication of the portable terminal device 200e has failed, and the display unit 107b displays the generated message (Step S705). This ends the operation of the sales device 100e.

When authentication of the sales device 100e fails (“NO” in Step S706), the control unit 201b generates a message indicating that the authentication of the sales device 100e has failed, and the display unit 207b displays the generated message (Step S707). This ends the operation of the portable terminal device 200e.

When mutual authentication and the key sharing between the sales device 100e and the portable terminal device 200e are successful (“YES” in Step S704 and “YES” in Step S706), the control unit 101b and the control unit 201b establish a secure communication path (Step S708).

The control unit 201b reads out the model ID 261 stored in the model ID storage unit 214b (Step S709). Subsequently, the control unit 201b transmits the model ID 261 so read out to the sales device 100e via the secure communication path (Step S710).

The judgment unit 112b receives the model ID 261 via the secure communication path (Step S710).

Subsequently, the judgment unit 112b judges whether or not the received model ID 261 exists in the model list 160 (Step S711). When the model ID 261 does not exist in the model list 160 (“NO” in Step S711), the display unit 107b displays a message to that effect (Step S712). This ends the operation of the sales device 100e.

When the model ID 261 exists in the model list 160 (“YES” in Step S711), the judgment unit 112b transmits a message indicating that the portable terminal device 200e is a portable terminal device (Step S713).

The purchase certificate generation unit 110e generates purchase data (Step S714).

Subsequently, the purchase certificate generation unit 110e reads out the private key of the sales device 100e from the private key storage unit 111e. The purchase certificate generation unit 110e causes the encryption processing unit 105b to generate signature data (Step S716). Thus, the purchase certificate generation unit 110e generates a purchase certificate (Step S717).

The purchase certificate generation unit 110e transmits the generated purchase certificate to the portable terminal device 200e via the secure communication path (Step S718).

The verification unit 212e receives the purchase certificate from the sales device 100e via the secure communication path (Step S718).

Subsequently, the verification unit 212e performs verification of the signature data of the purchase certificate (Step S719). When the verification fails (“NO” in Step S720), the verification unit 212e generates a message indicating that the verification has failed, and the display unit 207b displays the generated message (Step S721). This ends the operation of the portable terminal device 200e.

When the verification is successful (“YES” in Step S720), the verification unit 212e writes the purchase certificate to the secure storage unit 202b (Step S722).

This ends the operations when selling content.

(2) Operations when Acquiring Content

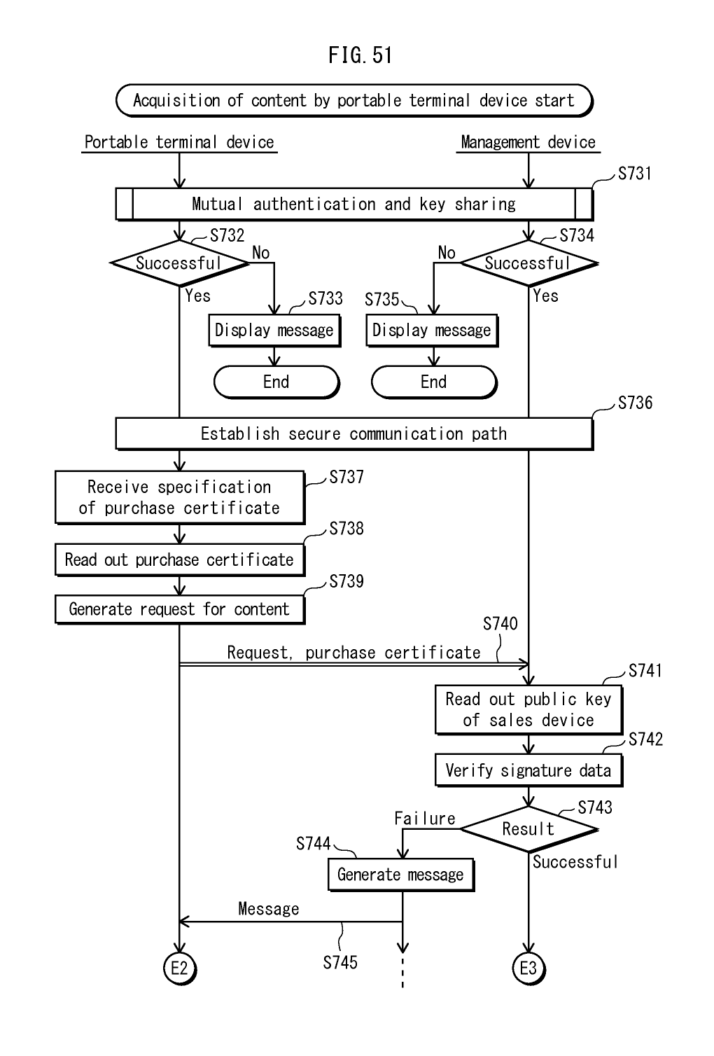

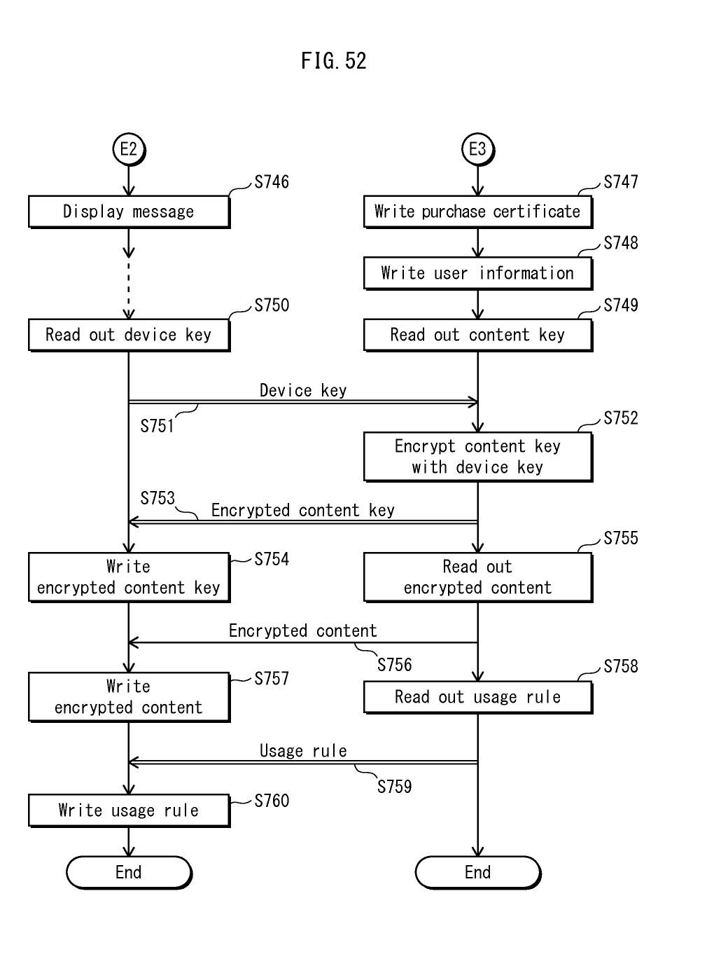

In the following, description is provided on operations of the portable terminal device 200e when acquiring content, by referring to the sequence diagram in FIGS. 51 and 52.

The authentication unit 204b of the portable terminal device 200e and the authentication unit 304b of the management device 300e perform mutual authentication and key sharing (Step S731). Note that the details of the mutual authentication and key sharing have already been described above.

When authentication of the management device 300e fails (“NO” in Step S732), the control unit 201b generates a message indicating that the authentication of the management device 300e has failed, and the display unit 207b displays the generated message (Step S733). This ends the operation of the portable terminal device 200e.

When authentication of the portable terminal device 200e fails (“NO” in Step S734), the control unit 301b generates a message indicating that the authentication of the portable terminal device 200e has failed, and the display unit 307b displays the generated message (Step S735). This ends the operation of the management device 300e.

When mutual authentication and the key sharing between the management device 300e and the portable terminal device 200e are successful (“YES” in Step S732 and “YES” in Step S734), the control unit 201b and the control unit 301b establish a secure communication path (Step S736).

The input reception unit 208b receives a specification of a purchase certificate from a user (Step S737). The control unit 201b reads out a purchase certificate from the storage unit 202b (Step S738). Subsequently, the control unit 201b generates a request for content (Step S739). The control unit 201b transmits the request for content and the purchase certificate to the management device 300e via the secure communication path (Step S740). Subsequently, the control unit 301b receives the request for content and the purchase certificate from the portable terminal device 200e via the secure communication path (Step S740).

The verification unit 312e reads out, from the public key storage unit 313e, the public key of the sales device 100e (Step S741). Subsequently, the verification unit 312e causes the encryption processing unit 305b to verify signature data included in the received purchase certificate (Step S742).

When the verification fails (“Failure” in Step S743), the verification unit 312e generates a message indicating that the verification has failed (Step S744). The verification unit 312e transmits the generated message to the portable terminal device 200e via the communication unit 303b and the network 20e (Step S745).

The communication unit 203b receives the message (Step S745), and the display unit 207b displays the message (Step S746). This ends the operation of the portable terminal device 200e.

When the verification is successful (“Successful” in Step S743), the verification unit 312e writes the purchase certificate to the storage unit 302b (Step S747).

Subsequently, the user information management unit 309b writes user information included in the purchase certificate to the user information table 320 (Step S748).

The control unit 201b reads out the device key stored in the device key storage unit 210b (Step S750). Subsequently, the device key so read out is transmitted to the management device 300e via the secure communication path (Step S751).

The control unit 301b reads out a content key from the storage unit 302b (Step S749). Subsequently, the device key is received from the portable terminal device 200e via the secure communication path (Step S751).

Subsequently, the control unit 301b causes the encryption processing unit 305b to encrypt the content key read out by using the received device key. As such, an encrypted content key is generated (Step S752).

The control unit 301b transmits the generated encrypted content key to the portable terminal device 200e via the secure communication path (Step S753).

The control unit 201b receives the encrypted content key from the management device 300e via the secure communication path (Step S753). Subsequently, the control unit 201b writes the received encrypted content key to the secure storage unit 202b (Step S754).

Subsequently, the control unit 301b reads out encrypted content from the storage unit 302b (Step S755). Subsequently, the encrypted content so read out is transmitted to the portable terminal device 200e via the communication unit 303b and the network 20c (Step S756).

The control unit 201b receives the encrypted content from the management device 300e via the network 20e and the communication unit 203b (Step S756). Subsequently, the control unit 201b writes the received encrypted content to the secure storage unit 202b (Step S757).

The control unit 301b reads out a usage rule from the usage rule table 350 (Step S758), and transmits the usage rule so read out to the portable terminal device 200e via the secure communication path (Step S759).

The control unit 201b receives the usage rule from the management device 300e via the secure communication path (Step S759), and writes the received usage rule to the secure storage unit 202b (Step S760).

This ends the operations when acquiring content.

### 6. Other Modifications

In the following, description is provided modifications of the content distribution system.

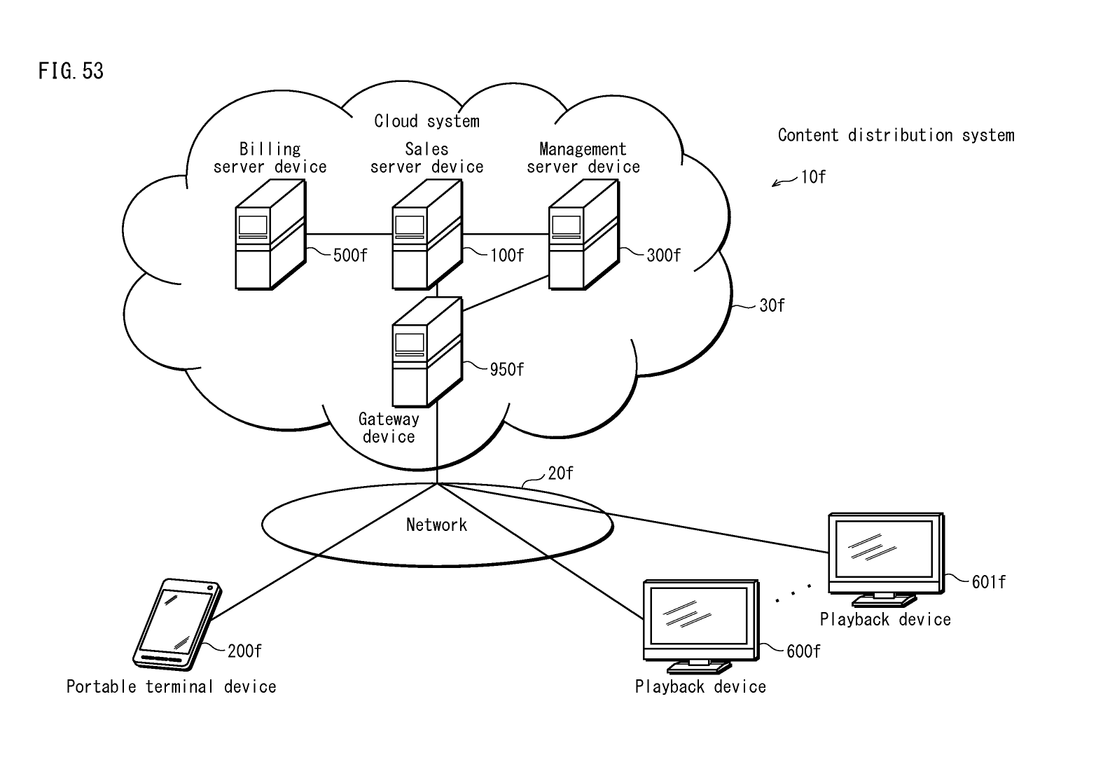

FIG. 53 illustrates a content distribution system 10f. The content distribution system 10f includes: a cloud system 30f; a portable terminal device 200f; and playback devices 600f, . . . , 601f.

The cloud system 30f includes: a billing server device 500f; a sales server device 100f; a management server device 300f; and a gateway device 950f.

The portable terminal device 200f and the playback devices 600f, . . . , 601f are all connected to the gateway device 950f via a network 20f.

The billing server device 500f, the sales server device 100f, and the management server device 300f have the same structures as the billing server device 500b, the sales device 100b, and the management device 300b in the content distribution system 10b, respectively.

The portable terminal device 200f and the playback devices 600f, . . . , 601f have the same structures as the portable terminal device 200b and the playback devices 600b, . . . , 601b in the content distribution system 10b, respectively.

In the following, description is provided while focusing on the differences between the content distribution system 10f and the content distribution system 10b.

(Gateway Device 950f)

The gateway device 950f relays the transmission and reception of information between the portable terminal device 200f and the sales server device 100f. The gateway device 950f also relays the transmission and reception of information between the portable terminal device 200f and the management server device 300f. Further, the gateway device 950f also relays the transmission and reception of information between the playback devices 600f, . . . , 601f and the management server device 300f.

(Portable Terminal Device 200f)

The portable terminal device 200f connects to the sales server device 100f via the gateway device 950f.

The portable terminal device 200f includes a structure that is equivalent to the ticket reader 109b included in the sales device 100b. The portable terminal device 200f reads ticket information from a ticket via the ticket reader included therein, and transmits the ticket information so read to the sales server device 100f via the gateway device 950f. Here, it should be noted that the sales server device 100f does not include the ticket reader 109b.

In addition, the portable terminal device 200f acquires content from the sales server device 100f via the gateway device 950f.

(Playback Device 600f)

The playback device 600f connects to the management server device 300f via the gateway device 950f. The playback device 600f acquires content from the management server device 300f via the gateway device 950f.

Due to the content distribution system 10f having such a structure, a user having viewed a movie at a theater or a movie theater is able to acquire content corresponding to the movie by using the portable terminal device 200f and connecting to the cloud system 30f, after he/she returns home. In addition, during the purchasable period of the content, the user is able to acquire the content by using a playback device and connecting to the cloud system 30f.

(2) In Embodiments 2 through 5, a user performs input of user information and billing information. However, the input of such information is not limited to being made in such a manner. For example, user information, billing information, etc., may be registered to a portable terminal device in advance, and may be transmitted from the portable terminal device to a sales device or an on-board playback device.

(3) In Embodiments 2 through 5, a user selects content that he/she would like to purchase. However, the specification of content is not limited to being made in such a manner. For example, in a case where the user watches a movie at a theater and would like to purchase content corresponding to the movie, a content ID identifying the content may be acquired by reading a bar code or the like printed on a movie ticket or a ticket stub for the movie. Further, a title of the content identified by the content ID may be displayed, and the user may select the content by selecting the title.

When the user is on-board an airplane, a title indicating content that the user has watched (or is currently watching) may be displayed, and the user may select the content.

(4) In each of Embodiments 2 through 5, the content distribution system includes a separate billing server device. However, the content distribution system is not limited to separately including a billing server device.

For example, a sales device may have the structure of a billing server device.

(5) In Embodiment 5, the sales device 100e (or the on-board playback device 400e) transmits a purchase certificate to the portable terminal device 200e by utilizing short-distance wireless communication. However, the acquisition of a purchase certificate is not limited to being performed in such a manner.

For example, the display unit 107b of the sales device 100e may display a QR code with information included in a purchase certificate, and the portable terminal device 200e may read a purchase certificate from such a QR code.

(6) In Embodiment 5, the sales device 100e, after completing the billing processing, generates and issues a purchase certificate. However, the sales device 100e is not limited to performing processing in such a manner.

For example, the sales device 100e may display a One-Time URL in the form of a QR code. A One-Time URL stands for a One-Time Uniform Resource Locator, and is a URL used when accepting only one request for connection, when accepting requests for connection within a limited time period, or when accepting only a limited number of requests for connection. When making such a modification, the portable terminal device 200e reads a One-Time URL from a QR code displayed by the sales device 100e. After reading a One-Time URL, the portable terminal device 200e accesses the URL and goes through procedures such as the registration of user information and billing processing.

(7) In each of Embodiments 2, 3, and 5, content is distributed in response to a content request from a playback device, and a playback device plays back content so received after storing the content. However, the playback of content by a playback device is not limited to being performed in such a manner. For example, a playback device may perform playback of content in the form of streaming. Further, a playback device may begin playback of content as soon as downloading of the content begins.

(8) In Embodiment 3, the portable terminal device 200c makes a request for content to the management device 300c along with the transmission of user information to the management device 300c. However, the request for content and the transmission of user information are not limited to being performed in such a manner. For example, the portable terminal device 200c may first transmit to the management device 300c user information such as a user ID. The portable terminal device 200c may then receive a list of content that is usable (available for playback) from the management device 300c. Finally, a user may select content from the list of content, and a request for the selected content may be made at this point.

(9) In each of Embodiments 2 and 4, a sales device stores content. However, the structure of a sales device is not limited in such a manner. For example, a sales device may only have a function of providing a user interface. When making such a modification, a server device that is connected to the sales device via a network may be provided with a content storing unit that stores content, and the sales device may receive content from the server device and then transfer the content to a portable terminal device.

In addition, in the above Embodiments, short-distance wireless communication may be used for the transferring of content from the sales device to the portable terminal device. This realizes high-speed transferring of content. Further, by using short-distance wireless communication, transferring of content from the sales device to the portable terminal device is possible only when the portable terminal device is in proximity of the sales device. Consequently, safe transferring of content is realized.

(10) In each of Embodiments 2 through 5, the judgment of whether or not a user is entitled to purchase content is made based on ticket information included in a ticket for entering a theater or a movie theater. However, the ticket from which ticket information is acquired is not limited to such a ticket as described above. For example, each of the ticket for entering a theater or a movie theater and the boarding pass for an airplane flight may be an electronic ticket including an antenna, a memory, and a processor. When making such a modification, ticket information is stored in a memory included in an electronic ticket. Further, a sales device or an on-board playback device reads out ticket information from an electronic ticket.

(11) Content is not limited to content corresponding to a movie. That is, content may be any type of electronic data, such as electronic data corresponding to music, books and other types of publication, games, photographs, and programs. Further, in advance to being made publically available, such electronic data may be provided in various venues not limited to theaters and movie theaters. Such venues include concert halls, venues for live music performance, and event halls.

(12) In each of the Embodiments, one device has a plurality of functions (constituent elements). The present invention is not, however, limited to such a structure. The functions (constituent elements) may be distributed among a plurality of devices, and the same advantageous effects and functions may be achieved through combination of such devices.

(13) A portion or all of the constituent elements composing each of the above devices may be constituted by an IC card, or an individual module, that is removable from the device. The IC card or the module is a computer system that includes a microprocessor, ROM, RAM, etc. The IC card or the module may include an ultra-multifunctional LSI. The microprocessor operates according to computer programs, and the IC card or the module thereby accomplishes its functions. The IC card or the module may be tamper resistant.

In addition, the method for assembling integrated circuits is not limited to the above-described method utilizing LSIs, and a dedicated communication circuit or a general-purpose processor may be used. A Field Programmable Gate Array (FPGA), which is programmable after the LSI is manufactured, or a reconfigurable processor, which allows reconfiguration of the connection and setting of circuit cells inside the LSI, may be used.

Furthermore, if technology for forming integrated circuits that replaces LSIs emerges, owing to advances in semiconductor technology or to another derivative technology, the integration of functional blocks may naturally be accomplished using such technology.

In addition, the constituent elements composing each of the above devices may be implemented by using software, or a combination of software and LSIs. In such a case, the software may be tamper resistant.

Each of the above devices may be a computer system that includes a microprocessor, a ROM, a RAM, etc. The microprocessor operates in accordance with computer programs stored in the RAM and/or the ROM, whereby the devices achieve the functions thereof.

Alternatively, the computer program may be recorded on a computer-readable recording medium, such as a flexible disk, hard disk, CD-ROM, MO, DVD, DVD-ROM, DVD-RAM, BD(Blu-ray Disc), or semiconductor memory

Alternatively, the computer program may be transmitted via networks, of which telecommunications networks, wired/wireless communications networks, and the Internet are representative, or via data broadcasting.

Alternatively, another independent computer system may implement the computer program after the computer program is transferred via being recorded on a recording medium as described above or via a network as described above.

(15) The above Embodiments and modifications may be combined with one another.

(16) One aspect of the present invention is a content distribution system including: a terminal device using content; a dedicated terminal device providing the content; and a server device managing a right to view the content and distributing the content to the terminal device. In the content distribution system, the dedicated terminal device includes: a reception means receiving a request for the content and user information of a user who uses the content; a judgment means judging whether or not the content is to be provided based on the user information so received; and a transmission means, when the judgment means judges that the content is to be provided, transmitting the content to the terminal device and transmitting a content identifier uniquely identifying the content and the user information to the server device. The terminal device includes: a reception means receiving the content; a storing means storing the content so received; and a playback means playing back the content so stored. The server device includes: a reception means receiving the content identifier and the user information from the dedicated terminal device and receiving the request for the content from the terminal device; a management means managing the content identifier and the user information, which are received from the dedicated terminal device, as a right to view the content possessed by the user; a judgment means that judges whether or not the content is to be provided in response to the request for the content, the judgment performed based on the request for the content and the right to view the content managed by the management means; and a transmission means, when the judgment means judges that the content is to be provided, transmitting the content to the terminal device.

In the content distribution system pertaining to one aspect of the present invention, the judgment means of the dedicated terminal device may read and check a ticket or a portion of the ticket to judge whether or not the content is to be provided.

In the content distribution system pertaining to one aspect of the present invention, the ticket checked by the judgment means of the dedicated terminal device may be an electronic ticket.

In the content distribution system pertaining to one aspect of the present invention, the judgment means of the dedicated terminal device may acquire information pertaining to a location of the device to which the content is to be provided, and may judge whether or not the content is to be provided based on the information pertaining to the location of the device.

In the content distribution system pertaining to one aspect of the present invention, the transmission means of the dedicated terminal device, instead of transmitting the content, may generate and transmit a purchase certificate indicating purchase of the content by the user, and the reception means of the terminal device, instead of receiving the content, may receive the purchase certificate. The terminal device may further include: a transmission means transmitting the purchase certificate. In the server device, the reception means may receive the purchase certificate, the judgment means may check validity of the purchase certificate, and the transmission means may transmit the purchase certificate to the terminal device when the judgment means judges that the purchase certificate is valid.

In the content distribution system pertaining to one aspect of the present invention, the purchase certificate may include at least the user information and the content identifier.

In the content distribution system pertaining to one aspect of the present invention, the dedicated terminal device may further include: a display means generating and displaying a purchase certificate indicating purchase of the content by the user, the display means generating and displaying the purchase certificate instead of the transmission means transmitting the content. The terminal device may further include: a reading means reading and storing the displayed purchase certificate; and a transmission means transmitting the purchase certificate. In the server device, the reception means may receive the purchase certificate, the judgment means may check validity of the purchase certificate, and the transmission means may transmit the purchase certificate to the terminal device when the judgment means judges that the purchase certificate is valid.

In the content distribution system pertaining to one aspect of the present invention, the purchase certificate displayed by the display means of the dedicated terminal device may be a QR code.

In the content distribution system pertaining to one aspect of the present invention, the server device may further include: a notification means, when a distribution start date of the right of the user to view the content is set, notifies the user of the distribution start date based on the user information managed by the management means.

Another aspect of the present invention is a dedicated terminal device in a content distribution system 10b including: a terminal device using content; the dedicated terminal device, which provides the content; and a server device managing a right to view the content and distributing the content to the terminal device. The dedicated terminal device includes: a reception means receiving a request for the content and user information of a user who uses the content; a judgment means judging whether or not the content is to be provided based on the user information so received; and a transmission means, when the judgment means judges that the content is to be provided, transmitting the content to the terminal device and transmitting a content identifier uniquely identifying the content and the user information to the server device.

Another aspect of the present invention is a server device in a content distribution system 10b including: a terminal device using content; the dedicated terminal device, which provides the content; and a server device managing a right to view the content and distributing the content to the terminal device. The server device includes: a reception means receiving a content identifier and user information pertaining to a user from the dedicated terminal device and receiving a request for the content from the terminal device; a management means managing the content identifier and the user information, which are received from the dedicated terminal device, as a right to view the content possessed by the user; a judgment means that judges whether or not the content is to be provided in response to the request for the content, the judgment performed based on the request for the content and the right to view the content managed by the management means; and a transmission means, when the judgment means judges that the content is to be provided, transmitting the content to the terminal device.

### INDUSTRIAL APPLICABILITY

According to the method of controlling a content-providing system pertaining to the present invention, content is made usable only on a portable terminal device that a user has. This has the effect of preventing the content from circulating in the market. Consequently, it can be expected that the present invention prevents the decrease in the number of people visiting theatrical venues to watch movies. As such, the present invention is useful as technology of providing content to users.

### REFERENCE SIGNS LIST

10a content-providing system
10b, 10c, 10d, 10e, 10f content distribution system
20b, 20c, 20d, 20e, 20f network
30f cloud system
100b, 100c, 100d, 100e sales device
100f sales server device
200a, 200b, 200c, 200d, 200e, 200f portable terminal device
300b, 300c, 300d, 300e management device
300f management server device
400b, 400c, 400d, 400e on-board playback device
500b, 500c, 500d, 500e, 500f billing server device
600b, 600c, 600d, 600e, 600f playback device
700d medium manufacturing device
800 recording medium
900b, 900c, 900d, 900e gate device
950f gateway device

1. A method of controlling a content-providing system that includes: a first acquisition unit; a second acquisition unit; a judgment unit; an encryption unit; and a transmission unit, and that provides, to users who receive a service, content corresponding to a movie shown at a site where the service is provided when the users make a payment for the content, the method comprising:
a first acquisition step of the first acquisition unit acquiring a request for purchasing the content from a user;
a second acquisition step of the second acquisition unit acquiring first identification information for the service, from a medium carrying the first identification information;
a judgment step of the judgment unit (i) judging whether or not the request is received before a period during which the content is purchasable in a form of a packaged medium, and (ii) judging, by using the first identification information, whether or not the user is entitled to the service;
an encryption step of the encryption unit, when the request is received before the period and the user is entitled to the service, encrypting the content to generate encrypted content usable only on a terminal device that the user has; and
a transmission step of the transmission unit transmitting the encrypted content to the terminal device before the period.

2. The method of claim 1, wherein
in the service, the movie is shown to an audience in a theatrical venue,
in the judgment step, the judgment unit judges that the user is entitled to the service when the first identification information matches second identification information that is internally stored in advance,
the medium is a movie ticket and the first identification information identifies content corresponding to a movie, and
the second identification information identifies the content corresponding to the movie, which is shown at the theatrical venue.

3. The method of claim 1, wherein
in the service, a passenger is transported between airports on an airplane, the movie shown on the airplane,
in the judgment step, the judgment unit judges that the user is entitled to the service when the first identification information matches second identification information that is internally stored in advance,
the medium is a boarding ticket and the first identification information identifies an airplane flight, and
the second identification information identifies the airplane flight during which the movie is shown.

4. The method of claim 1, wherein
in the service, a hotel guest is allowed to occupy a room in a hotel in which the movie is shown,
in the judgment step, the judgment unit judges that the user is entitled to the service when the first identification information matches second identification information that is internally stored in advance,
the first identification information identifies a hotel room and the medium is a cardkey for locking and unlocking the hotel room identified by the first identification information, and
the second identification information identifies the room in the hotel.

5. The method of claim 1, wherein
the content-providing system includes a sales device which sells and provides the content to users and in which the first acquisition unit, the second acquisition unit, the judgment unit, the encryption unit, and the transmission unit are included,
in the first acquisition step, the first acquisition unit, which is included in the sales device, acquires the request for purchasing the content from the user,
in the second acquisition step, the second acquisition unit, which is included in the sales device, acquires the first identification information,
in the judgment step, the judgment unit, which is included in the sales device, judges whether or not the request is received before the period and whether or not the user is entitled to the service,
in the encryption step, the encryption unit, which is included in the sales device, encrypts the content to generate the encrypted content, and
in the transmission step, the transmission unit, which is included in the sales device, transmits the encrypted content to the terminal device.

6. The method of claim 1, wherein
the content-providing system includes: a sales device which sells the content and in which the first acquisition unit, the second acquisition unit, and the judgment unit are included; and a management device which provides the content to users and in which the encryption unit and the transmission unit are included,
in the first acquisition step, the first acquisition unit, which is included in the sales device, acquires the request for purchasing the content from the user,
in the second acquisition step, the second acquisition unit, which is included in the sales device, acquires the first identification information,
in the judgment step, the judgment unit, which is included in the sales device, judges whether or not the request is received before the period and whether or not the user is entitled to the service,
in the encryption step, the encryption unit, which is included in the management device, encrypts the content to generate the encrypted content, and
in the transmission step, the transmission unit, which is included in the management device, transmits the encrypted content to the terminal device.

7. The method of claim 6 further comprising:
a purchase certificate generation step of a generation unit of the sales device, when the request is received before the period and the user is entitled to the service, generating a purchase certificate that certifies that the user has purchased the content and has the right to use the content, wherein
in the transmission step, the purchase certificate is transmitted to the terminal device, the method further comprising:
a terminal device reception step of a reception unit of the terminal device receiving the purchase certificate and storing the purchase certificate in the terminal device; and
a terminal device transmission step of a transmission unit of the terminal device transmitting the purchase certificate stored in the terminal device to the management device, wherein
in the encryption step, judgment is performed of whether or not the purchase certificate is valid, and the content is encrypted to generate the encrypted content when the purchase certificate is valid, regarding that the request is received before the period and the user is entitled to the service.

8. The method of claim 1 further comprising:
a terminal reception step of a reception unit of the terminal device receiving the encrypted content;
a decrypting step of a decryption unit of the terminal device decrypting the encrypted content to generate decrypted content, and
a playback step of a playback unit of the terminal device playing back the decrypted content.

9. The method of claim 8, wherein
in the transmission step, a usage rule is transmitted to the terminal device, the usage rule indicating limited conditions under which the content is available for use, and
in the terminal reception step, the usage rule is received, the method further comprising:
a terminal checking step of a checking unit of the terminal device checking the usage rule received in the terminal reception step, wherein
in the playback step, the decrypted content is played back according to results of the check in the terminal checking step.

10. The method of claim 1, wherein
the content-providing system includes: a sales device which sells and provides the content to users and in which the first acquisition unit, the second acquisition unit, the judgment unit, the encryption unit and the transmission unit are included; a management device that manages the content after being provided to users; and a playback device that the user has, the method further comprising:
a first reception step of a first reception unit of the management device receiving, from the sales device, sales information indicating that the content has been sold to the user, and storing the sales information in the management device;
a second reception step of a second reception unit of the management device receiving a transmission request from the playback device, the transmission request being a request for transmission of the content;
a management device judgment step of a judgment unit of the management device judging whether or not the transmission request is received before the period, and judging, by using the sales information stored in the management device, whether or not the user, who uses the playback device, is entitled to use the content, which pertains to the transmission request;
a management device encryption step of an encryption unit of the management device, when the transmission request is received during the period and the user is entitled to use the content, encrypting the content in accordance with a recording medium that is mounted to the playback device to generate encrypted content; and
a management device transmission step of a transmission unit of the management device transmitting the encrypted content to the playback device during the period.

11. The method of claim 10 further comprising:
a playback device reception step of a reception unit of the playback device receiving the encrypted content and writing the encrypted content to the recording medium;
a decryption step of a decryption unit of the playback device decrypting the encrypted content to generate decrypted content; and
a playback step of a playback unit of the playback device playing back the decrypted content.

12. The method of claim 11, wherein
in the management device transmission step, a usage rule is transmitted to the playback device, the usage rule indicating moderated conditions under which the content is available for use, and
in the playback device reception step, the usage rule is received, the method further comprising:
a playback device checking step of a checking unit of the playback device checking the usage rule received in the playback device reception step, wherein
in the playback step, the decrypted content is played back according to results of the check in the playback device checking step.

13. The method of claim 1, wherein
the content-providing system includes: a sales device which sells and provides the content to users and in which the first acquisition unit, the second acquisition unit, the judgment unit, the encryption unit, and the transmission unit are included; a management device that manages the content after being provided to users; a medium manufacturing device that writes the content to a recording medium; and a playback device that the user has, the method further comprising:
a first reception step of a first reception unit of the management device receiving, from the sales device, sales information indicating that the content has been sold to the user, and storing the sales information in the management device;
a second reception step of a second reception unit of the management device receiving a transmission request from the playback device, the transmission request being a request for transmission of the content;
a management device judgment step of a judgment unit of the management device judging whether or not the transmission request is received before the period, and judging, by using the sales information stored in the management device, whether or not the user, who uses the playback device, is entitled to use the content, which pertains to the transmission request;
a medium manufacturing device encryption step of an encryption unit of the medium manufacturing device, when the transmission request is received during the period and the user is entitled to use the content, encrypting the content in accordance with the recording medium to generate encrypted content;
a medium manufacturing step of a manufacturing unit of the medium manufacturing device writing the encrypted content to the recording medium;
a decryption step of a decryption unit of the playback device decrypting the encrypted content, which is recorded on the recording medium, to generate decrypted content; and
a playback step of a playback unit of the playback device playing back the decrypted content.

14. The method of claim 13, wherein
in the medium manufacturing step, a usage rule is recorded on the recording medium, the usage rule indicating moderated conditions under which the content is available for use, the method further comprising:
a playback device checking step of a checking unit of the playback device checking the usage rule recorded on the recording medium, wherein
in the playback step, the decrypted content is played back according to results of the check in the playback device checking step.

15. A sales device that provides, to users who receive a service, content corresponding to a movie shown at a site where the service is provided when the users make a payment for the content, the sales device comprising:
a first acquisition unit acquiring a request for purchasing the content from a user;
a second acquisition unit acquiring first identification information for the service, from a medium carrying the first identification information;
a judgment unit (i) judging whether or not the request is received before a period during which the content is purchasable in a form of a packaged medium, and (ii) judging, by using the first identification information, whether or not the user is entitled to the service;
an encryption unit, when the request is received before the period and the user is entitled to the service, encrypting the content to generate encrypted content usable only on a terminal device that the user has; and
a transmission unit transmitting the encrypted content to the terminal device before the period.

16. A computer-readable recording medium having recorded thereon a program for controlling a sales device that provides, to users who receive a service, content corresponding to a movie shown at a site where the service is provided when the users make a payment for the content, the program causing the sales device, which is a computer, to execute:
a first acquisition step of a first acquisition unit of the sales device acquiring a request for purchasing the content from a user;
a second acquisition step of a second acquisition unit of the sales device acquiring first identification information for the service, from a medium carrying the first identification information;
a judgment step of a judgment unit of the sales device (i) judging whether or not the request is received before a period during which the content is purchasable in a form of a packaged medium, and (ii) judging, by using the first identification information, whether or not the user is entitled to the service;
an encryption step of an encryption unit of the sales device, when the request is received before the period and the user is entitled to the service, encrypting the content to generate encrypted content usable only on a terminal device that the user has; and
a transmission step of a transmission unit of the sales device transmitting the encrypted content to the terminal device before the period.

17. An integrated circuit constituting a sales device that provides, to users who receive a service, content corresponding to a movie shown at a site where the service is provided when the users make a payment for the content, the integrated circuit comprising:
a first acquisition unit acquiring a request for purchasing the content from a user;
a second acquisition unit acquiring first identification information for the service, from a medium carrying the first identification information;
a judgment unit (i) judging whether or not the request is received before a period during which the content is purchasable in a form of a packaged medium, and (ii) judging, by using the first identification information, whether or not the user is entitled to the service;
an encryption unit, when the request is received before the period and the user is entitled to the service, encrypting the content to generate encrypted content usable only on a terminal device that the user has; and
a transmission unit transmitting the encrypted content to the terminal device before the period.

18. A content-providing system that provides, to users who receive a service, content corresponding to a movie shown at a site where the service is provided when the users make a payment for the content, the content-providing system comprising:
a sales device selling the content; and
a management device providing the content to users, wherein
the sales device includes:
a first acquisition unit acquiring a request for purchasing the content from a user;
a second acquisition unit acquiring first identification information for the service, from a medium carrying the first identification information; and
a judgment unit (i) judging whether or not the request is received before a period during which the content is purchasable in a form of a packaged medium, and (ii) judging, by using the first identification information, whether or not the user is entitled to the service; and
the management device includes:
an encryption unit, when the request is received before the period and the user is entitled to the service, encrypting the content to generate encrypted content usable only on a terminal device that the user has; and
a transmission unit transmitting the encrypted content to the terminal device before the period.

19. A content-providing system that provides, to users who receive a service, content corresponding to a movie shown at a site where the service is provided when the users make a payment for the content, the content-providing system comprising:
a sales device selling the content;
a management device providing the content to users; and
a playback device that a user has, wherein
the sales device includes:
a first acquisition unit acquiring a request for purchasing the content from the user;
a second acquisition unit acquiring first identification information for the service, from a medium carrying the first identification information; and
a judgment unit (i) judging whether or not the request is received before a period during which the content is purchasable in a form of a packaged medium, and (ii) judging, by using the first identification information, whether or not the user is entitled to the service;
an encryption unit, when the request is received before the period and the user is entitled to the service, encrypting the content to generate encrypted content usable only on a terminal device that the user has; and
a transmission unit transmitting the encrypted content to the terminal device before the period, and
the management device includes:
a first reception unit receiving, from the sales device, sales information indicating that the content has been sold to the user, and storing the sales information in the management device;
a second reception unit receiving a transmission request from the playback device, the transmission request being a request for transmission of the content;
a management device judgment unit judging whether or not the transmission request is received before the period, and judging, by using the sales information stored in the management device, whether or not the user, who uses the playback device, is entitled to use the content, which pertains to the transmission request;
a management device encryption unit, when the transmission request is received during the period and the user is entitled to use the content, encrypting the content in accordance with a recording medium that is mounted to the playback device to generate encrypted content; and
a management device transmission unit transmitting the encrypted content to the playback device during the period.

20. A content-providing system that provides, to users who receive a service, content corresponding to a movie shown at a site where the service is provided when the users make a payment for the content, the content-providing system comprising:
a sales device selling the content;
a management device providing the content to users;
a medium manufacturing device writing the content to a recording medium; and
a playback device that a user has, wherein
the sales device includes:
a first acquisition unit acquiring a request for purchasing the content from the user;
a second acquisition unit acquiring first identification information for the service, from a medium carrying the first identification information; and
a judgment unit (i) judging whether or not the request is received before a period during which the content is purchasable in a form of a packaged medium, and (ii) judging, by using the first identification information, whether or not the user is entitled to the service;
an encryption unit, when the request is received before the period and the user is entitled to the service, encrypting the content to generate encrypted content usable only on a terminal device that the user has; and
a transmission unit transmitting the encrypted content to the terminal device before the period,
the management device includes:
a first reception unit receiving, from the sales device, sales information indicating that the content has been sold to the user, and storing the sales information in the management device;
a management device judgment unit judging whether or not a present point in time is before the period, and judging, by using the sales information stored in the management device, whether or not the user is entitled to use the content,
the medium manufacturing device includes:
a medium manufacturing device encryption unit, when the present point in time is during the period and the user is entitled to use the content, encrypting the content in accordance with the recording medium to generate encrypted content; and
a medium manufacturing unit writing the encrypted content to the recording medium; and
the playback device includes:
a decryption unit decrypting the encrypted content, which is recorded on the recording medium, to generate decrypted content; and
a playback unit playing back the decrypted content.
